(19) United States
(12) Patent Application Publication
(10) Pub. No.: US 2003/0139936 A1
(43) Pub. Date: Jul. 24, 2003

(54) System and method for facilitating transactions between product brand managers and manufacturing organizations

(76) Inventors: Michael Saucier, Phoenix, AZ (US); Ray Hall, Scottsdale, AZ (US); Dennis Brandl, Cary, NC (US)

Correspondence Address: SULLIVAN LAW GROUP, 1850 NORTH CENTRAL AVENUE, SUITE 1140, PHOENIX, AZ, 85004, US

(21) Appl. No.: 10/055,870

(22) Filed: Jan. 21, 2002

(51) Int. Cl. G06F 17/60

(52) U.S. Cl. 705/1

(57) ABSTRACT

A method is provided for facilitating transactions between a product brand manager and manufacturing organizations using a transactional computer system. The product brand manager has a product brand and product brand information that includes information for manufacturing the product brand, and there is manufacturing organization information for each of the manufacturing organizations that includes the manufacturing process capabilities of the respective manufacturing organization. The method includes communicating the product brand information from the product brand manager to the transactional computer system, and communicating the manufacturing organization information for the manufacturing organizations from the manufacturing organizations to the transactional computer system. The method also includes using the transactional computer system to process the product brand information and the manufacturing organization information to select at least one candidate manufacturing organization from the manufacturing organizations and to generate selection information regarding the at least one candidate manufacturing organization. The selection processing uses the transactional computer system to compare the product brand information to the manufacturing organization information. The method further includes using the transactional computer system to communicate the selection information to the product brand manager. A related method is provided for the selection of product brand managers for the benefit of a manufacturing organization. Related systems also are disclosed.

### BACKGROUND OF THE INVENTION

1. Field of the Invention

The present invention relates to methods, systems and apparatus for interchanging information and/or facilitating transactions in a manufacturing community with manufacturing community members that comprise product brand owners or managers and manufacturing organizations. More specifically it relates to methods, systems and apparatus for performing such tasks or functions automatically or semi-automatically.

2. Description of the Related Art

A “product brand” as the term is used herein refers broadly to a product to be manufactured or otherwise processed. The product brand may be a final product, an intermediate, a processed raw material, etc. Product brands, for example, may comprise a material manufactured by a batch chemical process. Product brands as they relate to the presently preferred embodiments and methods of the invention as disclosed herein preferably comprise batch products, or products manufactured by batch processes. The product brands may comprise chemical products, food products, agricultural products, synthetics such as plastics, pharmaceutical products, etc. The product brands may be for commercial or industrial use. It should be noted that the product brand need not necessarily be associate with a trademark. The term product brand is used merely to identify a particular product or product type, and to designate its association with a product brand manager or mangers.

Product brands typically although not exclusively are manufactured or processed as part of what is commonly referred to as the process industry. The process industry as the term is commonly understood includes the segments of industry that process bulk materials by processing input materials, normally in a bulk manner, to change their physical and/or chemical state, typically in the course of manufacturing, re-manufacturing, or otherwise processing them into products. Industrial processes within this industry often can be segregated into one of three categories, i.e., continuous operations, batch operations and discrete operations. Batch operations normally are required when the products being manufactured, for example, either: (1) do not justify a dedicated, continuous operation, (2) are not capable of being produced by a continuous operation, or (3) pose an unreasonable risk if the batch is fouled or lost, etc. Batch type operations of the second category (i.e., those which are incapable of continuous operation) which do not fall within the first category (those that do justify a dedicated continuous operation) typically will have a dedicated production line that operates in a semi-continuous manner. Products that fall into the first category create a unique and very significant sector in the process industry. The term “batch process” typically refers to processes in the first category (e.g., processes that do not justify a continuous operation).

Product brands usually are controlled and managed by what is referred to herein as a “product brand manager.” A product brand manager as the term is used herein refers broadly to an individual, corporation, business entity or other entity, or groups thereof that has responsibility for, control of, or otherwise manages the product brand. This may and often does comprise the owner or owners of the product brand, although this is not necessarily required. The product brand manager may, for example, comprise organizations or entities that own, develop, acquire, manage, or otherwise are responsible for product brand or brands. A product development organization would be an example.

Historically, the product brand manager has had its own facilities for manufacturing its own product brands. It has not been uncommon for a product brand manager to acquire materials or other manufacturing inputs from other parties, or to enlist the assistance of third parties in part of the manufacturing process, but the overall manufacturing process typically has been controlled, managed and for the most part undertaken by the product brand manager.

In recent years, there has been a global trend toward a separation of product brand management or ownership and the means of manufacturing the product brand. This has been accompanied by a trend toward the use by product brand managers of manufacturing organizations that are independent of the product brand managers, but which can be enlisted, for example, under contract, to manufacture the product brand for the product brand manager.

A manufacturing organization as the term is used herein refers broadly to an organization, business, activity, or other entity that undertakes or is capable of undertaking a manufacturing or product processing activity. Manufacture as the term is used herein refers not only to manufacturing per se, but also generally to any task of handling, treating or processing a thing to transform it from one state to another, generally with the ultimate objective of reselling, redistributing or reusing it as a product. As noted above, product is used in a general sense to include not only final or end-use products, but intermediates or processed materials as well.

This trend toward separation of product brand managers and manufacturing organizations has brought to bear a number of significant advantages for the product brand managers, the manufacturing organizations, and for the consuming public. Companies can specialize in what they do best and most efficiently. The product brand managers typically benefit most directly by avoiding the requirement to establish, maintain and operate the facilities necessary to manufacture the product brands. For example, companies that specialize in the development of product brands do not need to burden themselves with specializing in manufacturing the product brands they develop. Research groups that develop product often have a very different set of skills and assets than manufacturing organizations which specialize in manufacturing. Additionally, research groups do not need to burden themselves with developing product brands that are compatible with the specific manufacturing capabilities their company possesses.

The manufacturing organizations benefit by the additional business obtained from the product brand managers, and from the more complete and efficient utilization of their manufacturing capacity. Manufacturing organizations, for example, typically have multiple sites or plants at which they can manufacture products. From time to time these various sites or plants may not be fully utilized. By contracting with product brand owners, these manufacturing organizations may be able to adjust or modify production to utilize otherwise idle time so that its sites are fully utilized.

The trend toward the enlistment of manufacturing organizations also has led to the establishment of independent manufacturing organizations wherein the entire organization is established specifically to manufacture a variety of products under contract, and often under short term to intermediate term contracts as opposed to long term contracts. Manufacturing organizations often can better utilize equipment and processes, and, for example, can afford to invest in a particular item of equipment and spread the costs over multiple users where a single user could not justify the cost of the equipment for such a limited use.

Consumers have benefited from these arrangements, for example, through a greater availability of manufacturing resources and correspondingly greater availability of resulting products. Lower prices also have resulted.

The trend toward a global contract manufacturing community, however, also presents significant challenges. Along with the added potential flexibility of this community comes the increased need for improved methods of communicating information throughout this community. Communication channels generally are no longer within a single organization, where the manufacturing segment of the organization can be kept appraised of the product brands being developed by the research segment of the organization and the manufacturing requirements of the product brands in development. Instead, communication of the manufacturing process requirements for a newly developed product brand in a contract manufacturing community generally may not occur until the product brand is fully developed and ready for production. This may be due in part to the product brand owner's or manager's need to protect the intellectual property associated with the product brand. Communication of the product brand information often poses a risk of that information being compromised or misappropriated. If the product brand manager wishes to contact a number of manufacturing organizations to inquire about the possibility of enlisting them undertake the manufacture, this typically will result in this sensitive information being placed in the hands of an actual or potential competitor.

An additional challenge imposed on the product brand owners or managers in a contract manufacturing community environment is the need to evaluate a number of manufacturing organizations to effectively select the one that is best suited to manufacture the product brand. Such evaluation often involves obtaining a substantial amount of information about a number of manufacturing organizations. The task of collecting this information, evaluating it, etc., can be very time consuming and costly. Particularly where the product brand involves a new product or a new release, there often is substantial advantage in being first to the market. In such instances, it is usually advantageous to be able to collect this information, evaluate it, and make a selection quickly. Limitations imposed by security often restrict this process.

In collecting such information, the manufacturing organizations also have their own requirements of confidentiality, and typically are reluctant or unwilling to provide the necessary detail, or are willing to disclose it only under tight controls.

### OBJECTS OF THE INVENTION

Accordingly, an object of the invention is to provide a method and apparatus for facilitating transactions between product brand managers and manufacturing organizations.

Another object of the invention is to provide a method and apparatus for facilitating such transactions so they can occur quickly relative to commercially known methods.

Another object of the invention is to provide a method and apparatus for facilitating such transactions so they can occur securely.

Still another object of the invention is to provide a method and apparatus for facilitating such transactions with reduced human intervention.

Additional objects and advantages of the invention will be set forth in the description, which follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, a method is provided for facilitating transactions between a product brand manager and manufacturing organizations using a transactional computer system. The product brand manager has a product brand and product brand information comprising information for manufacturing the product brand, and there is manufacturing organization information for each of the manufacturing organizations comprising the manufacturing process capabilities of the respective manufacturing organization.

The method according to this aspect of the invention comprises communicating the product brand information from the product brand manager to the transactional computer system, and communicating the manufacturing organization information for the manufacturing organizations from the manufacturing organizations to the transactional computer system. The method also comprises using the transactional computer system to process the product brand information and the manufacturing organization information to select at least one candidate manufacturing organization from the manufacturing organizations and to generate selection information regarding the at least one candidate manufacturing organization. The selection comprises using the transactional computer system to compare the product brand information to the manufacturing organization information. The method further comprises using the transactional computer system to communicate the selection information to the product brand manager.

In accordance with this aspect of the invention, it is desirable although optional that as much of the process as is practicable be carried out by computers or like machines with minimal human intervention. Accordingly, the communicating of the product brand information from the product brand manager to the transactional computer system preferably is performed without human intervention at the transactional computer system. The communicating of the manufacturing organization information for the manufacturing organizations from the manufacturing organizations to the transactional computer system also preferably is performed without human intervention at the transactional computer system.

In addition, it is preferred that the using of the transactional computer system to process the product brand information and the manufacturing organization information to select at least one candidate manufacturing organization from the manufacturing organizations and to generate selection information regarding the at least one candidate manufacturing organization is performed without human intervention at the transactional computer system.

It is also preferred that, the use of the transactional computer system to compare the product brand information to the manufacturing organization information and the use of the transactional computer system to communicate the selection information to the product brand manager are performed without human intervention at the transactional computer system.

The product brand manager preferably comprises a product brand manager computer and the transactional computer system is operatively coupled to the product brand computer to communicate the product brand information from the product brand computer and to communicate the selection information to the product brand computer. Similarly, it is preferred that each of the manufacturing organizations comprises a manufacturing organization computer and the transactional computer system is operatively coupled to each of the manufacturing organization computers to receive the manufacturing organization information from the manufacturing organization computers. As noted above, it is also preferred that the transactional computer system receives the product brand information and the manufacturing organization information from the product brand manager computer and the manufacturing organization computer respectively without human intervention at the transactional computer system and automatically selects the at least one candidate manufacturing organization without human intervention at the transactional computer system, and that the transactional computer system generates the selection information and communicates to the product brand manager without human intervention.

The transactional computer system preferably comprises at least one computer operatively coupled to a network and/or a local area network. It preferably comprises a plurality of computers and a distributed database. It may also comprise a wide area network.

The product brand manager may comprise an owner of the product brand, a product development organization, a product brand manager, or other entity responsible for the product brand and/or its production, distribution and/or the like.

The product brand in the preferred implementation comprises a material manufactured by a batch chemical process.

The product brand information communication may comprise communicating the product brand information to comprise a general recipe. It also may comprise pricing information, schedule information, delivery information, quality information, and/or other information pertaining to the product brand. The product brand information communicating may comprise communicating the product brand information in a general recipe format, or otherwise in a normalized format.

The manufacturing organizations preferably comprise contract manufacturing organizations, wherein each of the manufacturing organizations comprises at least one site, at least one area, and/or at least one process cell. The manufacturing organization information accordingly may comprise site information, area information, and/or process cell information. The manufacturing organization information also may and preferably does comprise equipment information, flow information, scheduling information, price information, delivery information, capacity information, plant location information, and other information relating to the production capabilities of the manufacturing organization, and/or its ability to meet product brand owner needs. Each of the manufacturing organizations typically is capable of manufacturing a product and the manufacturing organization information for each of the manufacturing organizations accordingly may comprise the product for the manufacturing organization.

Similarly, in may instances each of the manufacturing organizations is capable of manufacturing one or more products within at least one product classification. In this event, the manufacturing organization information for each of the manufacturing organizations may comprise the at least one product classification for the manufacturing organization.

Preferably, the manufacturing organization information communicating comprises communicating the manufacturing organization information in a normalized format.

The method optionally but preferably comprises excluding the product brand information from the manufacturing organizations, and may comprise excluding the manufacturing information from the product brand manager.

The product brand information communicating may comprise communicating the product brand information to comprise a general recipe as was noted above.

The processing accordingly may comprise converting the general recipe to a plurality of master recipes, and comparing the plurality of master recipes to the manufacturing organization information. The product brand information processing also may comprise formatting the product brand information to comprise a general recipe. The processing also may comprise converting the general recipe to a plurality of master recipes, and comparing the plurality of master recipes to the manufacturing organization information.

The processing also may comprise providing a normalized set of process parameters, and converting the product brand information to the normalized set of process parameters. Similarly, the manufacturing organization information communication may comprise providing a normalized set of process parameters, and providing the manufacturing organization information for each of the manufacturing organizations as the normalized set of process parameters. In addition, the processing may comprise providing a normalized set of process parameters, and converting the manufacturing organization information for each of the manufacturing organizations to the normalized set of process parameters.

The product brand information preferably but optionally may be stored in a database, such as a distributed database, a secure database, and the like. The manufacturing organization information also optionally but preferably may be stored in a database, such as a distributed database, a secure database or the like.

Where the product brand information comprises a general recipe, the processing preferably comprises converting the general recipe into at least one master recipe and preferably into a plurality of the master recipes. In this instance, the processing preferably comprises comparing the plurality of the master recipes with the manufacturing organization information.

In general terms, the product brand information may comprise steps required to make the product brand, the manufacturing organization information may comprise steps capable of being carried out by the manufacturing organization, and the processing preferably comprises comparing the product brand information steps with the manufacturing organization steps to identify a match.

Preferably, the at least one candidate manufacturing organization selection comprises selecting as the at least one candidate manufacturing organization each of the manufacturing organizations that has at least one master recipe for the general recipe for the product brand. The at least one candidate manufacturing organization selection may comprise assessing the extent to which each of the manufacturing organizations matches the product brand information and assigning to each of the manufacturing organizations a score, and including within the selection information each of the at least one candidate manufacturing organizations for which the score is above a threshold value. The at least one candidate manufacturing organization selection also may comprise assessing the extent to which each of the manufacturing organizations matches the product brand information and assigning to each of the manufacturing organizations a score, and including within the at least one candidate manufacturing organizations a predetermined number of the manufacturing organizations having the highest of the scores. The at least one candidate manufacturing organization selection also may comprise assessing the extent to which each of the manufacturing organizations matches the product brand information and assigning to each of the manufacturing organizations a rank, and including within the selection information each of the at least one candidate manufacturing organizations in order of the rank. The at least one candidate manufacturing organization selection still further may comprise assessing the extent to which each of the manufacturing organizations matches the product brand information satisfies a weighted set of selection criteria.

The selection information may comprise the number of manufacturing organizations comprising the at least one candidate manufacturing organizations. It also may comprise information sufficient to confirm that the at least one candidate manufacturing organization can manufacture the product brand according to the product brand information, but the selection information excludes information sufficient to identify the at least one candidate manufacturing organization. In a general sense, it is preferable that the selection information comprises information useful to the product brand manager. It may, for example, comprise price information. The selection information may comprise public selection information and private selection information, in which case the selection information communicating preferably comprises communicating the authorized selection information to the product brand manager and withholding the unauthorized selection information from the product brand manager.

The communication of the selection information to the product brand manager preferably comprises communicating the selection information to a product brand manager computer accessible by the product brand manager. It also may comprise communicating the selection information automatically upon the selection of the at least one candidate manufacturing organization, without human intervention.

In some applications it may be desirable to communicate some or all of the selection information to the at least one candidate manufacturing organization, although this typically may not be the case.

In accordance with another aspect of the invention, a method is provided for facilitating communications between a product brand manager and manufacturing organizations using a transactional computer system, wherein the product brand manager has a product brand and product brand information comprising information for manufacturing the product brand, and wherein there is manufacturing organization information for each of the manufacturing organizations comprising the manufacturing process capabilities of the respective manufacturing organization.

The method according to this aspect of the invention comprises communicating the product brand information from the product brand manager to the transactional computer system, and communicating the manufacturing organization information for the manufacturing organizations from the manufacturing organizations to the transactional computer system. The method also comprises using the transactional computer system to process the product brand information and the manufacturing organization information to select at least one candidate manufacturing organization from the manufacturing organizations and to generate selection information regarding the at least one candidate manufacturing organization. The selection is carried out according to this method by the transactional computer system and comprises confirming that the product brand information comprises a general recipe and to the extent the confirmation is not made, converting the product brand information into the general recipe. The method also comprises converting the general recipe into a plurality of master recipes, and comparing the product brand information to the manufacturing organization information. This method further comprises using the transactional computer system to communicate the selection information to the product brand manager. Optional and preferred aspects of the above summarized method also may apply to this method.

In accordance with another aspect of the invention, a method is provided for facilitating communications between a manufacturing organization and product brand managers using a transactional computer system. Each of the product brand managers has a product brand and product brand information comprising information for manufacturing the product brand, and there is manufacturing organization information for the manufacturing organization comprising the manufacturing process capabilities of the manufacturing organization.

The method according to this aspect of the invention comprises communicating the product brand information from the product brand managers to the transactional computer system, communicating the manufacturing organization information for the manufacturing organization from the manufacturing organization to the transactional computer system, and using the transactional computer system to process the product brand information and the manufacturing organization information to select at least one candidate product brand manager from the product brand managers and to generate selection information regarding the at least one candidate product brand managers. The selection comprises using the transactional computer system to compare the product brand information to the manufacturing organization information. The method further comprises using the transactional computer system to communicate the selection information to the manufacturing information.

In accordance with another aspect of the invention, a system is provided for facilitating transactions between a product brand manager and manufacturing organizations, wherein the product brand manager has a product brand and product brand information comprising information for manufacturing the product brand, and wherein there is manufacturing organization information for each of the manufacturing organizations comprising the manufacturing process capabilities of the respective manufacturing organization.

The system comprises a network comprising a transactional computer system, at least one product brand manager computer and a plurality of manufacturing organization computers. Each of the manufacturing organizations has one of the plurality of the manufacturing organization computers. The product brand manager computer comprises a storage device for storing the product brand information and communication means for communicating the product brand information to the transactional computer system. Each of the manufacturing organization computers comprises a storage device for storing the manufacturing organization information for the manufacturing, and communication means for communicating the manufacturing organization information to the transactional computer system. The transactional computer system comprises a processor for processing the product brand information and the manufacturing organization information to select at least one candidate manufacturing organization from the manufacturing organizations and to generate selection information regarding the at least one candidate manufacturing organization. The system also comprises communication means for communicating the selection information to the product brand manager computer without human intervention at the transactional computer system.

In accordance with yet another aspect of the invention, a system is provided for facilitating transactions between a manufacturing organization and product brand managers. Each of the product brand managers has a product brand and product brand information comprising information for manufacturing the product brand, and there is manufacturing organization information for the manufacturing organization comprising the manufacturing process capabilities of the manufacturing organization.

The system comprises a network comprising a transactional computer system, at least one manufacturing organization computer and a plurality of product brand manager computers. Each of the product brand computers has one of the plurality of the product brand manager computers. Each of the product brand manager computers comprises a storage device for storing the product brand information and communication means for communicating the product brand information to the transactional computer system. The manufacturing organization computer comprises a storage device for storing the manufacturing organization information for the manufacturing, and communication means for communicating the manufacturing organization information to the transactional computer system. The transactional computer system comprises a processor for processing the product brand information and the manufacturing organization information to select at least one candidate product brand manager from the product brand managers and to generate selection information regarding the at least one candidate product brand managers. The system further comprises communications means for communicating the selection information to the manufacturing organization computer without human intervention at the transactional computer system.

### BRIEF DESCRIPTION OF THE DRAWINGS

The accompanying drawings, which are incorporated in and constitute a part of the specification, illustrate presently preferred embodiments and methods of the invention and, together with the general description given above and the detailed description of the preferred embodiments and methods given below, serve to explain the principles of the invention.

FIG. 1 shows a diagram of a system according to a presently preferred system embodiment of the invention, and is used herein below to describe a presently preferred but merely illustrative method according to the another aspect of the invention;

FIG. 2 depicts an illustrative company with multiple manufacturing sites;

FIG. 3 depicts an example process cell layout;

FIG. 4 depicts the elements of a unit;

FIG. 5 is a simple block diagram of processing flows according to the preferred implementation;

FIG. 6 illustrates the relationship between a general recipe, master recipe, and equipment;

FIG. 7 shows the subdivision of elements in a master recipe;

FIG. 8 illustrates the relationship between procedural elements of a general recipe and a master recipe;

FIG. 9 is a simplified comparison of the procedural steps of a general recipe and a master recipe;

FIG. 10 is an example recipe segment for a process action;

FIG. 11 is another simplified comparison of the procedural steps of a general recipe and a master recipe;

FIG. 12 is a block diagram illustrating process flows for another aspect of the preferred implementation;

FIG. 13 is the process cell configuration for the first example;

FIG. 14 is a depiction of a general recipe for the first example;

FIG. 15 is another depiction of the general recipe for the first example;

FIG. 16 is shows material flow information for the process cell of the first example;

FIG. 17 shows recipe segment information and material flow information for the process cell of the first example;

FIG. 18 shows unit start and unit end recipe segments for the process cell of the first example;

FIG. 19 shows equipment information for the process cell of the first example;

FIG. 20 is a block diagram of processing flows according to another aspect of the preferred implementation;

FIG. 21 is a block diagram of processing flows according to another aspect of the preferred implementation;

FIG. 22 is a block diagram that shows flows for expanding the general recipe according to FIG. 21;

FIG. 23 is a block diagram that shows flows for creating the preliminary list of recipe segments in accordance with the preferred implementation;

FIG. 24 is a block diagram that shows flows for creating the list of recipe segments in accordance with the preferred implementation;

FIG. 25 is a block diagram that shows flows for creating the collection of segment path series in accordance with the preferred implementation;

FIG. 26 is a block diagram that shows flows for creating the dependency path in accordance with the preferred implementation;

FIG. 27 is a block diagram that shows flows for creating the segment paths in accordance with the preferred implementation;

FIG. 28 is a block diagram that shows flows for creating the production paths in accordance with the preferred implementation;

FIG. 29 is a block diagram that shows flows for determining the optimal production paths in accordance with the preferred implementation;

FIG. 30 is a block diagram that shows flows for determining the production path with the minimum number of material movements in accordance with the preferred implementation;

FIG. 31 is a block diagram that shows flows for determining the production path with the closest match of process action and recipe segment parameter ranges in accordance with the preferred implementation;

FIG. 32 is a block diagram that shows flows for determining the production path with the minimum or maximum user defined weighting factor in accordance with the preferred implementation;

FIG. 33 is a block diagram that shows flows for constructing the master recipes in accordance with the preferred implementation;

FIG. 34 is a block diagram that shows flows for creating the recipe procedure structure in accordance with the preferred implementation;

FIG. 35 is a block diagram for inserting the transfer recipe segments in accordance with the preferred implementation;

FIG. 36 shows the general recipe of the first example including the underlying process actions and process operations in accordance with the preferred implementation;

FIG. 37 shows process stages 2 and 4 of the general recipe of the first example including the material joins and process branches;

FIG. 38 shows the exploded general recipe for the general recipe of the first example;

FIG. 39 shows the dependency path for the general recipe of the first example;

FIG. 40 is a tabular representation for the dependency path of FIG. 39;

FIG. 41 is a detailed depiction of the general recipe of the first example including the identification of the material joins and the process branches;

FIG. 42 shows the preliminary list of recipe segments for process branch 3 of the of the general recipe of the first example;

FIG. 43 shows the list of recipe segments for process branch 3 of the of the general recipe of the first example;

FIG. 44 shows the nomenclature and identification schemes used for the segment paths for the first example;

FIG. 45 shows the segment paths for process branch 3 of the general recipe of the first example;

FIG. 46 shows the possible segment paths corresponding to the process branches of the general recipe of the first example arranged in the structure of the dependency path;

FIG. 47 shows one of the possible production paths corresponding to the dependency path of the general recipe of the first example;

FIG. 48 shows possible production paths corresponding to the dependency path of the general recipe of the first example;

FIG. 49 illustrates the opening of parallel unit procedures during the initial phases of master recipe construction in accordance with the preferred implementation;

FIG. 50 illustrates a unit procedure including unit start and end recipe segments in accordance with the preferred implementation;

FIG. 51 is an example of a unit start recipe segment;

FIG. 52 is an example of a recipe segment, its corresponding process action, and the unit in process cell associated with the process action;

FIG. 53 depicts the creation of new unit operations during master recipe construction in accordance with the preferred implementation;

FIG. 54 is an example of a process operation of a general recipe;

FIG. 55 provides the recipe segments for the process actions of the process operation of FIG. 54;

FIG. 56 is a unit operation corresponding to the process operation of FIG. 54;

FIG. 57 shows a master recipe under construction with a unit procedure being created prior to the insertion of the unit operation of FIG. 56;

FIG. 58 shows the master recipe of FIG. 56 after the insertion of the unit operation of FIG. 56;

FIG. 59 is an example of a unit transfer between two units with no parallel unit operations;

FIG. 60 is an example of a unit transfer between two units with parallel unit operations in both units;

FIG. 61 is an example of a unit transfer between two units with parallel unit operations in the receiving unit;

FIG. 62 is an example of a unit transfer between two units with parallel unit operations in the transfer from unit;

FIG. 63 is an example of a material join involving three units with parallel unit operations in the two transfer from units;

FIG. 64 is an example of a material join involving three units with parallel unit operations in all three units;

FIG. 65 is an example of a material join involving two units with parallel unit operations both units;

FIG. 66 shows a unit transfer with parallel operations in both unit and a dummy unit procedure inserted allowing de-allocation of one of the units before the parallels complete in accordance with the preferred implementation;

FIG. 67 shows a view from the general recipe editor in accordance with the preferred implementation for a summary of header information for the general recipe of the second example;

FIG. 68 shows a view from the general recipe editor in accordance with the preferred implementation for header information for the general recipe of the second example;

FIG. 69 shows another view from the general recipe editor in accordance with the preferred implementation for header information for the general recipe of the second example;

FIG. 70 shows still another view from the general recipe editor in accordance with the preferred implementation for header information for the general recipe of the second example;

FIG. 71 shows a view from the general recipe editor in accordance with the preferred implementation for the process inputs for the general recipe of the second example;

FIG. 72 shows a view from the general recipe editor in accordance with the preferred implementation for the products for the general recipe of the second example;

FIG. 73 shows a view from the general recipe editor in accordance with the preferred implementation for the process dependency chart for the general recipe of the second example;

FIG. 74 shows the flow symbols for the flow diagram of the general recipe view of FIG. 72;

FIG. 75 shows a view from the general recipe editor in accordance with the preferred implementation for the process details of the Sulfurize process stage for the general recipe of the second example;

FIG. 76 shows a view from the general recipe editor in accordance with the preferred implementation for general information associated with an “Add” process action for the general recipe of the second example;

FIG. 77 shows a view from the general recipe editor in accordance with the preferred implementation for process input information associated with an “Add” process action for the general recipe of the second example;

FIG. 78 shows a view from the general recipe editor in accordance with the preferred implementation for the process parameters associated with an “Add” process action for the general recipe of the second example;

FIG. 79 shows a view from the general recipe editor in accordance with the preferred implementation for history information associated with an “Add” process action for the general recipe of the second example;

FIG. 80 shows a view from the general recipe editor in accordance with the preferred implementation for process output information associated with a “Dump” process action for the general recipe of the second example;

FIG. 81 shows a view from the general recipe editor in accordance with the preferred implementation for the process details of the Esterify process stage for the general recipe of the second example;

FIG. 82 shows a view from the general recipe editor in accordance with the preferred implementation for the process details of the Separate process stage for the general recipe of the second example;

FIG. 82 shows a view from the RSBATCH professional recipe editor in accordance with the preferred implementation for the Procedure Flow Chart for the master recipe of the second example;

FIG. 84 shows a view from the RSBATCH professional recipe editor in accordance with the preferred implementation for header information for the master recipe of the second example;

FIG. 85 shows a the Procedure Flow Chart for the unit operation Sulfurize_OP:1 from the master recipe of the second example;

FIG. 86 shows a the detailed Procedure Flow Chart for the unit procedure Sulfurize_UPC:1 from the master recipe of the second example;

FIG. 87 shows a the detailed Procedure Flow Chart for the unit procedure Esterify_UPC:1 from the master recipe of the second example;

FIG. 88 shows a detailed Procedure Flow Chart for the unit procedure Separate_UPC:1 from the master recipe of the second example;

FIG. 89 is a table showing the relationship between the process actions of the general recipe of the second example and the recipe segments from the corresponding master recipe for the example;

FIG. 90 shows a view from the RSBATCH professional recipe editor in accordance with the preferred implementation for a recipe segment from the master recipe of the second example;

FIG. 91 shows a view for mapping recipe segment parameters to process action parameters in accordance with the preferred implementation;

FIG. 92 shows a view for editing recipe phase parameters of the master recipe in accordance with the preferred implementation;

FIG. 93 shows a view for reviewing reports associated with recipe phases of the master recipe in accordance with the preferred implementation;

FIG. 94 shows a view for reviewing messages associated with recipe phases of the master recipe in accordance with the preferred implementation;

FIG. 95 shows the process cell configuration for the second example;

FIG. 96 shows the unit configuration for unit Premix_A from the process cell of the second example;

FIG. 97 shows the unit configuration for unit Reactor_1 from the process cell of the second example;

FIG. 98 is a view for editing equipment information associated with units in the process cell in accordance with the preferred implementation;

FIG. 99 is another view for editing equipment information associated with units in the process cell in accordance with the preferred implementation;

FIG. 100 is still another view for editing equipment information associated with units in the process cell in accordance with the preferred implementation; and

FIG. 101 is a representation of the Sulfurize process stage from the general recipe of the second example using a sequence function chart.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiment and method. The invention according to its various aspects is particularly pointed out and distinctly claimed in the attached claims read in view of this specification, and appropriate equivalents.

In accordance with one aspect of the invention, a system is provided for facilitating transactions between a product brand manager and manufacturing organizations, wherein the product brand manager has a product brand and product brand information comprising information for manufacturing the product brand, and wherein there is manufacturing organization information for each of the manufacturing organizations comprising the manufacturing process capabilities of the respective manufacturing organization.

The system comprises a network, in turn comprising a transactional computer system, at least one product brand manager computer and a plurality of manufacturing organization computers. Each of the manufacturing organizations has one of the plurality of the manufacturing organization computers.

In accordance with another aspect of the invention, a method is provided for facilitating communications between a product brand manager and manufacturing organizations using a transactional computer system. The product brand manager has a product brand and product brand information comprising information for manufacturing the product brand, and there is manufacturing organization information for each of the manufacturing organizations comprising the manufacturing process capabilities of the respective manufacturing organization.

The method according to this aspect of the invention comprises communicating the product brand information from the product brand manager to the transactional computer system, and communicating the manufacturing organization information for the manufacturing organizations from the manufacturing organizations to the transactional computer system. It also comprises using the transactional computer system to process the product brand information and the manufacturing organization information to select at least one candidate manufacturing organization from the manufacturing organizations and to generate selection information regarding the at least one candidate manufacturing organization. The selection preferably comprises using the transactional computer system to compare the product brand information to the manufacturing organization information or to otherwise analyze this information, and using the transactional computer system to communicate the selection information to the product brand manager.

The system and method according to these aspects of the invention are ideally suited for facilitating transactions between one or more product brand managers and one or manufacturing organizations, for example, in which a product brand manager enlists the services of a manufacturing organization to manufacture or process a product brand, typically under a contract arrangement, and typically using product brand information from the product brand manager for the manufacturing or processing. According to the presently preferred system and method, a transactional system, typically independent of both the product brand manager and the manufacturing organization or organizations, is used to receive and process both product brand information and manufacturing organization information, and to match the needs or objectives of each of these parties to select those whose needs or objectives match or are sufficiently comparable.

In a typical but merely illustrative transaction, for example, a product brand owner may wish to retain a contract manufacturing organization to manufacture a particular product brand according to the product brand manager's specified procedures, quality requirements, delivery requirements, etc. The transactional system will take this information, process it, for example, as described herein below, and compare it to similar information pertaining to various potential contract manufacturing organizations. In so doing, the manufacturing capabilities, availability, pricing, etc. of each of the manufacturing organizations is compared to the needs and requirements of the product brand manager's request. This procedure may be used to identify a particular manufacturing organization, or it may result in the compilation of a plurality or list of qualified candidate contract manufacturing organizations that can satisfy the product brand manager's need.

A variety of different transactions are possible. The product brand managers may contract the manufacture of the product brands belonging to the product brand managers to one or more of the manufacturing organizations, and the product brand manager may subsequently buy the product brand directly from the manufacturing organization for resale or for direct consumption by the product brand manager. An example of this might be a major food retailer who owns the rights to a trade name food product, such as “ABC ketchup,” and owns a chain of grocery stores who sell the “ABC ketchup.” The food retailer may contract a manufacturing organization that manufactures food products to manufacture the “ABC ketchup.” The food retailer would then buy the “ABC ketchup” directly from the manufacturing organization under contract.

The product brand manager also may contract one or more of the manufacturing organizations for both the manufacture and the sale of the product brand. In this latter scenario, the product brand manager will typically have some form of licensing agreement with the manufacturing organization that provides for a fee or royalty paid to the product brand owner based on the sales volume of the product brand. An example of this case might be a product development organization that develops a “ABC ketchup,” but has no manufacturing capability or sales distribution channel for the “ABC ketchup.” In this case, the product development organization may license a food manufacturer and retailer that has both the manufacturing capabilities and the sales distribution channels to manufacture and distribute the “ABC ketchup.” The food manufacturer would manufacture and sell the “ABC ketchup” and pay the product development organization a fee or royalty for the privilege to manufacture and sell the “ABC ketchup.”

The product brand manager also may license one or more of the manufacturing organizations to manufacture the product brand and provide it to a third party such as a distributor, with the product brand manager paying the manufacturing organization for the manufacture of the product brand. In this case, the third party such as the distributor may pay the product brand manager for the product brand it receives from the manufacturing organization under contract.

The preferred system and method also may be used, for example, where a contract manufacturing organization, e.g., having extra capacity in a particular area, seeks a product brand manager of a product brand in that area with whom to contract to utilize that extra capacity. The capabilities of the contract manufacturing organization could be compared to the needs of the product brand owners to select potential or candidate product brand owners for such a transaction. Thus, the transactional computer system would comprise a processor for processing the product brand information and the manufacturing organization information to select at least one candidate product brand manager from the product brand managers and to generate selection information regarding the at least one candidate product brand managers; and communications means for communicating the selection information to the manufacturing organization computer without human intervention at the transactional computer system.

Thus it can be seen that, in general terms, the system and method according to this aspect of the invention facilitate transactions among product brand managers and manufacturing organizations, for example, by serving as an intermediary to evaluate and compare their respective objectives, needs, requirements, capabilities, schedules, etc., and to bring them together as is appropriate. The system and method in their preferred implementations allow this to be done while limiting access, or preventing access altogether, to the other party's information, which often is considered confidential or proprietary.

In accordance with these aspects of the invention, it is desirable although optional that as much of the process as is practicable be carried out by computers or like machines with minimal human intervention. Accordingly, the communicating of the product brand information from the product brand manager to the transactional computer system preferably is performed without human intervention at the transactional computer system. The communicating of the manufacturing organization information for the manufacturing organizations from the manufacturing organizations to the transactional computer system also preferably is performed without human intervention at the transactional computer system.

In addition, it is preferred that the using of the transactional computer system to process the product brand information and the manufacturing organization information to select at least one candidate manufacturing organization from the manufacturing organizations and to generate selection information regarding the at least one candidate manufacturing organization is performed without human intervention at the transactional computer system. It is also preferred that, the use of the transactional computer system to compare the product brand information to the manufacturing organization information and the use of the transactional computer system to communicate the selection information to the product brand manager are performed without human intervention at the transactional computer system, or with limited intervention. Such limited intervention, for example, may comprise or consist of merely inspecting and appraising selection processing results as a quality control check before the selection information is communicated to the intended recipients.

Each of these aspects of the invention, and the preferred embodiments or implementations of it, will be described more fully below.

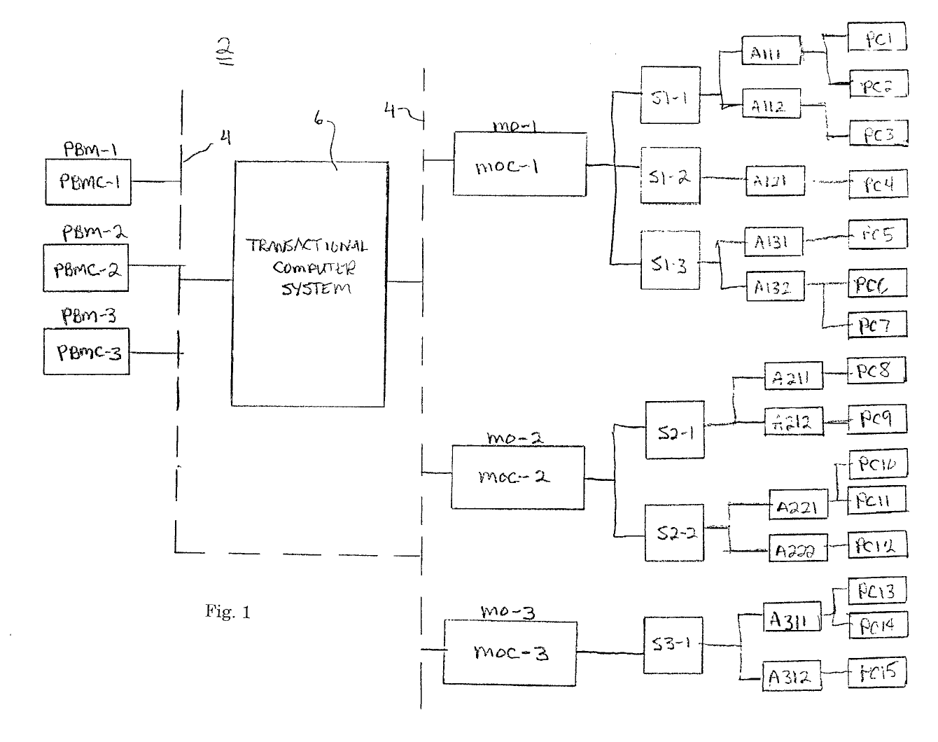

A system 2 according to a presently preferred system embodiment of the invention is shown in FIG. 1. System 2 also will be used herein to describe and illustrate the principles of a presently preferred version of the method according to the invention. It should be noted, however, that the method of the invention is not limited to the specific hardware, configuration and description of the preferred system. Some features of the invention, or of preferred system embodiment and preferred method, are common among the system and method. Accordingly, the preferred system embodiment and the preferred method collectively or commonly will be referred to herein as the “preferred implementation.”

With reference to FIG. 1, in accordance with the preferred implementation, system 2 comprises a network 4 which in turn comprises a transactional computer system 6.

In the preferred implementation, a plurality of product brand managers PBM-1, PBM-2, PBM-3, . . . , as generally described above are in the manufacturing community. Each of these product brand managers is assumed herein to have and manage at least one product brand, and is assumed to require the services of a manufacturing organization to manufacture its product brand. Each such product brand manager also has a product brand manager computer PBMC-1, PBMC-2, PBMC-3, . . . , respectively, at its facility and under its control, but operatively coupled to transactional computer system 6 via network 4.

Each of the product brand manager computers may comprise a single, stand alone machine, or it may comprise a plurality of machines, e.g., configured in a network. The transactional computer system 6 is operatively coupled to the product brand computer via network 4 so that product brand information can be communicated from the product brand computer to the transactional computer system, and so that “selection information” as described herein may be communicated back to the product brand computer.

Each of the product brand manager computers according to the preferred embodiment comprises a PC-based system or small business machine that includes a processor, a storage device for storing the product brand information, and communication means, such as a modem, network card, network connection, or other coupling device, for communicating the product brand information to the transactional computer system. The processor may be any processing device capable of performing the processing functions described herein. Preferred examples would include a current generation processor or microprocessor commercially available as part of commercially offered PC-based or small business computers.

The storage device may comprise any form of storage medium or media suitable for operating with the product brand manager computer and capable of receiving, storing and providing the information as generally described herein. Examples of such storage media would include a hard drive, a diskette drive, a tape drive, an optical storage drive, a ZIP drive, and the like.

The product brand manager computer of any given product brand manager alternatively may comprise multiple computers, e.g., in a local area network, a distributed network, a virtual private network, or other form of connectivity.

The product manager computers further comprise communication means for communicating with the transactional computer system, for example, to communicate product brand information to the transactional computer system and to receive selection information from it. The communications means may comprise any means suitable for operation with the product brand manager computer and the network upon which it operates. Examples of such communication means would include a modem, a network card, a network or other communication hub or interface, and the like. The product brand manager computers in the preferred implementation are configured to communicate with the transactional computer system with little or no human intervention once the process of requesting that manufacturing organization be identified has been made to the transactional computer system.

Each of the product brand manager computers or machines PBMC-1, PBMC-2, PBMC-3, . . . stores product brand information for the product brand or brands managed by that product brand manager. Product brand information as the term is used herein refers broadly to information that pertains to the product brand. Examples of such product brand information may include information pertaining to the manner in which the product brand is manufactured or processed, such as a formula for making the product brand, a general recipe for such manufacture, properties of the product brand, pricing or cost information, schedule information, for example, as to when certain quantities of the product brand are needed, delivery information regarding where such product is to be delivered, quality information, etc.

The product brand information also may include a listing of one or more of the product brand owners in the manufacturing community and the manufacturing process requirements for the product brands owned by the listed product brand owners. Preferably, the product brand owners have one or more general recipes for each of the product brands belonging to them. Each general recipe describes how to manufacture the product brands independent of equipment. The product brand information also may include information derived from one or more general recipes.

Each of the manufacturing organizations in the preferred implementation similarly comprises (e.g., has) one of the manufacturing organization computers MOC-1, MOC-2, MOC-3, . . . . Each of these machines is or can be operatively coupled to transactional computer system 6 via network 4. Each manufacturing organization computer in this implementation comprises a single, stand alone computer. The manufacturing organization computer as referred to herein alternatively may comprise multiple computers, e.g., comprising a manufacturing organization computer system network. The network may comprise a local area network, a distributed network, a virtual private network, or other form of connectivity. Each of the manufacturing organization computers in this implementation comprises a PC-based or small business computer or system, in turn comprising a processor, a storage device for storing the manufacturing organization information for the manufacturing, and communication means, such as those identified above, for communicating the manufacturing organization information to the transactional computer system. The storage device and communications means may be as described above for the product brand manager computers.

Each of the manufacturing organization computers is coupled to network 4 and configured to receive communications from the transactional system computer and to communicate its manufacturing organization information and possibly other information to the transactional computer system. This includes circumstances in which the transactional computer system is provided access to the manufacturing organization computer so that the former may obtain information from the latter without direct intervention or assistance from the manufacturing organization.

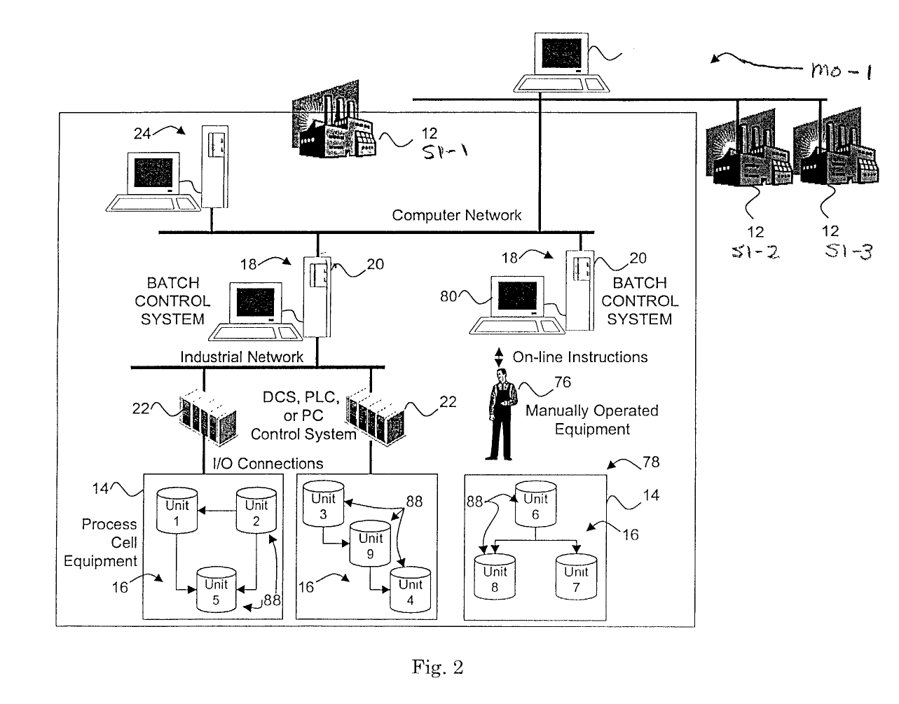

In describing the preferred implementation, it is useful to consider the aspects of manufacturing organizations involving sites, areas, and process cells. A site as the term is used herein refers generally according to its common meaning in the field, for example, to mean a physical location at which a manufacturing organization conducts manufacturing or processing operations. As noted above, manufacturing organizations typically have at least one site, and often have a number of sites, where the actual manufacturing tasks occur. Very large manufacturing organizations may have tens or even hundreds of manufacturing sites. The manufacturing capabilities of each manufacturing site within a single manufacturing organization may vary substantially from site to site. To illustrate this in the preferred implementation, manufacturing organization MO-1 has three sites, S1-1, S1-2 and S1-3, manufacturing organization MO-2 has two sites, S2-1 and S2-2, and manufacturing organization MO-3 has one site, S3-1. A general site will be identified herein and in the drawings by the reference numeral 12. FIG. 2 shows in diagrammatic form the layout of an illustrative yet representative manufacturing organization MO-1. This manufacturing organization comprises the three sites S1-1, S1-2 and S1-3.

An area as the term is used here is used according to its common meaning in the field, for example, to comprise a physical location at which a manufacturing organization conducts manufacturing or processing operations with a set of process cells. portion of a site in which production or processing may take place.

As shown in FIG. 1, manufacturing organization MO-1 has two areas, A111 and A112, associate with site S1-1, area A121 associated with site S1-2, and areas A131 and A132 associated with site S1-3. Manufacturing organization MO-2 has two areas, A211 and A212, associate with site S2-1, and areas A221 and A222 associated with site S2-2. Manufacturing organization MO-3 has two areas, A311 and A312, associate with site S3-1.

Each manufacturing site and/or area preferably includes at least one process cell. The term process cell is used here according to its common meaning in the field, for example, to refer to one or more items of process equipment at a site that are configured or may be configured to carry out a process. A process cell is identified generally herein by reference numeral 14. With reference to FIG. 1, area A111 has associated with it process cells PC-1 and PC-2, area A112 has associated with it process cell PC-3, area A121 has associated with it process cell PC-4, area A131 has associated with it process cell PC-5, area 132 has associated with it process cells PC-6 and 7, area A211 has associated with it process cell PC-8, area 212 has associated with it process cell PC-9, area A221 has associated with it process cells PC-10 and 11, area 222 has process cell PC-12, area 311 includes process cells PC-13 and 14, and area A312 includes process cell PC-15.

With reference to FIG. 2, each process cell 14 has associated with it a set of equipment 16 for manufacturing products, such as the product brands, using the cell. Preferably, information pertaining to the site (“site information”) includes equipment information describing the manufacturing capabilities of the set of equipment in each process cell. The set of equipment in each process cell preferably includes multiple individual pieces of equipment, and the equipment information associated with that site or process cell describes the processing capabilities of each piece of equipment in the process cell.

Each manufacturing site has at least one process cell 14, which manufactures the product or group of products. The process cell has a set of equipment 16 located in the cell, which is used to process materials and manufacture the products. The process cell 14 has a batch control system 18 that controls operation of the process cell. The batch control system preferably includes a batch server 20 that interfaces the process cell through the process connected devices 22. There may be one batch control system 18 for each process cell 14, or the batch control system may interface and control multiple process cells. The process connected devices 22 are preferably process controllers or equipment with the capability of directly communicating with the batch server 20. The process connected devices 22, or PCD's, are electrically, optically or physically connected to the set of equipment 16. The process controllers include both the software programming and logic to interface with and control the operation of the set of equipment. Typical process controllers are made by various companies throughout the control industry.

The batch control system 18 may be connected to a site computer system 24. The site computer system may be connected to a company 10, or global computer system 26, such as a global enterprise resource planning system, or ERP.

The batch server preferably interfaces the PCD's by industry standard interface software such as WINDOWS® Dynamic Data Exchange, or WINDOWS® DDE by Microsoft Corporation of Redmond, Wash., or OPC defined by the OPC Foundation, Boca Raton, Fla. This software provides the communications protocols for the communication link between the PCD's 22 and the batch control system 18 through the batch server 20.

The process connected devices 22 are connected to batch server 20 by industry standard communication connections, such as MODBUS by Schneider Electric of North Andover Mass., DEVICENET by Open Devicenet Vendors Association of Boca Raton Fla., PROFIBUS by Siemens Corporation of Munich Germany, and DATA HIGHWAY by Honeywell Corporation of Minneapolis Minn.

The batch server 20 preferably has a process control application, or PCA, such as a batch control software application, operating on it to allow operators to interface with the process cell 14. This allows the operators to monitor and control the set of equipment 16 in the process cell directly from the batch control system. The preferred PCA is RS BATCH by Rockwell Automation of Milwaukee, Wis. The batch server 20 may be any configuration of computer that will operate the PCA and allow the operators to control the process cells to manufacture the products. The batch server 20 has the appropriate software loaded on the server required by the PCA. A typical configuration of a preferred server is a current generation IBM type personal computer with a minimum of a 300 megahertz PENTIUM processor with 256K of cache RAM by Intel Corporation of Santa Clara, Calif. or equivalent, with a minimum of 128 megabytes of RAM, a 2 gigabyte hard drive, a 20×CD ROM, a 10 megabit ETHERNET Card, a 3½ inch floppy drive, a 512K 800×600 resolution graphics card, an 800×600 resolution VGA 17 inch monitor, and a UPS with ½ hour rating. The server 20 preferably has the following minimum software loaded and operating on it: WINDOWS® NT 4.0, WINDOWS DDE, and SQL Server Version 7 by Microsoft Corporation of Redmond Wash. and RSBATCH, Batch Service Manager, and Batch History Archiving by Rockwell Automation of Milwaukee, Wis. The batch control system 18 preferably has operator terminals configured to allow the operator to interface the system. One server may support multiple terminals or clients. These terminals are typically personal computers with a configuration sufficient to allow the operators to access the batch control system 18 and perform their duties. An example configuration for an operator terminal is a current generation IBM type personal computer with a minimum of a 166 megahertz PENTIUM processor with 256K of cache RAM by Intel Corporation of Santa Clara, Calif. or equivalent with a minimum of 64 megabytes of RAM, a 1 gigabyte hard drive, a 20×CD ROM, a 10 megabit ETHERNET Card, a 3½ inch floppy drive, a 512K 800×600 resolution graphics card, an 800×600 resolution VGA 17 inch monitor, and a UPS with ½ hour rating. The terminal preferably has the following minimum software loaded and operating on it: WINDOWS® NT 4.0, WINDOWS® DDE, and SQL SERVER Version 7 by Microsoft Corporation of Redmond Wash. and RSBATCH, BATCH SERVICE MANAGER, and BATCH HISTORY ARCHIVING by Rockwell Automation.

The batch control system 18 from any one process cell 14 preferably is connected to the site computer system 24 so that other personnel may access some or all of the data and features provided by the process control application.

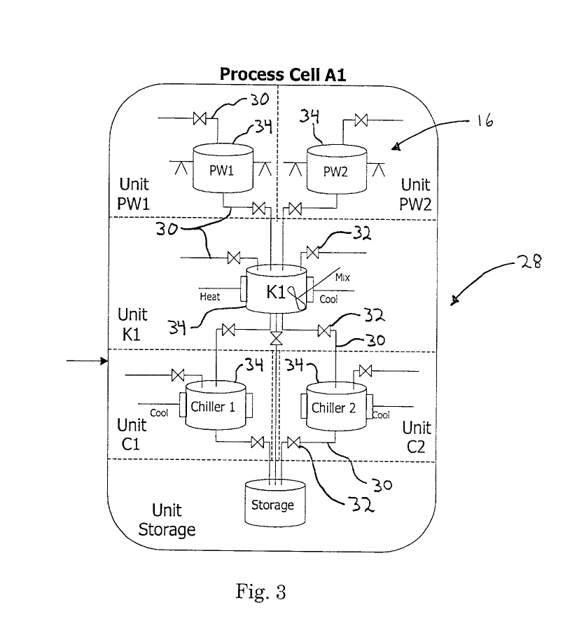

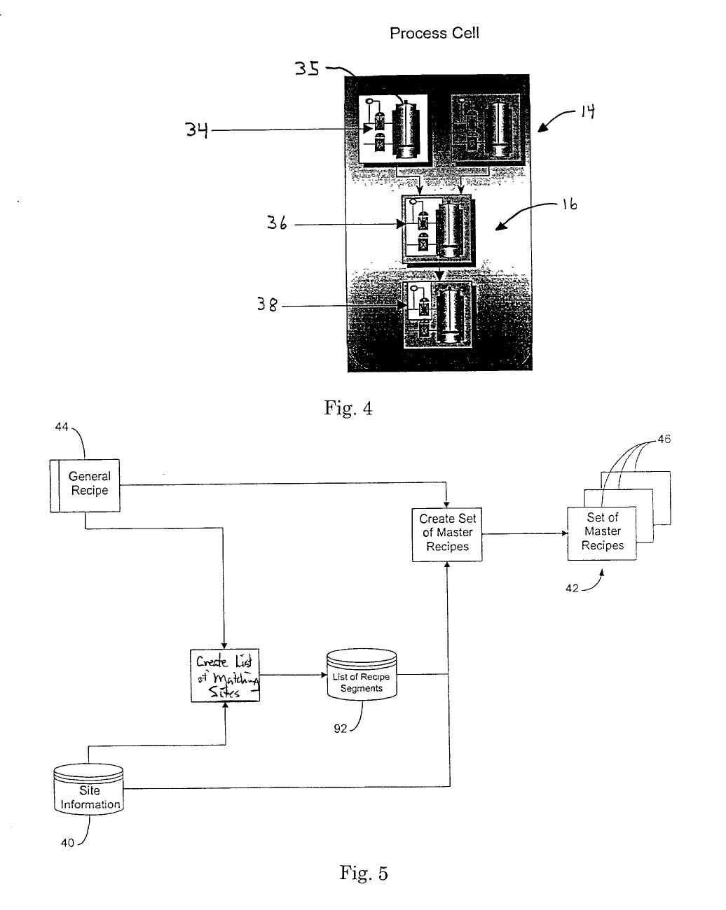

In the preferred implementation, the set of equipment 16 in the process cell 14 preferably is process equipment for batch processing groups or lots of bulk materials such as gases, liquids, or bulk solids such as powders or granules. This variety of equipment is commonly used throughout the chemical, pharmaceutical, and food industries. The set of equipment 16 is typically arranged in the process cell 14 with a specific equipment layout 28 that includes the location of the equipment within the process cell, as well as the allowable material flow paths 30 within the process cell and between the equipment, an example of which is shown in FIG. 3. The material flow paths 30 generally include flow control devices 32, such as valves, pumps, flow regulators, flow meters, etc., to route and control the flow of materials throughout the process cell as shown in FIG. 4. The material flow paths 30 route input materials into the process cell and into the equipment, process intermediate materials between the equipment within the process cell, and final products out of the process cell.

The set of equipment 16 in the process cell 14 is broken down into units 34 that are for processing a batch of material, as shown in FIGS. 3 and 4. These units are typically capable of holding the batch of material as it is being processed. They often comprise large reservoirs 35 that hold the material and the associated equipment module 36 that performs the processing of the batch of material. The equipment module 36 comprises a collection of control modules 38 that are associated with a specific unit 34. Each equipment module 36 can carry out a finite number of specific processing activities related to the unit 34 with which they are associated, for example, a weigh tank, a process heater, a scrubber, etc. The control modules 38 are the lowest level of grouping of equipment that can carry out basic control, such as a valve and the associated solenoid to open and close the valve. The control modules 38 preferably are connected to a process connected device 22 or are themselves a process connected device in communication with the batch control system 18. The batch control system 18 controls manufacture in the process cell 14 through its interface to the control modules 38 within the process cell. Although each control module typically can be operated independently of all of the other control modules in the process cell, the logical grouping of the control modules 38 into the hierarchy of equipment modules 36, units 34, and process cells 14 provides for a more organized picture of the process equipment. This structure often simplifies the task of controlling a process to manufacture a product.

Each piece of equipment in the process cell has a variety of characteristics associated with it. These characteristics include capabilities (such as capacities, maximum and minimum limits, material compatibilities, etc.), classifications (such as unit, control module, heater, chiller, scrubber, reactor, etc.), associations with other equipment (such as identification of material flow paths to other equipment, unit ID with which a control or equipment module is associated, etc.), and the like. All this information is specific to a process cell 14 and a site and constitutes site information 40.

“Manufacturing organization information” as the term is used herein refers broadly to information pertaining one or more manufacturing organizations, including but not limited to any site, area or process cell within it. A common form of such information would comprise information regarding the location of the manufacturing organization, site, plant, area and/or process cell, its size, its manufacturing capabilities, particularly as they related to certain products or classes of products, specific site information, area information, process cell information, etc. Manufacturing organization information typically will comprise such things as equipment information, flow information, scheduling information, price information, cost information, delivery information, capacity information, and the like. The manufacturing organization information may and preferably does comprise other characteristics describing the manufacturing capabilities of each manufacturing organization, such as manufacturing capacity describing the quantity of each product or classification of product each manufacturing organization can produce in a given time interval. The manufacturing organization information may also include relative cost factors describing the cost of product produced by the manufacturing organization relative to its competitors or among its various sites, safety and regulatory data such as the hazard classifications of the products each manufacturing organization is capable of producing, certification information for each manufacturing organization such as ISO 9000 or AALA (American Association of Laboratory Accreditation) certified, etc. Preferably, the site information or the manufacturing organization information includes at least recipe segment information, material flow information, and equipment information.

Each manufacturing organization or its designate manufactures, or is qualified to manufacture, one or more products or one or more classes of product. The product classifications may be very general or broad, for example, chemical products or food products, or they may be much more specific, for example polybutadiene resins or inorganic alkali and alkaline metal salts. The product classifications may include multiple levels of classification for each company starting with broad classifications and becoming narrower with each subsequent level, for example chemical, organic compounds and polymers, aromatic, benzene derivatives, etc. Accordingly, the manufacturing organization information may and preferably does include not only a listing of the various manufacturing organizations in the manufacturing community, but also some or all of the products and product classifications that each of the listed manufacturing organizations are capable of producing.

The manufacturing organizations also may and often do have the capability to adjust their existing manufacturing processes to correspondingly change some feature of the resulting product, or to make a different product or products, or class or classes of product, altogether. This type of information also may be included in the manufacturing organization information for applicable ones of the manufacturing organizations.

The manufacturing organization information communicated to and retained at the transactional system preferably includes a listing of one or more of the manufacturing sites, their respective sites, etc., as well as manufacturing organization information for the respective manufacturing organization, as will be clear from the remaining description herein below.

Transactional computer system 6 may comprise a single, stand alone computer, but also may comprise a plurality of computers, for example, coupled to network 4. The computers comprising the transactional computer system may comprise personal computers, small business computers, one or more servers, work stations, one or more main frames, or any other computer or combination of computers capable of receiving, storing, processing and communicating product brand information and manufacturing community information as generally described herein. Where multiple computers are used, they may be coupled in a local area network, a wide area network, a virtual private network, and the like. They may be used in a distributed architecture to comprise a distributed database.

Transactional computer system 6 according to the preferred implementation comprises a current-generation personal computer (“PC”) having storage means such as those described above for the product brand manager computers, and a processor such as those in commercially available PCs for processing the product brand information and the manufacturing organization information, for selecting at least one candidate manufacturing organization from the manufacturing organizations, and for generating selection information regarding the at least one candidate manufacturing organization.

The system also comprises communications means, such as those referred to herein above, for communicating the selection information to the product brand manager computer, preferably without human intervention at the transactional computer system.

In the preferred implementation, the product brand information, the manufacturing organization information and the selection information are retained in the transactional computer system in the form of data files. Preferably the information is contained in one or more binary data files or relational databases or a combination of the two, as described above. This allows the information to be organized in a manner that allows the information to be easily analyzed and processed.

In accordance with the preferred implementation, product brand information is communicated to the transactional computer system 6 via the network connection 4. This product brand information may comprise any one of the various forms of product brand information noted above. In the preferred implementation, the product brand information normally will comprise a query or request from the product brand manager, via the product brand manager computer and the network connection, for manufacturing organizations that are capable of manufacturing the product brand. The product brand information thus typically will comprise the identity of the product brand, the quantity required, the delivery time, schedule, etc., geographic requirements, price requirements, etc. The product brand information also typically will comprise formula or recipe information for the manufacture (processing) of the product brand. This information may be in a normalized format, such as a general recipe format. To the extent that it is not, it may be preferable to convert it to a normalized format such as general recipe, as described in greater detail below. Normalized is used according to its known meaning in the process industries to comprise a standard or uniform set of data or quantity definitions, data organization, formatting, units, etc., so that it can be compared, interchanged, processed, etc. using standard, predetermined or normalized procedures.

Further in accordance with the preferred implementation, the manufacturing organization information also is communicated to the transactional computer. This information also may and preferably does comprise a normalized format.

The product brand information and the manufacturing information in the preferred implementation are stored in a database, preferably residing in or readily accessible by the transaction computer 6 system. Where the transactional computer system comprises a plurality of machines, the database may comprise a distributed database. Regardless of the form of the database, in the preferred implementation the database is secure. Preferably, and in the preferred implementation, no product brand managers may gain direct access to manufacturing organization information and no manufacturing organization may gain direct access to product brand information residing in transactional computer system 6. Such information, and normally only very limited amounts of it, may be provided by the transactional computer system with or as part of the selection information, but such disclosures are tightly controlled.

To facilitate processing, comparison, etc. of product brand information and manufacturing organization, it is sometimes necessary and often desirable to ensure that the format the information is amenable to such tasks. The members of the manufacturing community do not necessarily use the same process language, variables, units, etc. to describe the product brand information and/or manufacturing organization information in a given instance. Accordingly, the system and method according to the invention may optionally comprise such formatting to modify the information to useable form or a form that is more amenable to the desired processing and comparison.

In a general sense, one may define a set of normalized parameters for some or all of the parameters that are to be processed, compared, etc. This may be accomplished, for example, by providing a normalized set of process parameters, converting the product brand information to the normalized set of process parameters, and converting the manufacturing organization information to the normalized set of process parameters. The normalized set of process parameters, for example, may include inputs, in normalized or standardized units, such as kg, liters, or the like, and outputs, also in normalized or standardized units. The conversion may include, for example, converting all quantities to these normalized or standardized units.

Formatting also may, and preferably does, take the form of a general recipe a general recipe for the product brand information and a plurality or set of master recipes or information that would enable one to derive a plurality or set of master recipes for the manufacturing organization information. The processing according to the preferred method in this case may comprise formatting the product brand information to comprise a general recipe, and converting the general recipe to a plurality of master recipes based on the manufacturing information. The master recipes also may be compared to the manufacturing information.

In preferred implementation, the product brand information comprises processing information required to make the product brand. The manufacturing organization information similarly comprises steps or processes capable of being carried out by the manufacturing organization. Thus, the processing according to the system and method may comprise comparing the product brand information steps or processing with the manufacturing organization steps or processing to identify a match.

The selection of the at least one candidate manufacturing organization using the transactional computer system may be undertaken in a number and variety of different ways, although each preferably is undertaken automatically or semi-automatically with minimal or no human intervention. In accordance with the presently preferred implementation, the selection is undertaken in stages or levels, proceeding from relatively simple or rudimentary screening to more complex and time- or processing-intensive tasks or approaches. At the initial or screening level, transactional computer system 6 preferably compares product brand manager requirements such as product brand or product class, geographic location requirements, volume or quantity requirements, manufacturing organization affiliation information, scheduling and delivery requirements, etc. These product brand manager requirements are compared to the capabilities and availabilities of each of the manufacturing organizations, and those manufacturing organizations for which there is no match are eliminated as potentials or candidates. The transactional system computer 6 can be configured to allow for a certain amount of mismatching, for example, where most product brand manager criteria are met but not all, or where a product brand manager requirement is not met, but is nearly met.

For those manufacturing organizations that meet the screening criteria at the first level of selection analysis, a secondary level of analysis, or multiple subsequent levels of analysis, may be undertaken. A secondary level of analysis, for example, may involve conducting pricing and delivery information in which an assessment is made of the range of prices the product manager is likely to face for each remaining candidate manufacturing organization. Threshold criteria then may be used at each stage, for example, wherein only the top ten manufacturing organizations in terms of delivered price continue to be considered candidate manufacturing organizations.

A more detailed approach to the selection process involves actually or effectively simulating from the manufacturing organization information of each of the candidate manufacturing organizations the capabilities and tasking at an operational level that would be involved in performing the transaction. This may involve, for example, analyzing and comparing the specific plant and equipment, layout, production factors, etc., for each manufacturing organization, and in the process assessing whether the manufacturing organization can meet the requirements, specifically how those requirements can be met, the material and other requirements that the manufacturing organization will have to address to undertake the transaction, etc.

An illustrative example of this type of selection approach, and one that is particularly useful where the product brand manager requirements involve a batch process, is to take advantage of the definitions and procedures set forth in the Instrumentation, Automation and Systems Society (“ISA”) Standard S88.01, released in October of 1995. In accordance with this illustrative selection approach, the product brand information comprises one or more general recipes for the manufacture of the product brand, and the selection of the at least one candidate manufacturing organization comprises selecting as the at least one candidate manufacturing organization each of the manufacturing organizations that has at least one master recipe for the general recipe for the product brand. The approach also may be undertaken using the general equivalent of these formula or recipe formats and comparing them to the specific capabilities, e.g., equipment, materials handling, flow and delivery systems, etc., of the candidate manufacturing organizations.

It is generally recognized in the industry that there are four major categories of procedure types for batch or batch-type processes. These four procedural categories are given in ISA S88.01 as the “general recipe,” the “site recipe,” the “master recipe,” and the “control recipe.” The definitions of these categories of procedures as given in ISA S88.01 follow. The ISA S88.01 definition of “recipe” is also given for reference purposes.

General Recipe—A type of recipe that expresses equipment and site independent processing requirements.

Site Recipe—A type of recipe that is site specific.

Master Recipe—A type of recipe that accounts for equipment capabilities and may include cell-specific information.

Control Recipe—A type of recipe, which, through its execution, defines the manufacture of a single batch of specific product.

Recipe—The necessary set of information that uniquely defines the production requirements for a specific product.

The term “general recipe” as used herein means the equipment independent procedure for manufacturing a product or group of products from one or more input materials. As with the master recipe, the general recipes are typically quantity independent. The definition of term general recipe as used herein includes both the definition of the term general recipe and the term site recipe as given in ISA S88.01. The term general recipe as used herein may or may not include certain site specific information that is independent of equipment, such as local language (i.e., English, French, German, etc.), engineering units (i.e., metric vs. British system), site specific operating instructions, safety and regulatory requirements, etc.

The term “master recipe” as used herein refers to the equipment specific procedure for manufacturing a product, or group of products, from one or more input materials in a process cell using a specific set of equipment with a specific equipment layout. The master recipes are generally quantity independent and represent material quantity requirements normalized to the amount of product being produced. The term master recipe as used herein also includes quantity-specific recipes such as control recipes, as described in more detail later. The term specific set of equipment means the same type and numbers of equipment, which can perform the same processes, requiring the same commands from the supervisory computer system to perform these processes. The term specific equipment layout means the equipment items are interconnected to allow materials to flow between the different pieces of equipment in the same manner, so that materials may be routed to and from equipment in the same manner with the same control commands from the supervisory computer system.

The term “control recipe” as used herein conforms to the ISA S88.01 definition of control recipe, and means the specific recipe for manufacturing a specific lot of product in a specific quantity from specific quantities of input materials. The control recipe is the recipe required to “push the button” on the control system and make the product. Generally speaking, the master recipe and the control recipe as defined in ISA S88.01 are very closely related. Each control recipe is generally created from a quantity independent master recipe prior to production of the product in the process cell, often immediately prior to production. The additional information required to create the control recipe from the quantity independent master recipe will vary from product to product and site to site. The additional information generally includes the quantity of product to be manufactured. This may be the only information required to create the control recipe from the quantity independent master recipe, or the information may further include, for example, identification of the input material lots to be used, time stamps for the actual time of manufacture, identification of the actual product lot to be produced, and other lot and batch specific information that is required to manufacture a specific lot of product in a specific quantity.

The control recipe may be created from the quantity independent master recipe automatically without human intervention, semi-automatically with only slight human intervention, or manually by having an operator enter the required information directly into a copy of the quantity independent master recipe or, alternatively, an old control recipe on file. This will vary from company to company and from site to site depending upon such things as the company standards and the process control system available at the location of manufacture. Typically, the conversion of quantity independent master recipes to control recipes is a relatively straightforward process. The master recipe and the control recipe as defined in ISA S88.01 are very similar. Therefore, the term master recipe as used herein includes both the master and control recipes as defined in ISA S88.01.

The conversion of general recipes to master recipes is not a trivial process, however. This effort requires a thorough or complete knowledge of the set of equipment (such as its processing capabilities and constraints) and the equipment layout in the process cell for which the product is targeted to be manufactured. Process cells often can support many procedures due to the multitude of possible permutations of the equipment included in the set of equipment, which may be used to manufacture the product. This further complicates the process. In addition, typically there is not a one to one relationship between process operations, which are to be performed, and the equipment operations available to perform them. ISA S88.01 identifies the two different models required to describe the general and the master recipe as the process model and the procedural control model respectively.

The process model defines the equipment independent procedure for manufacturing the products, or the general recipe, in terms of process actions. Process actions are the smallest element, which can be performed in the process model. Process actions are simple actions to be performed on the materials, such as charge material, heat, mix, discharge material, etc. The steps of the general recipe preferably are defined by process actions.

The procedural control model defines the equipment specific procedure for manufacturing the products, or the master recipe, in terms of recipe phases. “Recipe phases” are the smallest element of the procedural control model that can be performed on the equipment with the master or control recipe. Unfortunately, there is rarely a one-to-one relationship between the elements of the two models. It often takes multiple recipe phases to perform one process action. The simple process action of charge 0.2 lb. per lb. product of material A into unit one may require the recipe phases corresponding to open the exit valve, evacuate the vessel, verify the vessel weight indicates empty, close the exit valve, monitor the vessel weight, activate inlet pump A at 30 RPM, open inlet valve A, when vessel weight increase equals 200 lbs close inlet valve A, deactivate inlet pump A. Historically master recipes have generally been created manually from the general recipes or, alternatively, from other master recipes for products with similar manufacturing procedures. Due to the complex nature of the task, the creation and verification of master recipes from corresponding general recipes has historically been a costly and time-consuming task.

Manual creation and verification of master recipes typically is not very reliable and is prone to error. It usually requires one or more pilot or trial runs with the new master recipe to validate the recipe. The material used for this validation often becomes scrap.

The time consuming nature of manually creating and maintaining master recipes often means that the optimization of master recipes relative to parameters such as cost, production time, or even production location, is not performed. Companies are generally forced to have a restricted number of non-optimized master recipes with which to manufacture their products.

In accordance with the preferred implementation, the product brand information comprises one or more general recipes. The processing in this implementation correspondingly comprises converting each general recipe that is provided as part of the product brand information into at least one master recipe, preferably a plurality of such master recipes. The master recipes preferably are constructed using manufacturing organization information regarding the respective manufacturing organizations so that, in the process of the conversion, an evaluation is made not only of the ability of each manufacturing organization to perform the general recipe, but information is gleaned as to the particular manner in which the manufacturing organization will or can achieve this result.

It has been noted above that the manufacturing capabilities of the manufacturing organizations typically are or may be described by site information. The site information normally includes a list of recipe segments available at the manufacturing site and a summary of all the process actions that each available recipe segment performs, as described above. The process actions are the fundamental operations that might be performed on materials to manufacture products throughout the entire manufacturing community. Other than differences in the terminology, or process language, used by different community members, all of the manufacturing process requirements of every product brand and all of the manufacturing process capabilities of every manufacturing organization within the entire manufacturing community can be described using only the list of community process actions, as described above. Thus, the manufacturing process requirements for any product brand may be uniquely and universally described through the use of process actions in a general recipe and the manufacturing process capabilities for any manufacturing organization may be universally described by the list of process actions available that is contained in the site information.

In the preferred implementation, the manufacturing community information may be communicated to or received by the transactional computer system related using a plurality of process languages consisting of a standard process language and one or more foreign process languages. Each member of the manufacturing community uses at least one of the standard process language and the foreign process languages to relate the manufacturing community information. The method preferably includes the step of translating the manufacturing community information in a foreign process language to the standard process language. The standard process language preferably includes every process action available in the manufacturing community in a standard format. The foreign process languages include the process actions of one or more community members in a format other than the standard format. The foreign process languages often exist because of a lack of standardization between the various members of the manufacturing community. The standard process language provides the necessary community standards for the communication of process information.

In the preferred implementation, a general recipe, which is part of the product brand information, describes how to manufacture the product brands independent of equipment. The product brand information also may comprise information derived from one or more general recipes, as described above. One or more of the general recipes is expressed in a foreign process language, and the method preferably includes the step of translating the general recipes in the foreign process language to the standard process language. Each manufacturing organization in the manufacturing community has at least one manufacturing site for manufacturing products, as described above. The manufacturing organization information includes the site information for one or more of the manufacturing sites. The site information for at least one of the manufacturing sites is expressed in one of the foreign process languages and the method preferably includes the step of translating the site information in a foreign process language to the standard process language. This provides each manufacturing organization and each product brand owner with manufacturing process information such as the site information and the product brand information in a standard and compatible form. Thus, the product brand information belonging to a product brand owner may be compared to the manufacturing organization information for a contract manufacturing organization to determine the contract manufacturing organization's capability to manufacture product brands.

The translation of each foreign process language to the standard process language can be implemented using a map or a dictionary to provide a cross reference between the process languages. For example, the standard process language may use the process action identified as “ADD” to describe the process of filling a unit with a material, as illustrated in FIGS. 76 through 79. The definition of the process action as used in this example includes general information, material input information, process parameters, and process action revision history. These various pieces of information are defined through the underlying tabs in the process action definition screen. The general information, material information, and process parameters include key parameters such as terminology, alarm points, flow rates, set points, units of measure, etc. that define the process action. A foreign process language may use the process action identified as “FILL” to describe the same process. “FILL” may use different parameter terminology, units of measure, etc. to define the same basic process action as “ADD”. For example, referring to the process parameters of the “ADD” process action provided in FIG. 78, the FLOW_RATE parameter for “FILL” might be entitled INPUT_RATE. The units of measure might be kilograms per minute instead of lbs/min as shown in FIG. 78 for “ADD”. The process action “ADD” shown in FIG. 78 has an alarm called TRIP_RATE with a LOW_TRIP_POINT that corresponds to a lower flow rate alarm and a HIGH_TRIP_POINT that corresponds to a higher flow rate alarm. The TRIP_RATE alarm is defined in lbs/min and each of the two trip points, LOW_TRIP_POINT and HIGH_TRIP_POINT are defined as a percentage of the absolute value of the TRIP_RATE alarm. This way and absolute trip rate can be set and varying priorities of alarm can be set as a percentage of the absolute trip rate. In FIG. 78 the LOW_TRIP_POINT alarm is set at 80% of the absolute TRIP_RATE and the HIGH_TRIP_POINT alarm is set at 95% of the TRIP_RATE. The low flow alarms for “FILL” might be identified as LOW_ALARM_{—}1 and LOW_ALARM_{—}2 instead of LOW_TRIP_POINT and HIGH_TRIP_POINT as shown for “ADD” in FIG. 78. “FILL” may not have a TRIP_RATE as shown for “ADD” in FIG. 78. “FILL” may simply provide two absolute alarms, LOW_ALARM_{—}1 and LOW_ALARM_{—}2 both in kilograms per minute, if the flow rate falls below either one of these two absolute values. The conversion or translation process of the “FILL” process action to the “ADD” process action must provide a map of the parameters from one process action to the other. The map must identify each parameter of the process action “ADD” and the corresponding parameter of the process action “FILL”, along with the necessary algorithms or conversions to translate the parameter of the “FILL” process action to the corresponding parameter of the “ADD” process action. For example, the FLOW_RATE parameter of the “ADD” process action corresponds to the INPUT_RATE parameter of the “FILL” process action and the value of INPUT_RATE must be multiplied by 2.2 lbs per kg to convert the value of the INPUT_RATE parameter of “FILL” in kilograms per minute to the corresponding value of the FLOW_RATE parameter of “ADD” in lbs/min. The LOW_ALARM_{—}1 parameter and the LOW_ALARM_{—}2 of the process action “FILL” does not correspond to any one parameter of the process action “ADD” of FIG. 78. The LOW_ALARM_{—}1 parameter of the process action “FILL” actually corresponds to the product of the TRIP_RATE and the HIGH_TRIP_POINT parameters of the process action “ADD” and the LOW_ALARM_{—}2 parameter of the process action “FILL” corresponds to the product of the TRIP_RATE and the LOW_TRIP_POINT parameters of the process action “ADD”. The value of the LOW_ALARM_{—}1 parameter of the process action “FILL” is calculated by taking the arithmetic product of the TRIP_RATE parameter and the HIGH_TRIP_POINT parameters of the process action “ADD” and dividing their product by the unit conversion of 2.2 lbs per kilogram. Arithmetically this is represented by the equation:

LOW_{—}ALARM_{—}1=(TRIP_{—}RATE×HIGH_{—}TRIP_{—}POINT)/2.2

Similarly, the value of the LOW_ALARM_{—}2 parameter of the process action “FILL” is calculated by taking the arithmetic product of the TRIP_RATE parameter and the LOW_TRIP_POINT parameters of the process action “ADD” and dividing their product by the unit conversion of 2.2 lbs per kilogram. Arithmetically this is represented by the equation:

LOW_{—}ALARM_{—}1=(TRIP_{—}RATE×LOW_{—}TRIP_{—}POINT)/2.2

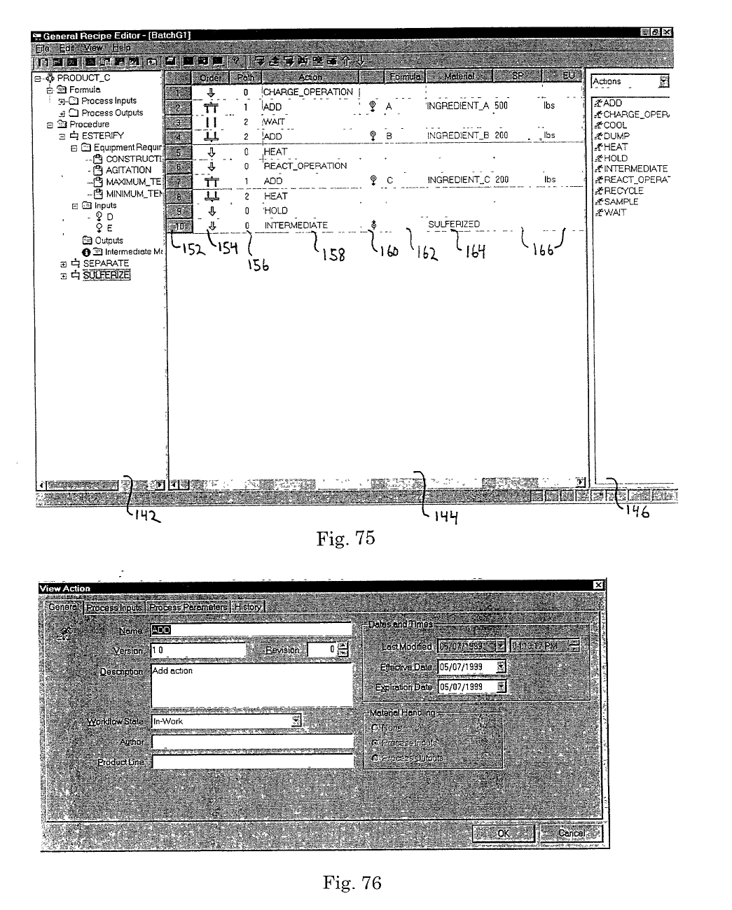

A process action in a foreign process language may not necessarily contain all of the process action parameters of available for the process action defined in the standard process language. A process action “CHARGE” may also be a process action in a foreign process language that corresponds to the process action “ADD” defined in FIGS. 75 through 79. The process action “CHARGE” may be otherwise identical to the process action “FILL” described above except the process action “CHARGE” has only one alarm for the INPUT_RATE parameter identified as LOW_ALARM. Similar to the process action FILL described above, the LOW_ALARM parameter of “CHARGE” is in the units of kilograms per minute, requiring conversion during the translation of a “CHARGE” process action in the foreign process language to an “ADD” process action in the standard process language.

In this case, because the process action “ADD” in the standard process language has two alarm trip points available, the first alarm HIGH_TRIP_POINT for the process action “ADD” can be used to correspond to the LOW_ALARM parameter. The second alarm of the process action add, the LOW_TRIP_POINT parameter can be set to 0%, a negative value, or a null value so that the second alarm, LOW_TRIP_POINT is deactivated. In this manner, the process action “CHARGE” that is in a foreign process language can be mapped to the process action “ADD” in the standard process language so that any “CHARGE” process actions used in any general recipes can be translated to the standard process language, even though one of the process action “CHARGE” has one less alarm parameter than the process action “ADD” from the standard process language. Because the LOW_ALARM of the process action “CHARGE” actually corresponds to the product of the LOW_FLOW_RATE and the HIGH_TRIP_POINT parameters of the process action “ADD” much the same as described for the process action “FILL” above, the mapping logic must fix one or the two process parameters LOW_FLOW_RATE and HIGH_TRIP_POINT of the process action “ADD” to allow the other parameter to be mapped to the LOW_ALARM process parameter of the process action “CHARGE”. This is because the LOW_ALARM parameter of “CHARGE” is only a single value. For a “CHARGE” process action in the foreign process language with real values for each of its parameters to be translated to an “ADD” process action in the standard process language, there must be a one to one relationship between the process parameters in of the process action in the foreign process language with real values and the corresponding process parameters for the process action in the standard process language. As is well understood in the field, a mapping equation, or mapping logic with one parameter with a known value mapped to more than one parameter with unknown values results in an indeterminant mapping equation. An equation with more variables than known values does not have an exact solution. For a process action to be accurately translated from a foreign process language to the standard process language, every process parameter in the resulting translated standard process action corresponding to a the process parameter of the foreign process action generally must have exact values. If this is not true, then the process parameters that are used to define the standard process action would have indeterminant values, and any recipe conversion from a general recipe to a master recipe would result in a master recipe with manufacturing instructions that are undefined. Because a master recipe is for manufacturing a product on a set of equipment in a process cell by controlling the equipment to manufacture the product, an indeterminant or undefined instruction would result in an indeterminant or undefined product, which is inherently unacceptable.

As a result, the mapping equation for the process parameter LOW_ALARM of the process action “CHARGE” must have one of the two process parameters LOW_FLOW_RATE and HIGH_TRIP_POINT of the process parameter “ADD” predefined as a fixed value as part of the mapping equation. Since LOW_ALARM corresponds to the product of LOW_FLOW_RATE and HIGH_TRIP_POINT, and the parameter LOW_FLOW_RATE is the actual value of the low flow rate of concern in lbs/min. and the parameter HIGH_TRIP_POINT corresponds to the percentage of the low flow rate at which to set off the alarm, the value of HIGH_TRIP_POINT may be pre-assigned to 100% since the LOW_ALARM parameter of the process action “CHARGE” has no corresponding percentage. The LOW_ALARM of “CHARGE” is an absolute value in kilograms per minute. In this case, the mapping equations become:

LOW_{—}FLOW_{—}RATE=2.2×LOW_{—}ALARM

HIGH_TRIP_POINT=100

LOW_TRIP_POINT=“null”

Thus, the HIGH_TRIP_POINT parameter of “ADD” is set to 100% so that the high trip point alarm is activated when the flow rate equals the value of the LOW_FLOW_RATE parameter of “ADD”. The LOW_FLOW RATE parameter of “ADD” equals 2.2 times the LOW_ALARM parameter of “CHARGE” thus correcting for the difference in units of the two process parameters. The LOW_TRIP_POINT parameter of “ADD” is disabled by setting its value equal to “null” because the process action “CHARGE” has no corresponding alarm defined.

In accordance with the preferred implementation, a set of master recipes is automatically created from a general recipe using manufacturing organization information comprising site information. Specifically with reference to FIG. 5, a set of master recipes 42 is created from a general recipe 44 using site information 40. The set of master recipes 42 created from the general recipe 44 comprises a group of discrete master recipes 46 that can be used to manufacture the product to the process requirements of the general recipe in the process cell 14 or in a class of process cells with a common equipment configuration. The set of master recipes may comprise as few as one master recipe if only one master recipe exists that will meet the constraints of the general recipe and the manufacturing organization or site information.

When used in the preferred implementation, the batch control system 18 controls the manufacture of products in the process cell 14 through the use of the master recipe 46. The master recipe 46 defines how to supervise and control the set of equipment 16 in the process cell 14. As described above, the master recipe preferably is a quantity independent recipe for manufacturing a specific product or group of products from at least one input material. A master recipe 46 may produce one product or a group of products in a single batch, depending upon the recipe. As used herein, the term “product” refers to a specific product or a specific group of products manufactured to the control recipe in a single batch. The master recipe 46 preferably includes all the process and equipment specific information necessary to manufacture the product, except the master recipe preferably is normalized with respect to quantity. The master recipe 46 is generally used to create the control recipe. The control recipe is the batch specific recipe to manufacture the product, as described above.

The master recipe 46 preferably is for the control of the manufacture of the product automatically, so that no human interaction is required between the batch control system 18 and the operator. Alternatively, the master recipe 46 can allow for partial or complete manual control of the manufacture of the product. In either case, the master recipe simplifies the operator's tasks by providing specific and detailed operating instructions in the order required for the recipe. The instructions could be either fully automatic control commands to control the equipment or devices (such as a valve or pump) or manual instructions to operators, or any combination of the two. For example, the control recipe issues an “Open” command to a valve or a “Start” command to a pump, and the automated devices go to the command state. Alternatively, the operator controls a material addition by specifying the amount of material to be added and actuating the addition of the material through the batch control system; however, the control recipe may perform multiple tasks, such as opening valves, actuating pumps, monitoring flow meters or load cells, turning off pumps, closing valves, etc., to accomplish the addition for the operator. Even a fully manual process cell can guide the operator through the steps of the recipe to simplify the operator's tasks. The operator may be allowed to perform tasks other than the standard task required by the recipe, but he or she might be provided the standard tasks in order before being allowed the option to over ride.

The master recipe 46 is preferably for the control of either one process cell 14 or multiple process cells of one process cell configuration. The master recipe 46 may be used with more than one process cell 14, provided each process cell the master recipe is used with has compatible process cell configuration. For the process cell configuration to be compatible, the process cell 14 should have an identical interface to the batch control system 18. In other words, each process cell 14 should look compatible to the control system 18. In general, this means that the equipment in the process cell 14, as well as the layout of the equipment 28 and the material flow paths 30 between the equipment, should be compatible between the process cells.

The master recipe 46 preferably comprises one or more data files that comprise the procedure required to manufacture the product. The master recipe 46 preferably is for use with the process control application residing on the batch control system 18. The master recipe 46 provides the necessary data required to operate the set of equipment 16 in the process cell through the process control application. The form and type of data file preferably are selected to operate with the process control application. When wiring or programming the preferred process control application, i.e., RSBATCH by Rockwell Automation, the master recipe data file type preferably is either a binary file or a relational database. The data file type preferably is selected by the user from one of the preferred data file types. Alternatively, the master recipe 46 may be one or more program routines or subroutines that operate on the batch control system 18. A combination of data files and subroutines may be used as well. The exact form of the master recipe 46 does not necessarily matter, provided it is capable of implementing the master recipe on the batch control system 18 to manufacture the product. Similar to the master recipe 46, the preferred embodiments of the general recipe 44 comprise one or more data files. As in the master recipe, the exact form of the general recipe 44 need not comply with strict requirements, particularly if it is capable of describing how to manufacture the product, as will be described in more detail herein below.

In the preferred implementation, both the master recipes 46 and the general recipes 44 include the five major elements identified in ISA S88.01. These elements are the header, formula, equipment requirements, procedure, and other information. These major elements preferably contain the same information in them that is identified in ISA S88.01. The following is a summary description of the information provided in each of these major elements in accordance with ISA S88.01. The definition of process input, process output, and process parameter provided as well for the sake of clarity:

Header—The administrative information in the recipe, usually including the recipe and product identification, the version number, the originator, the issue date, approvals, status, and other administrative information.

Formula—The category of recipe information that includes process inputs, process outputs, and process parameters. The type of data provided in the formula is that which may be needed by different parts of the enterprise, without including processing details not required by the balance of the enterprise. For example, the formula usually includes a general bill of materials and a bill of materials segregated by procedural elements.

Equipment Requirements—The category of recipe information that includes equipment constraints which limit the choice of equipment which may be used to manufacture the product. For the general recipes, these constraints are typically broad, such as allowable equipment materials of construction and required processing characteristics, e.g., categories of allowable mixer types. For the master recipes, the equipment requirements often limit the equipment to specific units, such as reactor R-5, or they may limit the equipment to vary specific classes of units.

Procedure—The category of recipe information that defines the actual strategy for carrying out the process, preferably in a step by step manner. In the case of general recipes, the procedure is independent of equipment and describes the basic material related process for creating the product. In the case of master recipes, the procedure includes both the equipment and the material processing details required to manufacture the product in a specific process cell or configuration of process cells.

Other Information—The category of recipe information that includes batch processing information not included in the other four categories of information. Examples include regulatory compliance information, materials and process safety information, process flow diagrams, and packaging and labeling information.

Process Input—The identification and quantity of a raw material or other resource required to make a product.

Process Output—An identification and quantity of material or energy expected to result from one execution of a control recipe.

Process Parameter—Information that is needed to manufacture a material but does not fall into the classification of process input or process output.

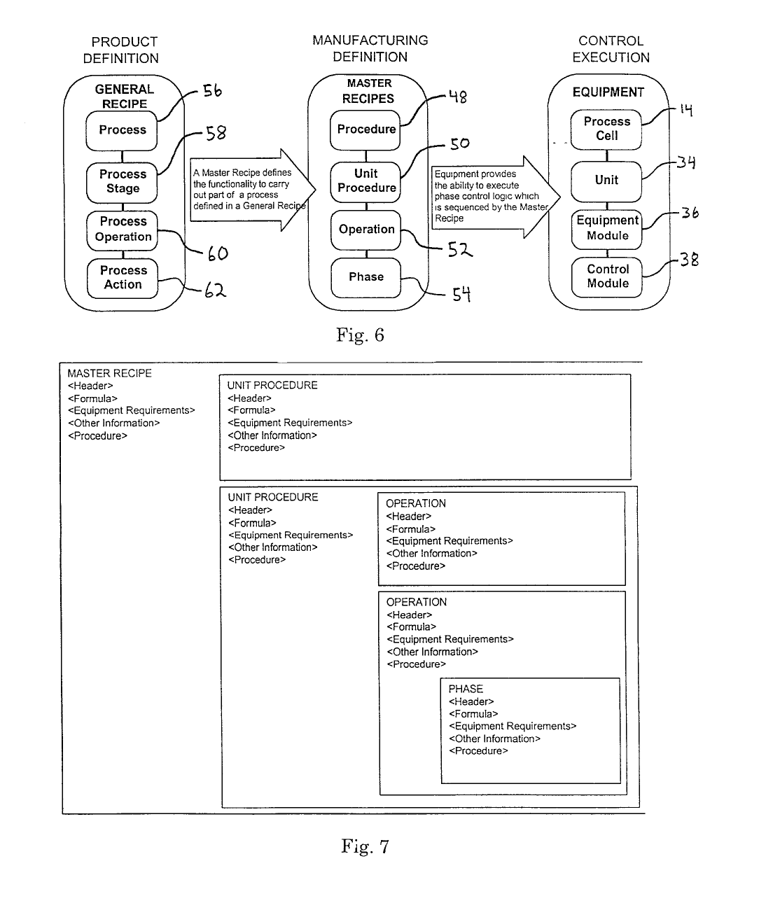

In the preferred implementation, the procedure section of both the general 44 and master recipes 46 may be divided into a hierarchy of elements, as shown in FIG. 6. The top level element in the master recipe 46 is procedure 48. Under the procedure are unit procedures 50. The unit procedures are subroutines or sub-procedures that identify a specific, major operation that is carried out on one unit 34. The ISA S88.01 definition for a unit procedure is “a strategy for carrying out a contiguous process within a unit. It consists of contiguous operations and the processing flows necessary for the initiation, organization, and control of those operations.” The next level of subdivision in the master recipes 46 is the operations 52. Operations are typically the procedural elements necessary to accomplish one task, such as charge, react, mix, etc. As defined by ISA S88.01, the operations are “the procedural element defining an independent processing activity consisting of the algorithm necessary for the initiation, organization, and control of phases.” Phases 54 are the lowest level of procedural control available to the batch control system 18. Phases correspond to a single, discrete action available to the process control system in the process cell 14 on the set of equipment 16. As defined in ISA S88.01, a phase is “the lowest level of procedural element in the procedural control model.” Examples of the actions performed by equipment phases 54 are the opening of a valve, the actuation of a mixer, the actuation of a pump, the reading of a meter or gauge, etc. Recipe phases 54 are the only necessary procedural elements to perform the procedure 48 of a master recipe. They are the procedural elements corresponding directly to the discrete physical actions or process communications, such as the reading of a value, being performed on the materials in the process cell. The unit procedures 50 and operation 52 do not need to be present in a discrete and identifiable form to create the procedure 48 in the master recipe 46. All the procedural elements, when they are present in the master recipe, preferably are in the same general form of the master recipe 46. Specifically, they include a header, a formula, equipment requirements, a procedure, and other information. FIG. 7 depicts the nested nature of the hierarchy of elements in master recipe 46, each element including a header, a formula, equipment requirements, a procedure, and other information, much the same as the master recipe itself

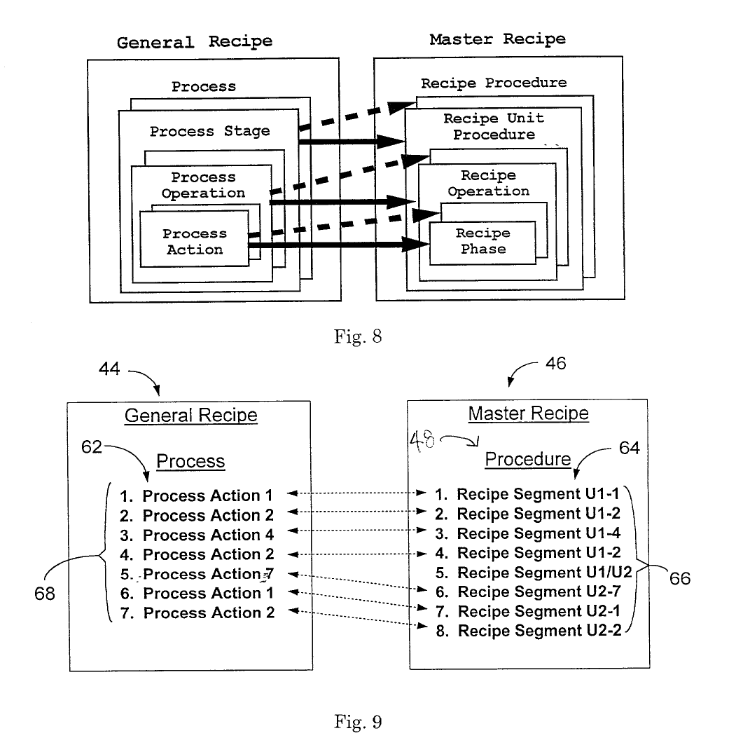

FIGS. 7 and 8 illustrate the division of possible procedural elements in a master recipe 46. The master recipe is subdivided into the unit procedures, unit operations, and recipe phases. As described above, each of these elements is in the same basic format as the master recipe itself, that is, each element includes the same five categories of information as the master recipe—a header, a formula, equipment requirements, a procedure, and other information. The actual information contained in each of these categories of information is dependent upon which element the category pertains to. For example, the formula and equipment requirements for a recipe phase 54 are very specific. The formula may include material A as the process input and may specify valve 3b as the equipment requirements. The procedure may be actuated at 5 volts for 3 minutes. The same basic data structure used for the master recipe 46 is used for any of the modular subcomponents of the master recipe to provide a consistent form for all recipe components. This simplifies the process of analyzing data associated with recipes. The same basic data structure also is used for the general recipe 44 and its subcomponents (for example, the process stages, process operation, and process actions).

The preferred hierarchy of procedural elements in the general recipe 44 is process 56, process stage 58, process operation 60, and process action 62. This hierarchy follows the guidelines of ISA S88.01. The process 56 of the general recipe is the equipment independent procedure for manufacturing the product. As described above, in the preferred embodiments the general recipe 44 includes the same five major elements as the master recipe 46—the header, the formula, equipment requirements, the procedure, and other information. The specific section of the general recipe 44 containing the process is the procedure section of the general recipe. Process is simply another name for the equipment independent procedure for manufacturing the product. Although the elements of the general recipe 44 and those of the master recipe 46 are often directly related, there is no one to one relationship between the elements. For example, there may be more than one master recipe procedure 48 for performing the process 56 of the general recipe, process stages 58 do not necessarily correlate to unit procedures 50, process operations 60 do not necessarily correlate to operations 52 in the master recipe, and process actions 62 generally require more than one recipe phase 54 to perform the process action. The fuzzy relationship between the procedural elements of the general recipe and the master recipe is depicted in FIG. 8.

Further in accordance with this aspect of the invention, each master recipe includes a plurality of recipe segments arranged in a manufacturing sequence and the general recipe includes a plurality of process actions arranged in a process sequence. In the preferred embodiments, the procedure 48 of the master recipe 46 comprises recipe segments 64 arranged in a manufacturing sequence 66 that defines the sequence of operations to manufacture the product. Each recipe segment 64 preferably comprises a group of recipe phases 54 that is organized to perform one specific process action 62 on one specific process cell. Alternatively, each recipe segment 64 may be a group of recipe phases 54 that is organized to perform a specific process action on a set of equipment 16 with one specific equipment configuration, as will be described in more detail below. The process 56 of the general recipe is preferably comprises process actions 62 arranged in a process sequence 68 that defines the sequence of operations required to define the process of the general recipe. The relationship between these elements of the master recipe 46 and the general recipe 44 is depicted in FIG. 9. The division of the master recipe 46 into recipe segments 64 provides a logical grouping of the recipe phases 54.

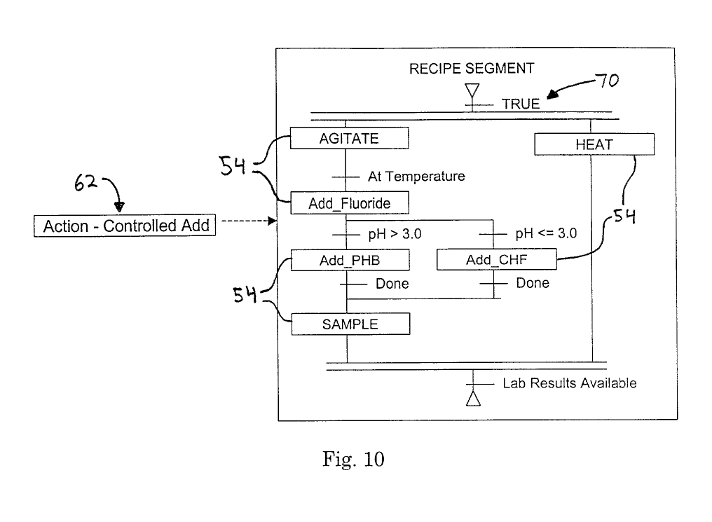

FIG. 10 depicts the recipe segment 64 for the process action 62 corresponding to a controlled material addition. The recipe phases 54 are represented by the blocks “agitate,” “add fluoride,” “add PHB,” “sample,” “add CHF,” and “heat.” The logic 70, or logical sequence of operation of the phases 54 and any corresponding states which must be true to begin and end a phase, are depicted by the flow lines interconnecting the blocks which represent the phases 54 as well as the other logic symbols. The logical sequence 70 for a recipe segment 64 is essentially the equivalent of the manufacturing sequence 66 for the master recipe 46. The logical sequence 70 of a recipe segment 64 defines the order in which the recipe phases 54 must be executed to accomplish the process action 62 performed by the recipe segment. The flow chart depicted in FIG. 10 is in the form of a sequential function chart (SFC), also known as a procedure flow chart (PFC), and is drawn in accordance with the requirements of ISA S88.02. Appendix 1 provides further description of how to read an SFC or PFC. The elements of a general recipe 44 can be depicted in a flow diagram or chart form called a process dependency chart, or PDC, in accordance with ISA dS88.02. The elements of a PDC, and how to read them, are provided in Appendix 2. The figures for master recipes 46 and subcomponents of master recipes (such as unit procedures, unit operations, and recipe segments) provided herein which follow the SFC or PFC format of ISA S88.02 shall be interpreted in accordance with ISA S88.02 and Appendix 1. The figures for general recipes 44 and subcomponents of general recipes (such as process stages, process operations, and process actions) provided herein which follow the PDC format of Appendix 2 shall be interpreted in accordance with Appendix 2.

The grouping of recipe phases 54 within the master recipe 46 into recipe segments 64 (which perform the process actions of the general recipe in the process cell) provides a relationship between the elements of the process 56 in the general recipe and the elements of the procedure 48 of the master recipe. This allows the general recipe 44 to be mapped to the process cell 14. Thus, for every process action 62 in the general recipe, there should be at least one corresponding recipe segment 64 available to the batch control system 18 which performs that process action in the process cell 14. If this is not true, the general recipe typically cannot be converted to a master recipe and cannot be performed in that process cell.

The manufacturing sequence 66 corresponds to the order in which the recipe segments 64 and recipe phases 54 should be performed in the process cell 14 to manufacture the product. The manufacturing sequence is defined by both the product and process constraints and the equipment constraints. The process sequence 68 corresponds to the order in which the process actions 62 should be performed to manufacture the product independent of equipment constraints. The process sequence 68 may be viewed as a manufacturing sequence 66 in an ideal process cell in which the equipment does not impose any additional constraints above and beyond those required by the process 56. Generally, the process sequence 68 is the simplest manufacturing sequence possible to produce the product. The one to one or more relationship between the process actions 62 and the recipe segments 64 allows the process sequence 68 to be used as an initial guess at the manufacturing sequence 66 when converting a general recipe 44 to a set of master recipes 42.

FIG. 9 provides a simplified representation of the organization of the process actions 62 in a general recipe 44 and the organization of the recipe segments 64 in a master recipe 46 corresponding to the general recipe. Referring to FIG. 9, the process sequence 68 corresponds to the order in which the process actions are performed in the process 56. In FIG. 9 this is represented by the order of the process actions listed from the top to the bottom. The process actions 62 can be repeated, as is shown in FIG. 9. This is because each process action 62, for example heat, may need to be performed multiple times in a single process 56.

The master recipe 46 corresponding to the general recipe 44 in FIG. 9 has more recipe segments 64 than the number of process actions 62 listed in the general recipe in the figure. The recipe segments 64 of the master recipe 46 which correlate to a specific process action 62 in the general recipe 44 are shown by the dashed line between the process action and the recipe segment in FIG. 9. The identification scheme used for the recipe segments 64 in this figure is the unit number the recipe segment is performed in followed by the process action the recipe segment performs. For example, U1-1 is the recipe segment that performs process action 1 in unit U1. This identification scheme provides a simplified representation of the general and master recipes that aids in the visualization of the processes described herein. The detailed representation of the elements of the general and master recipes for use with the preferred embodiments of the invention are the PDC's and the PFC's respectively.

The additional recipe segment U1/U2 for which no corresponding process action 62 exists represents a material transfer from unit U1 to unit U2 that is not included in the general recipe 44. This recipe segment is not required by the equipment independent process of the general recipe, but the equipment constraints require the transfer to perform the master recipe in the process cell. This may be required, for example, if process action 7 is not available in U1 in the process cell, but is available in U2 as recipe segment U2-7. In this case, if the procedure begins in unit U1, the material must be transferred to unit U2 prior to the performing of process action 7 for the process of the general recipe to be performed in the process cell. The process sequence 68 of the general recipe corresponds to the minimum manufacturing sequence required to manufacture the product (for example, if the constraints provided by the site information are not limiting). In the example provided in FIG. 9 the manufacturing sequence 66 requires one more step than the process sequence 68 due to the equipment constraints.

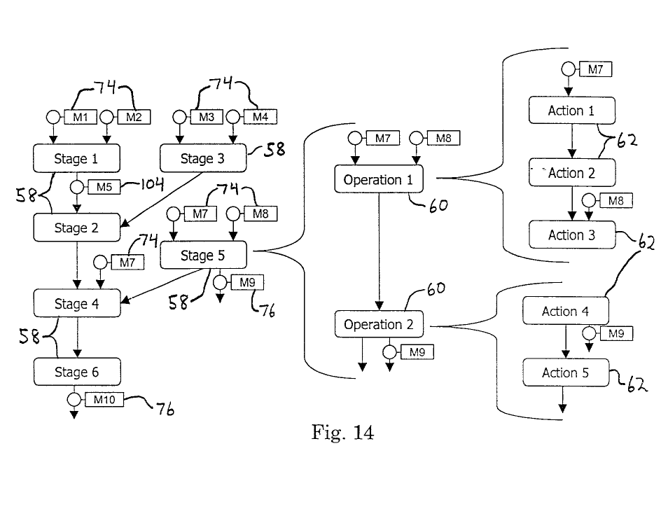

Further in accordance with this aspect of the invention, each master recipe is for manufacturing at least one product from at least one input material by performing the process actions on the at least one input material in the manufacturing sequence. In the preferred implementations each master recipe is for manufacturing as least one product 72 from the at least one input material 74 by performing the process actions 62 on the input material 74 in the manufacturing sequence 66. Each master recipe 46 is for use with a specific set of equipment 16 in a process cell 14 and each process action 62 has one or more corresponding recipe segments 64 that implement the process action on the set of equipment. In the preferred implementations, each master recipe 46 is for manufacturing a product or group of products 72 using the batch control system 18. The master recipes 46 preferably provide the control algorithms to operate the process connected devices 22 in the process cell1 14. If the master recipe 46 is a control recipe, it can be used to manufacture the product directly from the input materials 74 by operating the batch control system with the master recipe. FIG. 14 provides an example general recipe 44. If the master recipe 46 is a quantity independent master recipe, or a master recipe as otherwise defined in ISA S88.01, the master recipe can be used to manufacture the product 72 from the input materials 74 by inserting the quantity and batch or lot specific information into the master recipe to create the control recipe for the batch. In general, the specific quantities of input materials and products of a batch can be determined by scaling the input materials and products of a recipe in proportion to one of the other materials, for example, one of the products in the recipe. The control recipe generated from the master recipe then can be used to manufacture the lot of product requested. The latter scenario is often desirable when it can be integrated with an enterprise resource planning (ERP) system so that the lot and quantity specific information may be provided directly from the ERP system, such as SAP R/3 by SAP Corporation of Walldorf, Germany. In this case, the quantity independent master recipe may be automatically converted to the control recipe using the information provided by the ERP system. This can be used to further reduce the level of operator interface, and the resulting costs and possible human errors that are often associated with the human interface.

The master recipes 46 are typically automatic, requiring little or no human interface to manufacture the product 72. This usually reduces manufacturing costs. Typically, an operator monitors the process on a control terminal communicating with the batch control system 18. The operator can monitor the process for any alarm conditions, provide any necessary operator input or decisions, and communicate to other functions and areas of the plant regarding manufacturing operations which are not fully automated.

Alternatively, the master recipe 46 could provide the manufacturing instructions to produce the product 72 to an operator 76 in a manual process cell 78, or in an automated process cell when manual manufacture of the product is required. The batch control system 18 for automatic or manual manufacture is depicted in FIG. 2. In this case, the process connected device is actually an instruction terminal 80 using a manual operator to perform the procedure on the set of equipment 16 in the process cell. This set up might be preferable if the process cell is not automated, or if the manufacturing operation is sensitive and requires a significant amount of human interface and decision making to assure the product is properly manufactured. This might be the case with pilot runs, or if the product is of a highly sensitive nature. The manufacturing procedure may be manual, automatic, or any combination of the two. This depends upon the needs of the company manufacturing the product, and will vary anywhere from one extreme to the other.

In the preferred implementation, the general recipe 44 describes how to manufacture the at least one product 72 from the at least one input material 74 by performing the process actions 62 on the at least one input material in the process sequence 68. The process 56 of the general recipe 44 describes the order in which to perform the process actions 62, independent of equipment. The general recipe 44 is analogous to the recipe one might use in the kitchen to make a cake, where the recipe does not specify what type of oven to use, or what type of mixer. It defines the minimum process necessary to manufacture the product without equipment constraints. The process actions 62 are the actual steps of the process required to perform the various material transformations that create the product from the input materials. For example, mix, heat, dry, etc. It should be noted that the at least one product 72 and the at least one input material 74 do not need to be matter, both the at least one product and the at least one input material could be in the form of energy, matter, or any combination thereof. For example, a processing plant may use waste heat from a reaction to heat water to steam, use the steam to drive a turbine mechanically coupled to a generator, and produce electrical power to use within the plant or to sell. In this case the at least one product 72 would include electrical energy.

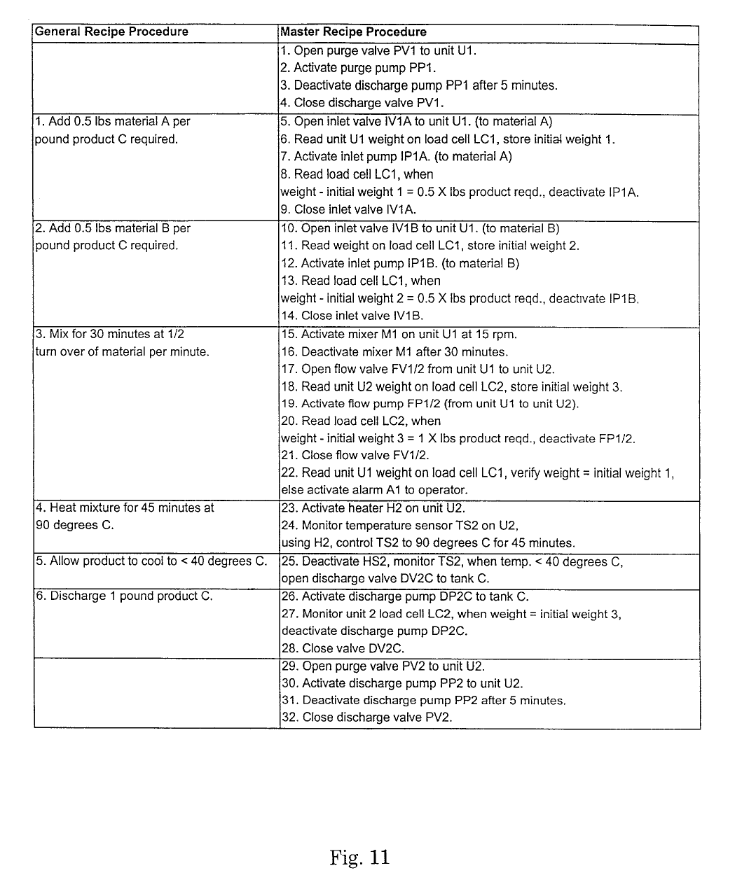

In the preferred embodiments, the site information 40 comprises material flow information 82, recipe segment information 84, and equipment information 86. The master recipe 46 includes equipment specific and process cell specific information, as well as the process and product specific information of the general recipe 44. This information is contained in the site information 40 as shown in FIG. 5. As described above, the master recipe 46 includes all the detailed information necessary to manufacture the product 72. The key differences between the master recipe 46 and the general recipe 44 may be better understood by the simplified example provided in FIG. 11. FIG. 11 provides a verbal description of the steps associated with the process 56 of a general recipe 44 to manufacture a product C from input materials A and B. FIG. 11 also provides a verbal description of the steps associated with the procedure 48 of a corresponding master recipe 46 which might be used manufacture the product C from input materials A and B in a specific process cell. In FIG. 11, each step in the general recipe is adjacent to the step in the master recipe that corresponds to the first step of the master recipe required to perform the adjacent general recipe step. For example, step 3 of the general recipe in FIG. 11, “Mix for 30 minutes at ½ turn over of material per minute” is performed by steps 15 through 22 of the master recipe. Steps 1-4 and 29-32 of the master recipe do not correspond to any of the steps of the general recipe. These steps are startup and shutdown steps required by the equipment in the process cell. In this verbal example of a general and master recipe, the steps in the general recipe are equivalent to process actions 62 and the steps in the master recipe are equivalent to recipe phases 54.

The general recipe 44 provides the product and process information and the master recipe 46 provides the product, process, equipment, and equipment configuration information. The general recipe 44 answers the questions of:

1. What consumable or input materials are required to manufacture the products, both type and quantity (normalized to product quantity)?

2. What are the products or by-products created by the recipe, both type and quantity (normalized to product quantity)?

3. What is the process to be performed to manufacture the product from the input materials (procedural steps and execution order)?

4. What additional material or process constraints (including equipment requirements such as materials of construction) are necessary to manufacture the product?

5. What other general information is required (such as detailed product description, recipe management data, safety and regulatory data about the product or process, etc.)?

The master recipe 46 answers the above questions and the additional questions of:

6. What specific equipment is to be used to manufacture the product?

7. What specific operations are to be performed on the materials with each piece of equipment, in what order, and when?

8. How are the materials to be transported into and between the different units used in the procedure, in what order, and when?

9. What exact lots of input materials are to be used, exactly how much of each lot of input material is to be used, exactly now much product is to be manufactured, what lot identification is to be given to the product lot, and what other batch and lot specific information is required?

10. What manufacturing data needs to be collected and archived as historical data?

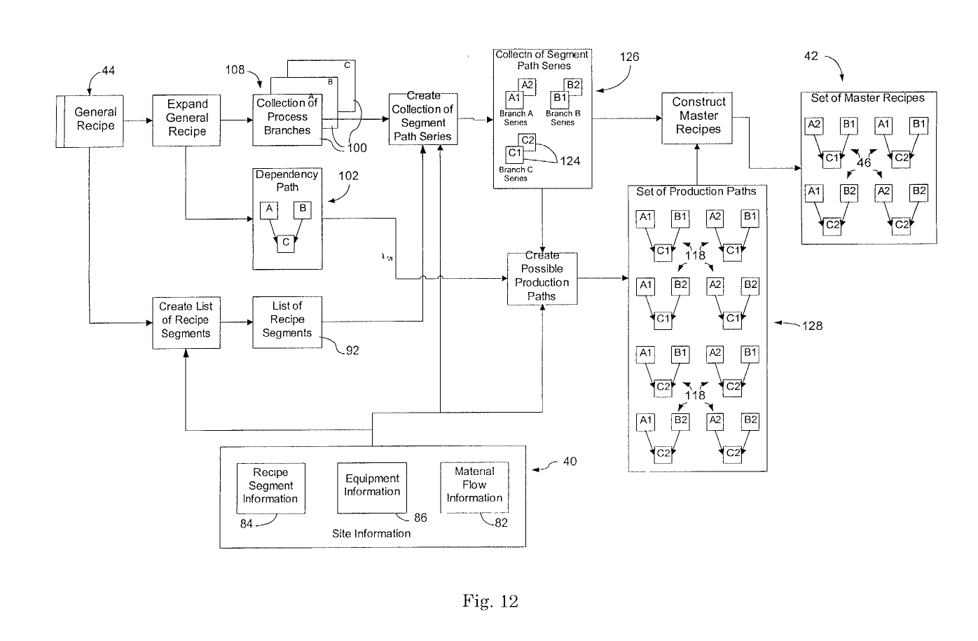

The answers to questions six through eight generally are required to create quantity independent master recipes 46. The answers to question nine generally are only required when the master recipe 46 comprises a control recipe. In the preferred implementation, the information required, above and beyond that which is provided in the general recipe 44, to answer questions six through eight is the site information 40. The site information 40 includes material flow information 82, recipe segment information 84, and equipment information 86, as depicted in FIG. 12. The site information may also include other site related information, such as restrictions on material usage for specific materials, equipment unit allocation information, etc. The site information 40 can be in any form that stores the necessary information and provides it for recipe conversion of the general recipe 44 to the master recipe 46. In the preferred implementation, the site information 40 is stored in relational databases, such as Microsoft SQL-SERVER by Microsoft Corporation of Redmond, Wash. or ORACLE 7 by Oracle Corporation of Redwood Shores, Calif. Alternatively, the data can be stored in binary or text files. The material flow information, recipe segment information, and equipment information may be stored in one database or a number of different databases. In the preferred implementation, these three varieties of site information 40 are stored in multiple databases.

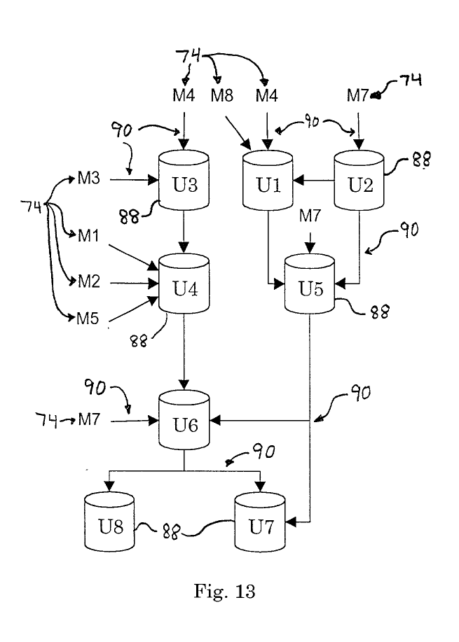

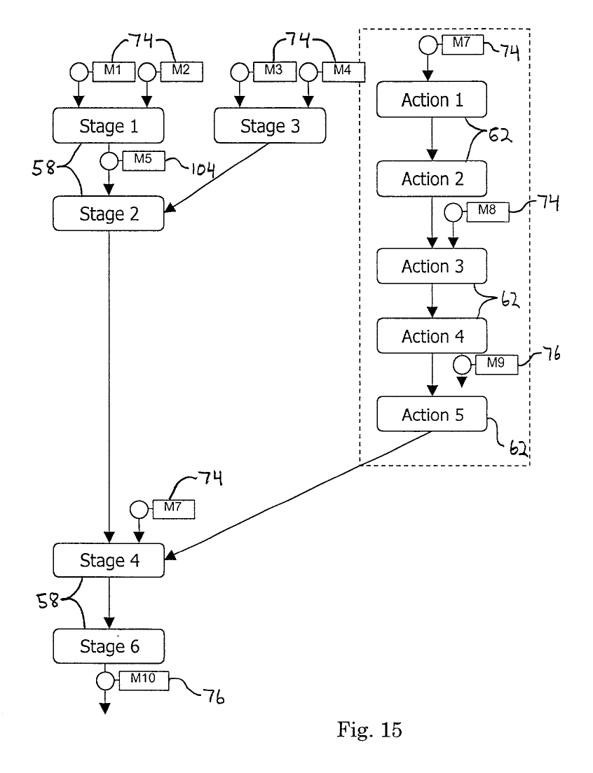

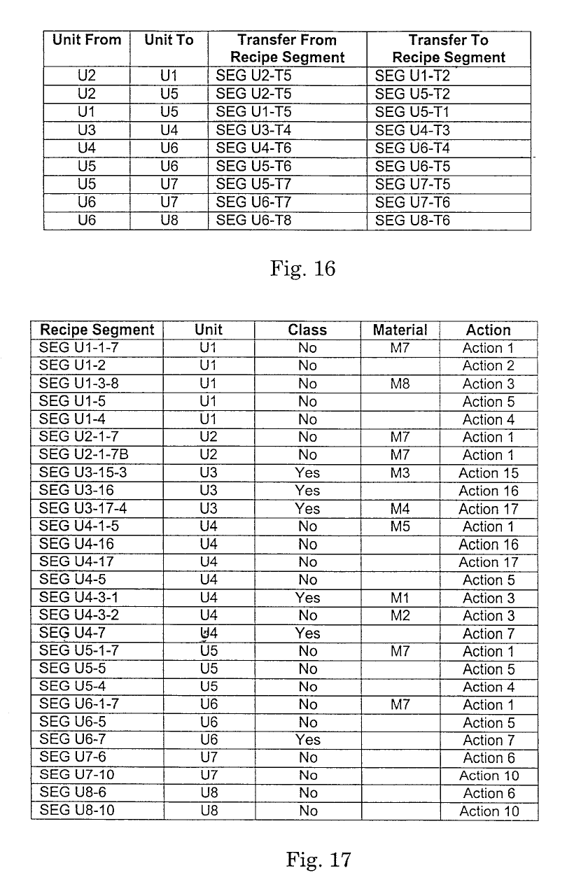

To aid the reader in understanding the methods associated with the preferred embodiments of the invention, FIG. 13 provides an example of a specific process cell configuration and FIG. 14 provides the process dependency chart for a specific general recipe 44. The following description of the preferred implementation will use the process cell configuration provided in FIG. 13 and the general recipe representation provided in FIG. 14. The following description will explain, in accordance with the preferred embodiments and methods of the invention, how a set of master recipes 42 will be created to perform the process of the general recipe 44 of FIG. 14 in the process cell 14 of FIG. 13. FIGS. 15, and 36 through 46 will be used to aid in the description of the preferred methods of conversion of the general recipe to a set of master recipes. FIGS. 16 through 19 represent the site information 40 associated with the process cell depicted in FIG. 13. The representations of the data structures and the components of the general 44 and master recipes 46 provided in these figures are simplified representations to aid in the readers understanding of the preferred implementation. The preferred data structures and form for the general and master recipes are described further below.

FIG. 13 shows the units 88 within the process cell 14, the material flow paths 90 between the units in the process cell, and the input materials 74 available to the process cell. The material flow paths 90 show both interconnections available between the units 88 and between the input materials 74 and the units, as well as the direction which material may flow via these flow paths. The allowable direction of flow is depicted by the arrow at the end of each material flow path 90. The units 88 are designated as U1 through U8. The input materials 74 are designated as M1 through M7.

FIG. 14 depicts the general recipe 44 of the example in the form of a PDC. The input materials 74 required by the general recipe are M1 through M4, M7 and M8. M5 is an intermediate material produced by Stage 1 of the general recipe. M9 and M10 are the products 72 produced by the general recipe of the example. The process stages 58 of the example are Stage 1 through Stage 6. Each process stage is an ordered grouping of process operations 60 and each process operation is an ordered grouping of process actions 62. FIG. 14 shows the expansion of Stage 5 into process operations 60 identified as Operation 1 and Operation 2. FIG. 14 further shows Operations 1 and 2 exploded to their respective underlying process actions 62 represented by Actions 1 through 3 for Operation 1 and Actions 4 and 5 for Operation 2. To simplify in the explanation of the preferred implementation, the following explanation will focus primarily on the details of the conversion process regarding Stage 5 of the general recipe in FIG. 14. The conversion and reconstruction of the balance of the stages follows the same method as is described for Stage 5 in the following; therefore, the explanation of the conversion of the other stages will be described with less detail.

FIG. 15 depicts the general recipe 44 of FIG. 14 exploding Stage 5 into the Actions 1 through 5. The process stages 58 and the process operations 60 provide useful groupings of the process actions 62 of the general recipe, but the process actions are the only required elements of the general recipe. The process stages and the process operations are for convenience only.

The material flow information 90 preferably includes information describing how material can flow in the process cell 14. This includes identifying the available flow paths between the different units and other pieces of equipment in the process cell, as well as the material flow paths providing material into and out of the process cell. The latter flow paths provide the information on the availability of materials (such as input materials), and the availability of storage reservoirs (such as for intermediate materials or products). This defines where material can be charged into the process, such as input materials, and where process products and byproducts can be routed for storage. These flow paths may be to storage vessels within the cell 14, or more typically, storage tanks located outside the cell.

An example of a database structure for the material flow information 90 is provided in FIGS. 16 and 17. The data structures in these figures are for the process cell depicted in FIG. 13. The database depicted in FIG. 16 identifies the flow connections between the units 88 and the recipe segments 64 associated with the transfers between the units. For each material transfer connection available, the database identifies:

1. the unit 88 from which the transfer may be performed identified in the “Unit From” column,

2. the unit 88 to which the transfer may be made identified in the “Unit To” column,

3. the recipe segment 64 associated with the unit from which the transfer may be performed identified in the “Transfer From Recipe Segment” column, and

4. the recipe segment associated with the unit to which the transfer may be performed identified in the “Transfer To Recipe Segment” column.

These recipe segments 64 include references to all the necessary recipe phases 54 to accomplish the transfer. The transfer from recipe segment typically will include references to the recipe or equipment phases to open the appropriate outlet valve to allow the transfer to occur. It may include the recipe or equipment phase to activate the pump to affect the transfer and recipe or equipment phases for monitoring flow meters or unit load cells to monitor the transfer as it is performed. The transfer to recipe segment typically will include the recipe or equipment phase to open the inlet valve to allow the transfer to the receiving unit to occur. It may also include the recipe or equipment phase for activating the pump and recipe phases for monitoring flow meters or unit load cells to monitor the progress of the transfer.

The example database provided in FIG. 17 contains both material flow information 82 and recipe segment information 84. The material flow information contained in this database is the information defining input material availability to the process cell 14. The column labeled “Recipe Segment” identifies the recipe segments available within the process cell. Because some of these recipe segments 64 are the segments associated with the charging of an input material 74 into a unit 88, this database contains information that falls under the category of material flow information 82. The column labeled “Material” identifies the input material 74 associated with the corresponding recipe segment contained in its row. The column labeled “Unit” identifies the unit 88 in which the recipe segment contained in the same row is available. If the cell in the material column is blank for any row, then the recipe segment does not correspond to an input material addition or charge. The column labeled “Action” identifies the process action 62 which is performed by the recipe segment 64 contained in the same row. Thus, the database of FIG. 17 identifies the recipe segments 64 available within the process cell 14, the unit 88 in which they are available, the process actions 62 which they perform within that unit, and, if they are an input material addition, the input material 74 which they provide to the unit.

In the example provided in FIG. 17, unit U1 of the process cell 14 has process actions 1 through 5 available within the unit. Action 1 is available through recipe segment SEG U1-1-7 and is associated with the material addition of input material M7. Action 2 is available through recipe segment SEG U1-2. SEG U1-2 does not have any associated input material. Action 3 is available through recipe segment U1-3-8 and is associated with the material addition of input material M8. Action 4 is available through recipe segment SEG U1-6 and is not associated with a material addition. Action 5 is available through recipe segment SEG U1-5 and is not associated with a material addition.

For the purposes of this example, the nomenclature used to identify recipe segments 64 consists of the following (1) a prefix “SEG” identifying that the tag is a recipe segment, (2) the “SEG” prefix is followed by the unit number in which the recipe segment is available, for example “U1” or “U2,” (3) the unit number is followed by the process action number the recipe segment performs, for example “1” for “Action 1,” “3” for “Action 3,” etc., and (4), if applicable, the material number of the input material associated with the recipe segment, for example, “4” if the recipe segment is for the addition of input material “M4,” “7” if the recipe segment is for the addition of input material “M7,” etc. Thus, SEG U1-1-7 is for a recipe segment performing Action 1 on U1, which is a material addition of M7 to U1. Each recipe segment identification is unique, therefore, if there are two different recipe segments available on the same unit, performing the same process action, and associated with the same input material (if applicable), the recipe segment identifiers must include additional characters to make each identifier unique. In FIG. 17, this situation occurs in unit 2, where Action 1 is available to add input material M7 via two different recipe segments. In this case, the first recipe segment is identified as SEG U2-1-7 and the second recipe segment is identified as SEG U2-1-7B. The addition of the character “B” allows both recipe segment identifiers to be unique. This identification scheme is used herein for this example and is intended for the purpose of aiding the readers understanding of the preferred implementation described in the following paragraphs.

The column labeled “Class” in the database represented in FIG. 17 identifies if the recipe segment 64 identified in the row is intended for a class of equipment instead of a specific unit 88. This provides for the option of creating master recipes 46 which are intended to be performed on a specific class of equipment, for example, in process cells 14 with the same basic type of equipment and equipment layout. If a cell in this column is labeled “No”, this means that the recipe segment 64 identified in the row containing that cell is for use with a specific unit and a specific piece or pieces of equipment. If the cell is labeled “Yes”, the recipe segment is for use with a specific class of equipment and may be performed on any piece of equipment, which is of the required class. A benefit of allowing for classes of equipment is that a master recipe 46 or a portion of a master recipe that is created for a class of equipment may be performed on a multitude of pieces of equipment provided multiple pieces of equipment are available in that class. This, of course, is only true if the company using the master recipe designs their process cells in a manner providing equipment classes.

Other types of information that may be included as flow information 82 might include maximum flow capacities, flow resistances, and materials of construction for the flow connections. For example, the line connecting unit 1 to unit 2 in the process cell 14 might be a type 304 stainless steel line with a maximum capacity of 100 gallons per minute (GPM) and a flow resistance of 0.5 psi differential pressure per GPM. This information could be included as part of the flow information.

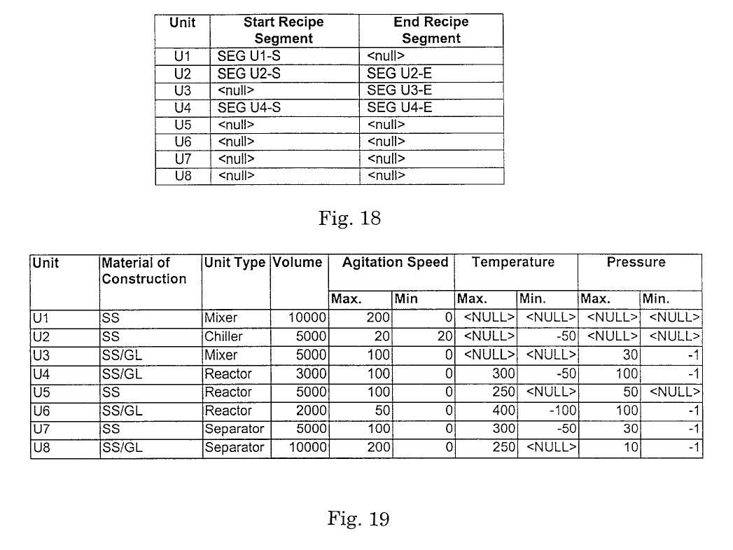

The recipe segment information 84 preferably identifies all of the recipe segments 64 that are available for performing process actions 62 in the process cell 14 and what process action each recipe segment performs. The recipe segment information also identifies the equipment upon which each recipe segment 64 runs on, the information required by the recipe segment to operate, for example, mixer speed or control temperature, as well as any operational limits associated with the recipe segment, for example, temperature ranges for heaters and chillers, speed ranges for blenders, flow rate ranges for pumps, etc. In the preferred implementation, recipe segment information 84 other than that which is shown in the tables of FIGS. 17 and 18 is contained in each recipe segment 64 itself, for example, under the equipment requirements section for the recipe segment. An example of the database structure for the recipe segment information 84 is provided in FIGS. 17 and 18. The database depicted in FIG. 17 includes all the recipe segments available in the process cell for performing process actions, as described above. FIG. 18 depicts the database for any unit start or unit end recipe segments required for the units in the process cell 14. The start and end segments correspond to the recipe segments 64 necessary to prepare a unit 88 for use, or to clean up the unit after its use is completed. Examples of operations which may be required at the start or end of the use of a unit in a process may be unit cleaning procedures, unit checkout procedures, unit temperature conditioning procedures (such as warm up), unit purging procedures, and the like. Any unit may require a start recipe segment, an end recipe segment, or both. Alternatively, a unit may not require either a start or an end recipe segment. The database depicted in FIG. 18 identifies any start recipe segment required by a unit in the column labeled “Start Recipe Segment,” any end recipe segment required by a unit in the column labeled “End Recipe Segment,” and the corresponding unit number with which the respective segments are associated in the column labeled “Unit.” If the start or end recipe segment cell in FIG. 18 is identified as<null>, then there is no corresponding start or end recipe segment for that unit. For example, unit U1 has a start recipe segment identified as SEG U1-S and does not have any end recipe segment, unit U4 has a start recipe segment identified as SEG U4-S and an end recipe segment identified as SEG U4-E, Unit U6 does not have a start or an end recipe segment.

The equipment information 86 preferably identifies the characteristics associated with each piece of equipment in the set of equipment 16 in the process cell 14. The equipment information preferably includes equipment limits such as equipment capacities (for example, 5000 gallons) and other equipment limits (for example, 200 psig maximum pressure capability). In addition, the equipment information preferably includes equipment materials such as stainless steel or glass lined, and any other equipment characteristics associated with each piece of equipment that may be required to determine if a specific operation can be performed on that piece of equipment. An example of a database structure for the equipment information 86 is provided in FIG. 19.

In the preferred implementation, the site information 40 is stored in relational databases. As a result, data files do not follow the simple tabular structure presented in FIGS. 16 through 19 of the example. These tabular structures are used to describe the preferred embodiments because they are easier to read and visualize. The preferred data structures and methods of describing the representing the recipes and the site information will be described later. In the preferred implementation, the equipment information 86 is distributed between an equipment information database and the recipe segments 64 themselves. As described above, each recipe segment is a recipe unto itself. It is composed of a header, a formula, a procedure, equipment requirements, and other information. The equipment requirements section of each recipe segment 64 typically will contain equipment information associated with that recipe segment (for example, minimum and maximum flow rates for material charge recipe segments). Since the recipe segment is generally for a specific unit 88 and a specific equipment module 36 or control module 38 (unless the recipe segment is class based, in which case it is for a specific class of units), it has very specific equipment limits, capabilities, and requirements associated with it. Where the equipment information 86 is stored, in the recipe segments 64 or in a separate data file, is a matter of the programmer's preference. The selection is generally determined based on which location of storage provides the best balance of computational speed, memory requirements, and other requirements such as ease of revision, etc. Generally, if the equipment information 86 is associated with a specific unit, but is not associated with a specific recipe segment, then the equipment information 86 is located in a separate data file specifically for the equipment information. For example, unit capacity, unit materials of construction, unit operating limits such as temperature or pressure, etc. are associated with the specific units but are not specific to any one recipe segment 64 associated with that unit (these types of equipment information are independent of recipe segments, the units capacity or its materials of construction do not change from one recipe segment to another).

FIG. 19 provides an example of a data file for unit specific equipment information. In the example data structure the unit specific equipment information consists of the unit identification, the material of construction, the unit type, the volume of the unit, the minimum and maximum agitation speed for the unit, the minimum and maximum operating temperature for the unit, and the minimum and maximum operating pressure for the unit. The unit identification, U1 through U8, is provided in the first, or left most column of the table, labeled “Unit.” The material of construction for the units is provided in the second column, labeled “Material of Construction.” The abbreviations “SS” and “SS/GL” stand for stainless steel and stainless steel, glass lined. The unit type is provided in the third column of the table, labeled “Unit Type.” In this case the units in the process cell of FIG. 14 are designated as either mixers, chillers, reactors, or separators. The next adjacent column, labeled “Volume,” provides the volume of each unit. In this case the each unit volumes vary from 2,000 to 10,000 gallons.

The mixing capabilities of each unit is provided in the two columns of FIG. 19 labeled “Agitation Speed.” The column sub-labeled “Max.” provides the maximum agitation speed for each unit. The column sub-labeled “Min.” provides the minimum agitation speed for each unit. Agitators for units may be variable and capable of operation at a multitude of speeds, or the agitators may only be capable of operation at a fixed speed. In FIG. 19, if the minimum agitation speed is “0” then the agitation speed may be varied between “0” and the maximum agitation speed. If the minimum speed is the same as the maximum speed, then the agitation speed is a fixed speed and may only be operated at that fixed speed or shut off. The table could also include a column that identifies the variety of agitator, fixed speed or variable. The units for agitation speed could be impeller speed, such as RPM, or the units could be in the form of volume of fluid mixed per unit time (gallons mixed per minute) or number of times the entire unit's volume is mixed per minute (turnovers per minute).

The two columns of FIG. 19 labeled “Temperature” provide the minimum and maximum operating temperature for each unit. The minimum operating temperature is given in the column sub-labeled “Min.” and the maximum in the column sub-labeled “Max.” If the table cell in the column contains “<NULL>” then the unit does not have temperature conditioning control module, such as a cooler or a heater, and the unit is only capable of ambient operation for that respective temperature capability. For example, unit U1 indicates <NULL> for both the minimum and maximum temperature capabilities of the unit. This means unit U1 does not have a heater or a cooler, and is only capable of ambient operation. Unit U2 has <NULL> in the “Max.” temperature column and −50 in the “Min.” column. In this case unit U2 has a cooler and is capable of operation down to −50 degrees centigrade, but the unit has no heater. Its maximum operation temperature is ambient. Unit U5 has <NULL> in the “Min.” temperature column and 250 in the “Max.” column. In this case, unit U5 has no cooler, but it does have a heater. Unit U5 has a minimum operation temperature of ambient and a maximum operating temperature of 250 degrees centigrade. Unit U4 has −50 in the “Min.” temperature column and 300 in the “Max.” column. In this case, unit U4 has both a cooler and a heater and is capable of operating at down to −50 degrees centigrade and up to 300 degrees centigrade.

The two columns labeled “Pressure” in FIG. 19 provide the minimum and maximum operating pressures for each of the units. The minimum operating pressure is provided in the column sub-labeled “Min.” and the maximum operating pressure is provided in the column sub-labeled “Max.” Similar to the temperature columns discussed above, the cells filled in with “<NULL>” indicate that the unit does not have a pressure conditioning control module, such as a pressurizing pump or a vacuum pump, and the unit is only capable of ambient operation for that respective pressure capability. The pressure values provided in FIG. 19 are in atmospheres gauge, so a “−1” means a vacuum of one atmosphere and a 30 means a pressure of 30 atmospheres gauge. Based on FIG. 19 units U1 and U2 are only capable of operating at ambient pressure, unit U5 is capable of an upper operating pressure of 50 atmospheres gauge and is not capable of operating at vacuum, and the remaining units are capable of both vacuum and pressurized operation.

FIG. 19 provides a possible data structure for the unit specific equipment information of the process cell provided in FIG. 13 for the example. The actual data structure, the units of measure used for the various pieces of data (such as pressures, temperatures, volumes, etc.), the information selected to be in the database, etc. are all matters of choice. In the preferred implementation, the users select the units of measure to be used for each data type. The users preferably also select what information is included in the unit specific equipment information database and in the equipment requirements section of each recipe segment.

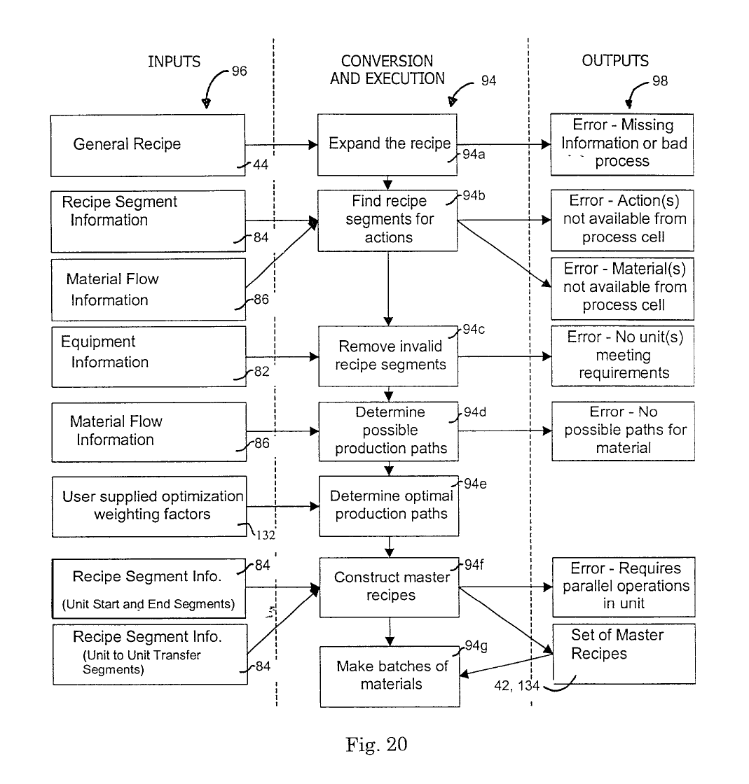

FIGS. 20 through 35 are block flow diagrams depicting the processing flows for performing the conversion of a general recipe 44 to a set of master recipes 42 in accordance with the preferred implementation. The following paragraphs will explain in detail the procedure according to the preferred implementation using the example process cell of FIG. 13, the general recipe of FIG. 14, and the site information provided in the databases depicted in FIGS. 16 through 19.

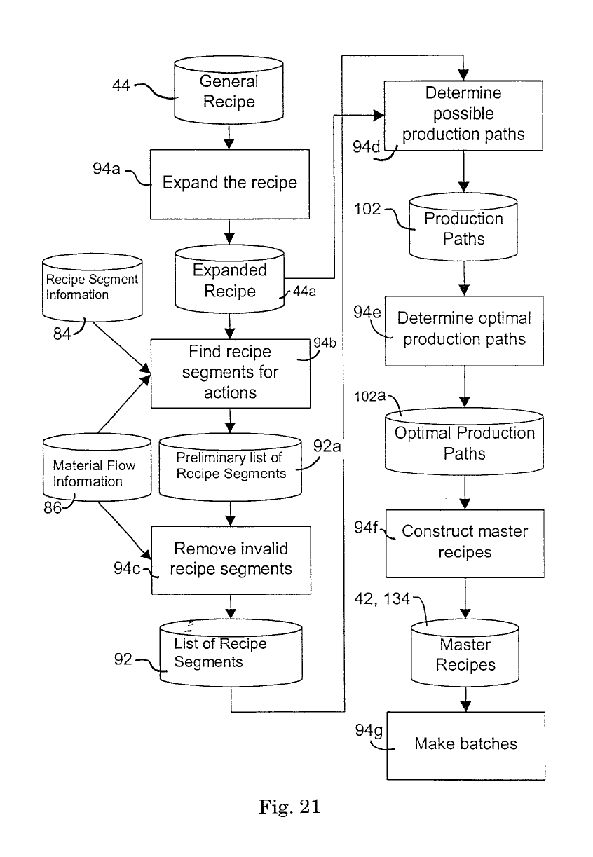

The preferred implementation comprises creating a list of recipe segments 92. The list of recipe segments comprises each process action 62 in the general recipe 44 and a listing of all the corresponding recipe segments 64 (constructed from the recipe phases 54 available in the process cell 14) for that process action which can perform that process action. FIGS. 5 and 12 provide general flow diagrams for the preferred manner of implementing this. FIGS. 20 and 21 depict a general flow diagram for the preferred implementation of the conversion process. FIG. 20 depicts the conversion process in the form of conversion execution steps 94 with conversion inputs 96 fed into the conversion processing flows from the right and the resulting conversion outputs 98 from the conversion execution steps provided to the left. FIG. 21 depicts the same conversion process in a sequential flow diagram. The conversion inputs comprise of the general recipe 44 and the site information 40. Referring to FIG. 20, the top input block is the general recipe 44. The balance of the input blocks below the general recipe are the various forms of site information 40. The output blocks 98 comprise the set of master recipes 42 and any corresponding errors or reports that may be generated by the conversion processing. “Error” as the term is used herein includes circumstances in which the process cell or site in question or under analysis for one reason or another is incapable or unsuited for performing part of all of the general recipe. As reflected by the illustrative output blocks in FIG. 20, this may comprise a circumstance in which the process action is unavailable from that process cell, the requisite materials are unavailable from that process cell or may not be processed in the process cell, the necessary units are unavailable in it, flow paths or other requisite paths are unavailable, etc.

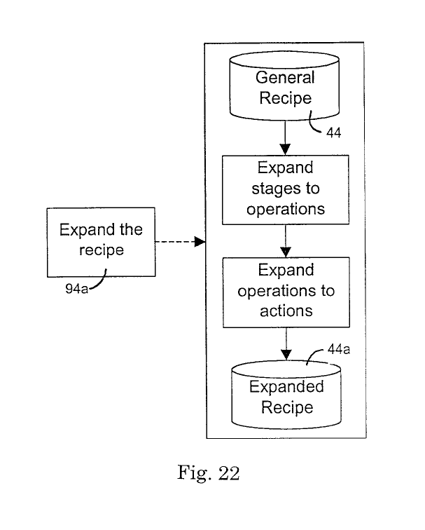

To illustrate, FIG. 5 depicts a high level flow diagram of the preferred conversion process. FIG. 12 provides a more detailed depiction. FIGS. 20 and 21 provide an additional level of detail. FIGS. 22 through 35 provide detailed processing flows for performing each of the conversion execution steps shown in FIGS. 20 and 21.

The first step of the conversion process according to the preferred implementation is to create a list of recipe segments 92, as described above, and as shown in generalized form in FIGS. 5 and 12. The conversion inputs required to perform this processing are the general recipe 44 and the recipe segment information 84, as shown in FIG. 20. The conversion execution steps that create the list of recipe segments 92 are steps 94a through 94c of FIGS. 20 and 21. The resulting intermediate data structure is the list of recipe segments as shown in FIG. 21.

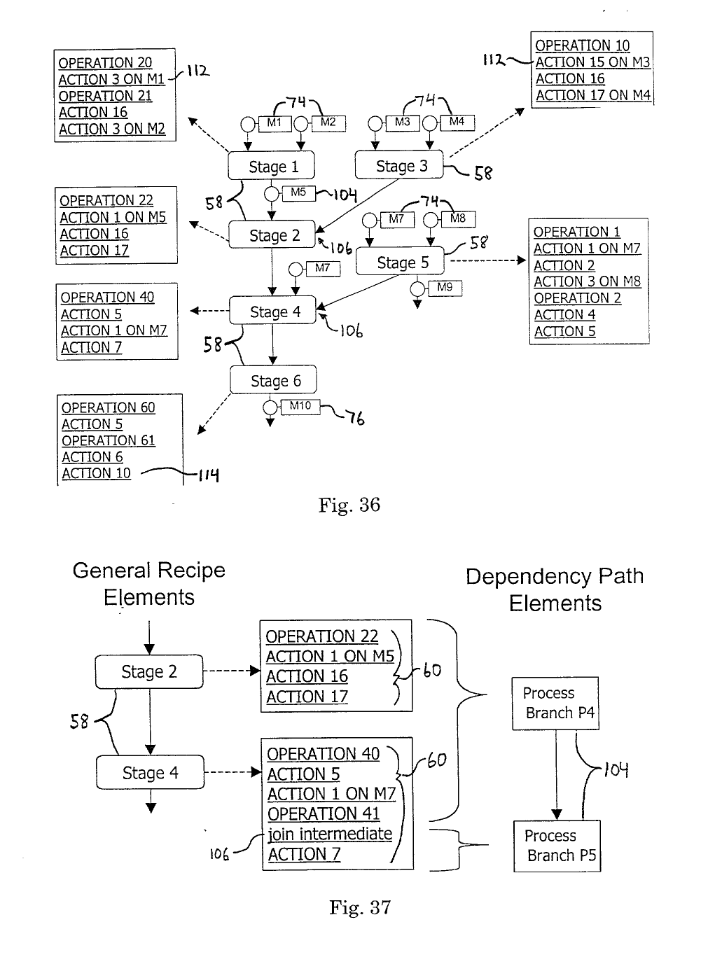

Referring to FIGS. 20 and 21, the first conversion execution step for creating the list of recipe segments 92 is step 94a, which expands the general recipe. This results in the expanded general recipe 44a. Referring to FIG. 36, the general recipe of FIG. 14 is shown including the details of the process broken down into process operations 60 and process actions 62. As described above, each process stage 58 is made up of process operations, which are further comprised of process actions. The conversion execution step 94a expands the general recipe 44 from the form of process stages 58 to the detailed process operations 60 and process actions 62 required to perform the process 56 of the general recipe.

Referring to FIG. 36, the process operations 60 are ordered groupings of process actions 62. The operation identifiers, for example “OPERATION 20”, “OPERATION 21”, etc. are labels identifying the starting point of each process operation. The steps associated with that process operation begin with the process action 62 following that process operation label and end at the last process action prior to the next process operation label encountered. For example, as shown in FIG. 36, Stage 1 comprises of two process operations, OPERATION 20 and OPERATION 21. OPERATION 20 comprises of one process action, ACTION 3, which is performed on material M1. OPERATION 21 includes two process actions, ACTION 16 followed by ACTION 3, performed on material M3.

In the preferred implementation, the process actions 62 of the general recipe 44 are organized into at least one process branch 100 and the process branches are interconnected in a dependency path 102 to form the general recipe. The process branches 100 are for describing how to process at least one material 104 (such as intermediate material M5 as shown in FIG. 36) separately without a material join 106 from another process branch. FIG. 37 depicts Stage 2 and Stage 4 expanded to show the underlying process operations 60 (OPERATION 22, OPERATION 40, and OPERATION 41), the underlying process actions 62 (ACTION 1 ON M5, ACTION 16, ACTION 17, ACTION 5, ACTION 1 ON M7, AND ACTION 7), and the process branches 100 (P4 and P5) of the dependency path 102. The process branches are the segments of the general recipe which process at least one material without joining material into the process from another process branch. A process branch 100 begins either at the point where input material 74 is first provided to the process branch to begin processing (i.e.: the beginning of the recipe) or at the end of two or more other process branches which have been joined. A process branch 100 ends either at the point another branch is joined to the branch or at the end of the process 56 where the all the material being processed in that branch is discharged out of the process as an output or product 72 (i.e.: the end of the recipe). Therefore, the process branches may be determined by identifying all the starting points of the general recipe 44, all the ending points of the general recipe, and all the points where material flow paths within the process join, or the material joins 106. The addition of an input material 74 to a process branch 100 does not constitute a material join 106, and the process branch continues on without starting a new branch. Thus, the at least one material 104 being processed by a process branch may comprise one or more materials. This is because during the material addition of an input material 74 to a process branch 100, there are more that one materials being processed, i.e., the input material and the material already in the process stage. The at least one material 104 may be an input material 74 if no other transformations have been performed on the material by the process branch 100 yet. The at least one material 104 may be one of the products 72 if the process branch is one of the branches producing a product and if the transformation of the materials being processed to the product is complete. Alternatively, if the at least one material 104 is no longer an input material 74 and it has not yet been transformed to a product 72, then the at least one material is an intermediate material, such as intermediate material M5 in FIG. 36. An intermediate material is any material which has been transformed by the process from an input material 74 to another material, but is not yet transformed to the at least one product 72. Intermediate materials may, or may not require unique identification within the process. This depends upon whether information unique to that material needs to be tracked to that material for the purposes of the process. The need for identification of an intermediate material could arise, for example, if physical properties of the material such as viscosity, density, vapor pressure, or the like are required for control of the process. Other requirements, such as safety and hazards, may require unique identification of the intermediate material. Material M5 is the only intermediate material with an identification tag in the example.

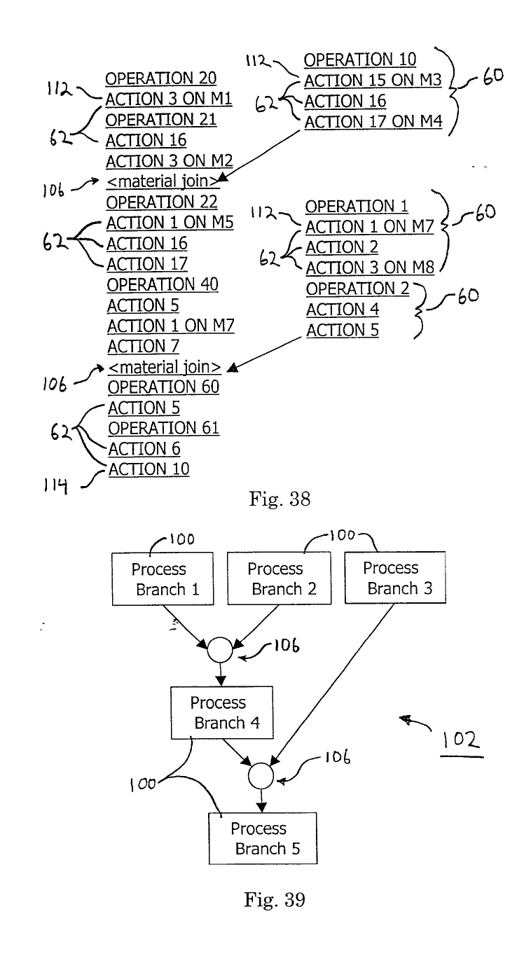

Referring to FIG. 37, process branch P4 terminates at the material join 106. This material join corresponds to the point in the general recipe 44 of FIG. 14 where Stage 5 is joined to Stage 4. Again referring to FIG. 37, at this point process branch P4 terminates and process branch P5 begins. The dependency path 102 corresponds to the interconnection path associated with the process branches 100, as shown in FIG. 39. In the preferred implementation, the general recipe 44 is broken into its process branches 100 and the dependency path 102 as shown in FIG. 39 and it is expanded into its component process actions 62 and process operations 60 as shown in FIG. 38. FIGS. 38 and 39 define the expanded general recipe 44a.

As depicted in FIG. 5, the general recipe 44 is expanded into the process actions 62, a list of all the recipe segments that perform those process actions in the process cell 14 is created, and all the permutations of master recipes 46 that will perform the general recipe in the process cell are created. For process cells 14 and general recipes 44 of any complexity, however, this can require tremendous amounts of computation. The division of the general recipe 44 into process branches 100 allows the steps of the conversion process to be performed on separate process branches discretely, thus reducing and preferably minimizing computational requirements and processing time. FIG. 12 depicts the method of the presently preferred embodiments including the steps of breaking down the general recipe 44 into the dependency path 102 and collection of process branches 108, which consists of all the process branches 100 contained in the general recipe.

FIG. 22 depicts the preferred processing flows to expand the general recipe 44. As shown in FIG. 22, the general recipe is first expanded from the process stages 58 into the process operations 60, and then it is further expanded into the process actions 62.

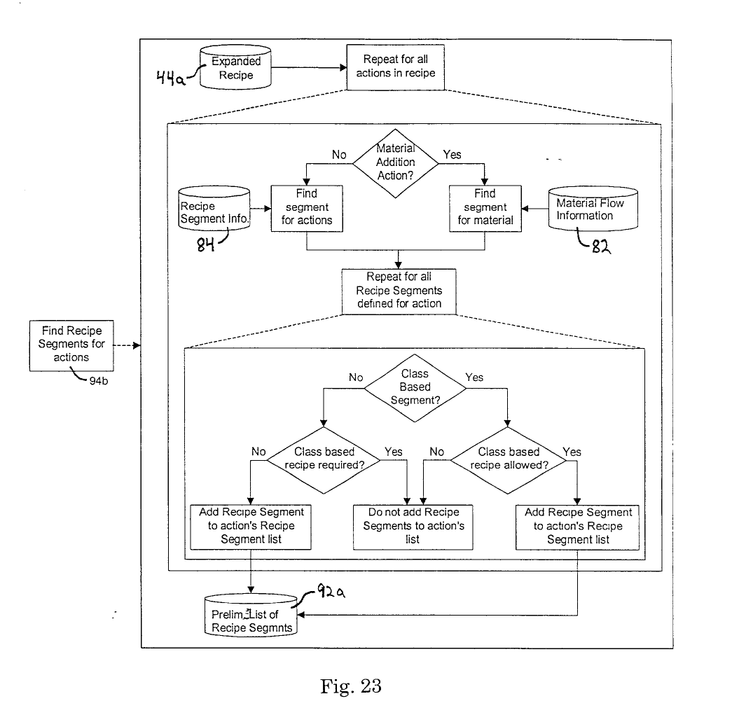

FIG. 22 is the detailed flow diagram for the processing flows associated with conversion execution step 94b of FIGS. 20 and 21. Conversion execution step 94b creates the preliminary list of recipe segments 92a for the process actions 62 in the expanded general recipe 44a. The basic process depicted in FIG. 23 is to look up the recipe segments 64 available in the process cell 14 for performing each process action 62 of the expanded general recipe and create a listing for each process action of the recipe segments which perform that process action in the process cell. The algorithm first screens the process action 62 to determine if it is a material addition action. If it is not a material addition, then the algorithm fetches all the recipe segments which perform that process action and adds them to the preliminary list 92a. If the process action 62 is a material addition, then the algorithm additionally verifies that the addition process action is associated with the correct input material 74. Only addition process actions that are associated with the correct input material (as required by the general recipe) are added to the preliminary list of recipe segments 92a.

In addition, each recipe segment 64 is screened to determine if it is an equipment class based recipe segment or not. If the recipe segment is class based, the algorithm checks to see if a class based recipe is allowed. If it is, then the recipe segment is added to the preliminary list of recipe segments 92a. If not, then the segment is not added to the list. Alternatively, if a class based recipe is not allowed, then the recipe segment is checked to see if it is class based. If it is class based, then the recipe segment is not added to the list. If it is not class based, then the recipe segment is added to the preliminary list of recipe segments. The process depicted in FIG. 23 is performed on all the process actions 62 in the general recipe 44.

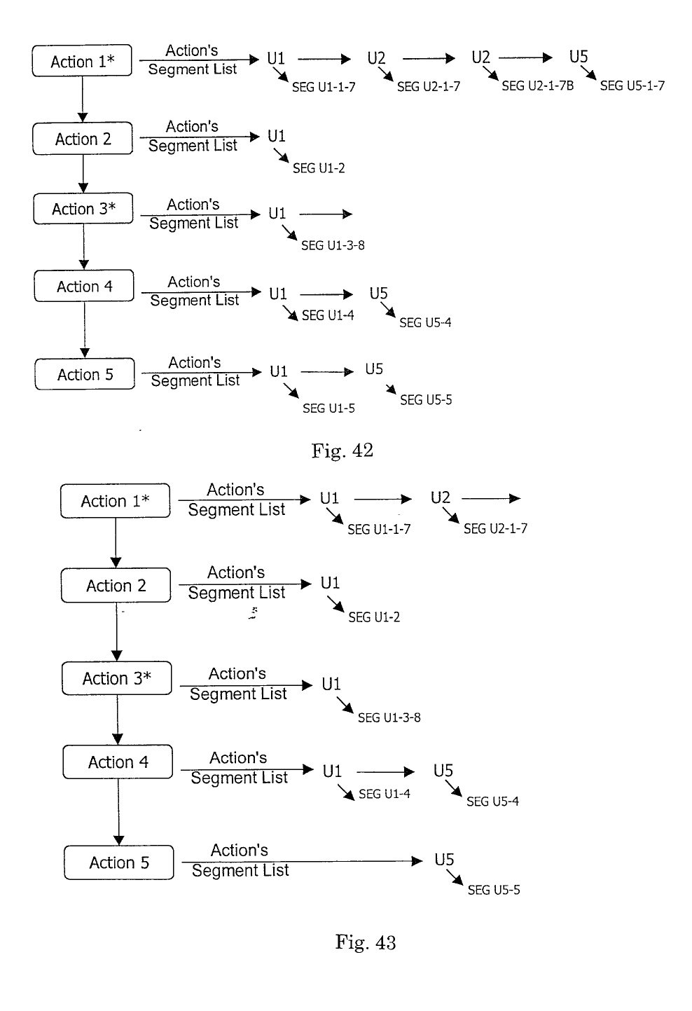

FIG. 42 depicts the results of conversion execution step 94b (See, e.g., FIGS. 20, 21, and 23) as it is applied to Stage 5 (See, e.g., FIGS. 14 and 15), or Process Branch 3 (See, e.g., 39), of the general recipe for this example. A similar preliminary list of recipe segments 92a is created for all the process branches 100 in the general recipe 44. The procedure is the same for all branches. The analysis provided in this example will only be performed in complete detail on Process Branch 3 (See, e.g., FIG. 39) of the example. The method used for the other process branches is the same as described for process branch 3 of this example.

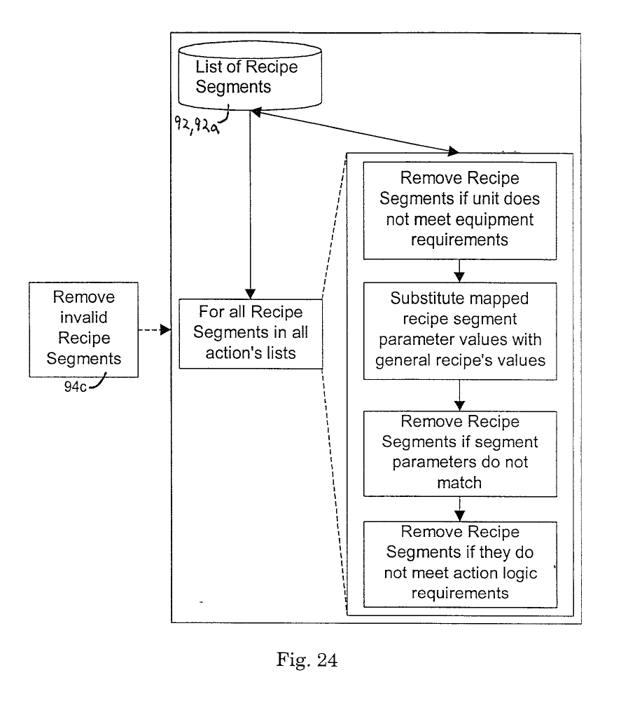

FIG. 24 depicts the preferred processing flows used to convert the preliminary list of recipe segments 92a to the final list of recipe segments 92. The list of recipe segments is screened against any equipment requirements defined in the general recipe 44. If the recipe segment 64 does not meet the equipment requirements for its corresponding process action 62, the recipe segment is removed from the list of recipe segments. If the recipe segment does meet the equipment requirements for the corresponding process action, the parameter values for the corresponding process action are copied to the recipe segment to define its parameter values. Each recipe segment in the preliminary list of recipe segments 92a is screened in this manner. The remaining list of recipe segments correspond to all the recipe segments which can perform the process actions of the general recipe 44 in the process cell 14. FIG. 42 corresponds to the resulting list of recipe segments 92 for Process Branch 3 of the example. In this case recipe segments SEG U2-1-7B, SEG U5-1-7, and SEG U1-5 were removed from the preliminary list of recipe segments provided in FIG. 42.

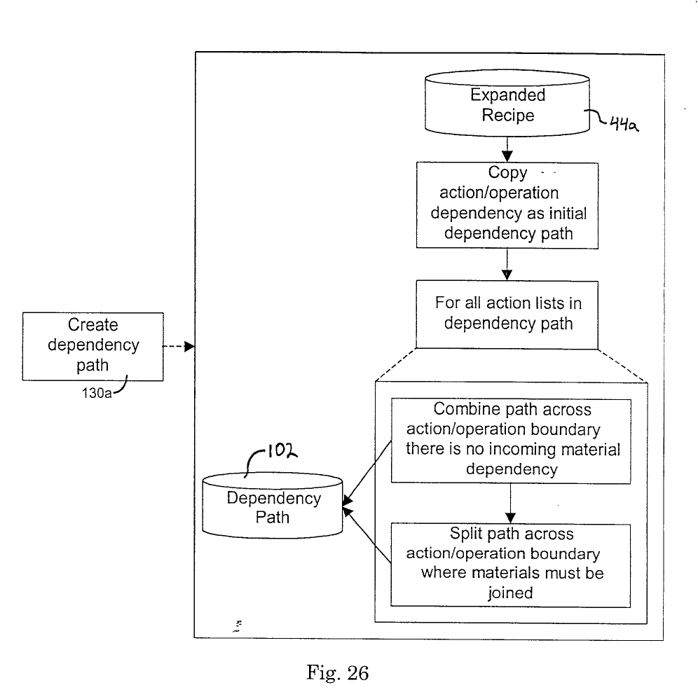

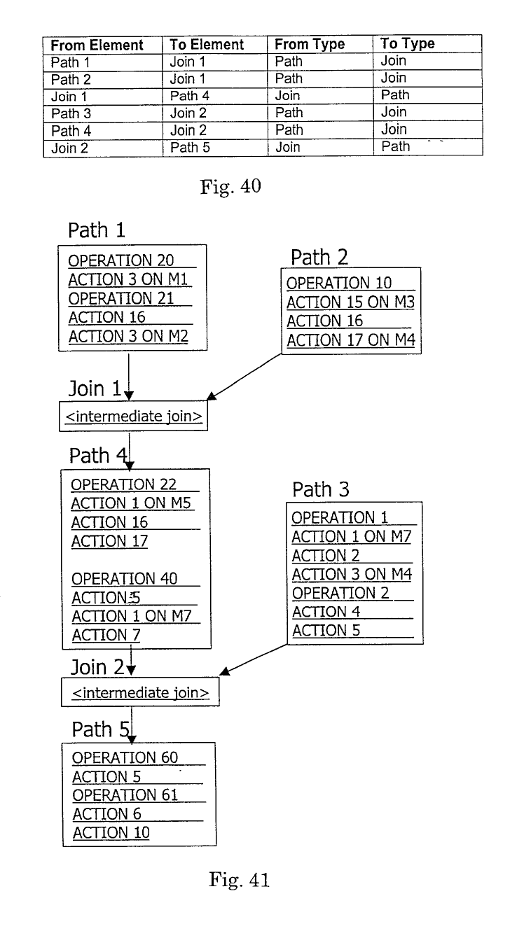

FIG. 26 illustrates a preferred method for determining the dependency path 102 for the general recipe 44. This process begins with the expanded general recipe 44a. The algorithm analyzes the expanded general recipe 44a beginning with starting process actions 112 and proceeds to remove all process actions 62 between the starting points and the first to be encountered of either a material join 106 as above defined or the an ending process action 114 (See, e.g., FIG. 38). When a process action is removed, the boundary between the previous process action and the next remaining process action is joined. At the end of this process all that remains are the general recipe starting points, ending points, and the material joins 106 which join the latter points in the form of a tree. Each resulting process branch 100 is uniquely identified, in this example as Process Branches 1 through 5. The resulting structure is depicted in FIG. 39. FIG. 40 is the same structure represented in tabular form. FIG. 41 shows the general recipe of the example in expanded form, but identifying all of the process branches 100, the material joins 106, and the general structure of the dependency path 102.

Further in accordance with this preferred implementation, the set of master recipes 42 is created from information comprising the list of recipe segments 92, the general recipe 44, and the site information 40, as generally illustrated in FIG. 5. As described above, FIG. 5 represents a simple and relatively computationally cumbersome method of creating the set of master recipes. In the implementation depicted in FIG. 5, the list of recipe segments 92, the expanded general recipe 44a, and the site information 40 are used to create all of the master recipes 46 that will perform the process 56 of the general recipe 44 in the process cell 14. This is done by replacing each process action 62 in the expanded general recipe 44a with one of the recipe segments 64 which performs that process action and meets the equipment requirements for the process action and the material flow constraints provided by the site information 40. The recipe segments are taken from the list of recipe segments 92. Each recipe segment is screened against the equipment requirements for the process action to verify that it meets the equipment constraints required by the general recipe, as described above. If the recipe segment 64 meets the equipment constraints, it is checked against the material flow information 82 for the process cell and to verify material can flow from the prior recipe segments already inserted in the pending master recipe to the recipe segment being screened. If the recipe segment 64 meets the constraints provided by the material flow information for the process cell, it is inserted into the master recipe being constructed and the next process action 62 of the general recipe is analyzed. If the recipe segment does not meet these constraints the recipe segment is discarded and the next recipe segment in the list of recipe segments is analyzed in a like manner. This procedure preferably is performed systematically, replacing all of the process actions in the general recipe to obtain a valid master recipe. This process is repeated until all of the unique permutations of valid master recipes that can be created from the general recipe, the site information, and the list of recipe segments are created.

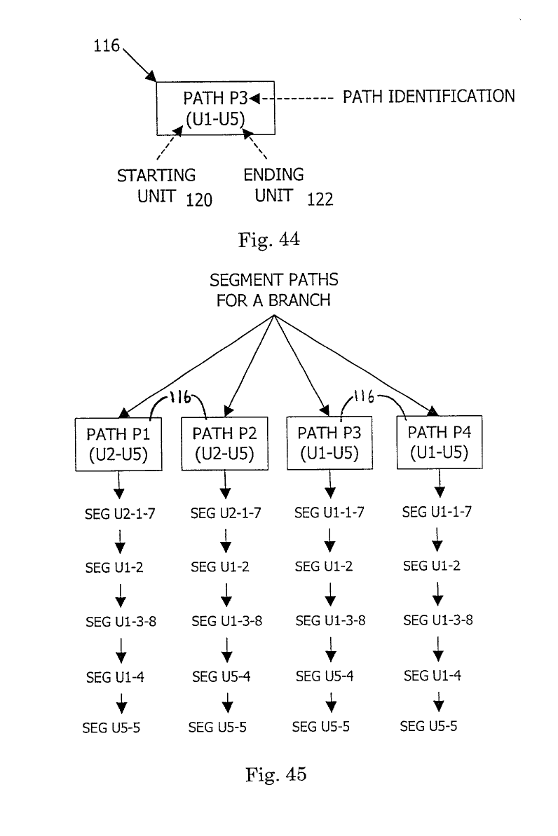

FIG. 12 depicts a more preferable or detailed approach, where the general recipe 44 is first dissected into the list of recipe segments 92, the dependency path 102, and a collection of process branches 108. Each process branch 100 can be used in combination with the list of recipe segments to construct all of the possible segment paths 116 which can perform the process actions 62 of the process branch in the process cell 14 as shown in FIGS. 44-47. A segment path 116 is simply the name for a branch in the procedure of the master recipe 46, such as a branch of recipe segments 64 which corresponds to a process branch 100 in the general recipe 44. In this manner each process branch 100 can be analyzed separately to determine all of the segment paths 116 which correspond to that process branch as depicted for process branch 3 of the example in FIG. 45. In the preferred implementation, each segment path 116 is analyzed, while it is being constructed from the list of recipe segments 92 and its corresponding process branch 100, to determine if the recipe segments 64 of the segment path can be performed given the material flow constraints for the process cell 14 (as defined by the material flow information 82). Each segment path 116 created is uniquely identified and cataloged by the process branch 100 to which it corresponds.

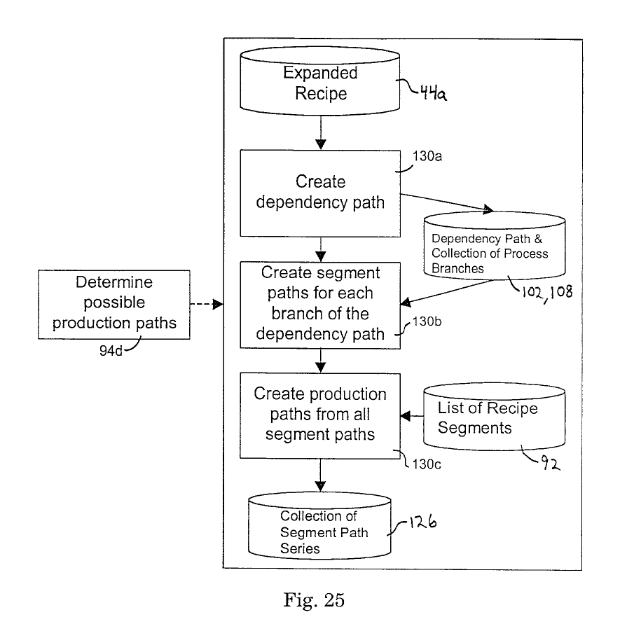

In the preferred implementation, FIG. 25 depicts a basic process used to reconstruct the general recipe 44 into the corresponding elements used to create the set of master recipes 46, namely the segment paths 116 as described above and the productions paths 118. The production paths are the interconnection path for the segment paths 116 of the master recipe 46. Each production path 118 corresponds to the dependency path 102 of the general recipe 44. The key difference between the production path 118 of the master recipe 46 and the dependency path 102 of the general recipe 44 is that the production path identifies which unique segment path 116 is used to perform each process branch 100 of the general recipe in the process cell with the respective master recipe 46. Because there is often more than one segment path 116 that can perform each process branch 100 of the general recipe, there are often multiple master recipes that are possible. Thus, there are as many production paths 118 as there are master recipes corresponding to the general recipe, even though there is only one dependency path 102 corresponding to the general recipe.

FIG. 44 provides an example of a segment path 116 including the identification scheme used in this example. As described above, the path identification is unique. In this case, the identification scheme is the simple tag “PATH P3”, where the prefix “PATH” identifies the label as a segment path and the alphanumeric suffix “P3” is the portion of the tag that is revised from path to path to make each label unique. In the example used here, the “P” remains fixed and the numeric digit is incremented for each new path encountered. The first path is “PATH P1”, the second path is “PATH P2”, and so on. This scheme is selected to improve the reader's comprehension of the example. Any identification scheme that provides a unique identification for each segment path may be acceptable.

In addition to the identification label for each segment path 116, the path starting unit 120 and the path ending unit 122 is identified. The path starting unit 120 is the unit 88 in which the first recipe segment 64 of the segment path 116 is performed. It corresponds to the unit in which that particular segment path must begin. The path ending unit 122 is the unit 88 in which the last recipe segment 64 of the segment path 116 is performed. It corresponds to the unit in which that particular segment path must end. The path starting unit and the path ending unit are used in the preferred implementation so that possible production paths may be analyzed against the material flow information 82 for the process cell 14 to determine if the production path 118 can be performed in the process cell. The inclusion of the path starting unit 120 and the path ending unit 122 in the data for a segment path 116 allows for production paths 118 to be analyzed without the need to actually construct any master recipes 46. This can significantly reduce computational requirements for the conversion process.

In the preferred implementation, the general recipe 44 is divided into the dependency path 102 and a collection of the at least one process branches 108. The collection of process branches 108 could be as few as one process branch 100 for the simplest general recipes. The method used to divide the general recipe into the dependency path and the collection of process branches is illustrated in FIG. 25, as described above.

In the preferred implementation, the list of recipe segments 92 is used to analyze each process branch 100 in the collection of the process branches 108 and create a segment path series 124 for the process branch. The segment path series 124 includes all the segment paths 116 corresponding to the process branch 100. The analysis results in a collection of segment path series 126 corresponding to the collection of the at least one process branch 108 as shown in FIG. 12. Further in accordance with the preferred implementation, the collection of segment path series 126, the dependency path 102, and the site information 40 are used to create a set of production paths 128. The collection of process branches 108, the list of recipe segments 92, and the site information 40 are used to create the collection of segment path series 126. The collection of segment path series 126 created, the dependency path 102, and the site information 40 are then used to create a set of all the production paths 128 which correspond to the dependency path 102 and can perform the process 56 of the general recipe in the process cell 14.

Block 94d in FIGS. 20 and 21 represents a general process to create the collection of segment path series 126 and the set of production paths 128. FIG. 25 breaks down block 94d into the component blocks 130a create dependency path, 130b create segment paths, and 130c create production paths. FIGS. 26 through 28 provide the detailed processing according to this implementation for performing each of the blocks 130a through 130c. The preferred method and corresponding processing of FIG. 26 for creating the dependency path 102 were described above.

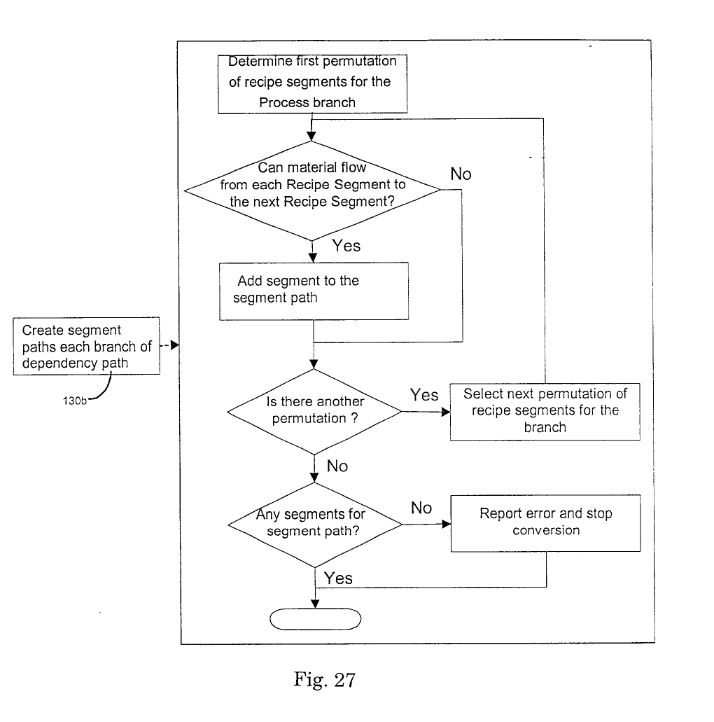

FIG. 27 illustrates a preferred method of creating the collection of segment path series 126. As shown in the figure, each process branch 100 is analyzed discretely using the list of recipe segments 92 and the material flow information 82 contained in the site information 40 to construct each segment path which can perform the process branch 100 in the process cell 14. This procedure is repeated for all combinations of recipe segments 64 which can perform the process actions 62 of the process branch 100 until the segment path series 124 for that process branch is complete. The segment path series 124 for a process branch 100 corresponds to all of the segment paths 116 that can perform that process branch in the process cell 14.

Each segment path 116 for a process branch 100 is constructed by using the list of recipe segments 92 to create each permutation of recipe segments 64 which correspond to the process actions 62 of the process branch 100, one at a time. The method then analyzes the potential segment path against the material flow information 82 for the process cell to determine if material can flow between each recipe segment in the potential segment path. If material can flow between the recipe segments in the segment path under scrutiny, then the segment path is added to the segment path series 124 for that process branch 100. If material can not flow between the recipe segments in the potential segment path, then the segment path is discarded or disqualified and the next possible permutation of recipe segments corresponding to the process actions of the process branch is analyzed. When all of the permutations have been analyzed for a process branch 100, the segment path series 124 is added to the collection of segment path series 126 corresponding to the collection of process branches 108 and the next process branch in the collection of process branches is analyzed in the same manner.

If any of the process branches 100 in the collection of process branches 108 does not have any segment path 116 that can perform the process branch in the process cell 14, the analysis is halted and an error is reported. This is because there must be at least one segment path that can perform each process branch in the process cell or the general recipe 44 cannot be performed in the cell. The procedure depicted in FIG. 27 is repeated until all of the process branches 100 in the collection of process branches 108 have been analyzed. The resulting data structure is the collection of segment path series 126 corresponding to the collection of process branches 108 for the general recipe.

FIG. 45 provides a depiction of the segment path series 124 corresponding to process branch P3 of the general recipe of the example. In this case there are four possible segment paths 116, PATH P1 through PATH P4, for process branch 3 of the example.

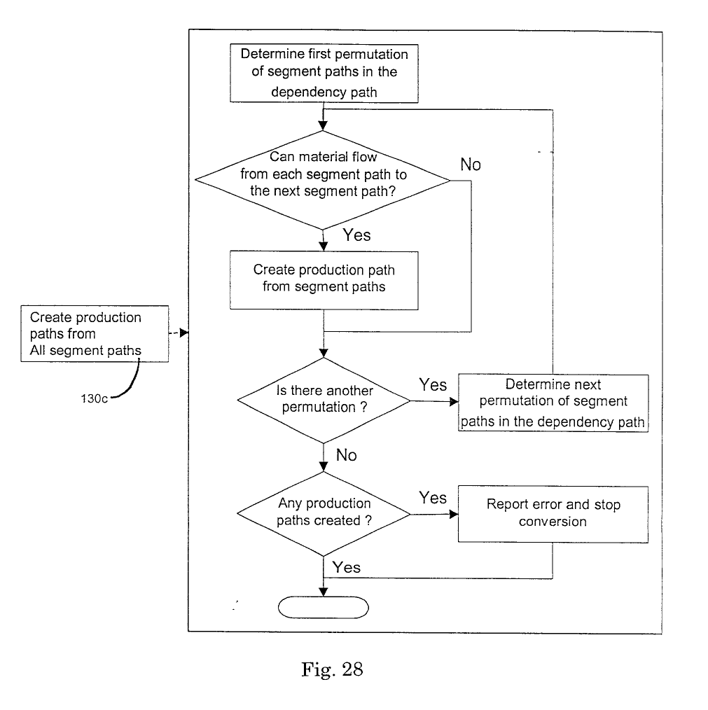

Once the collection of segment path series 126 is completed, all of the possible production paths 118 may be analyzed to determine the production paths that can perform the general recipe 44 in the process cell 14. This process is depicted by block 130c of FIG. 25. The detailed processing flows associated with the preferred procedure of block 130c are depicted in FIG. 28. Similar to the procedure FIG. 27, each permutation of possible segment paths 116 is analyzed. The procedure comprises using the dependency path 102 created above and the collection of segment path series 126 to create each possible production path 118 which might perform the dependency path 102 of the general recipe in the process cell 14. This may be done by replacing each process branch 100 in the dependency path with a segment path 116 from the collection of segment path series 126 corresponding to the process branch. Each possible production path 118 then can be analyzed against the material flow information 82 for the process cell to determine if material can flow between the segment paths 116 in the production path under investigation. If material can flow between the segment paths of the possible production path, then the production path 118 is added to the set of production paths 128. If material cannot flow between any of the segment paths in the production path being analyzed, then the production path is discarded and the next permutation of possible production paths is analyzed in the same manner. If no production paths are found after all of the permutations of segment paths have been analyzed, then an error is reported.

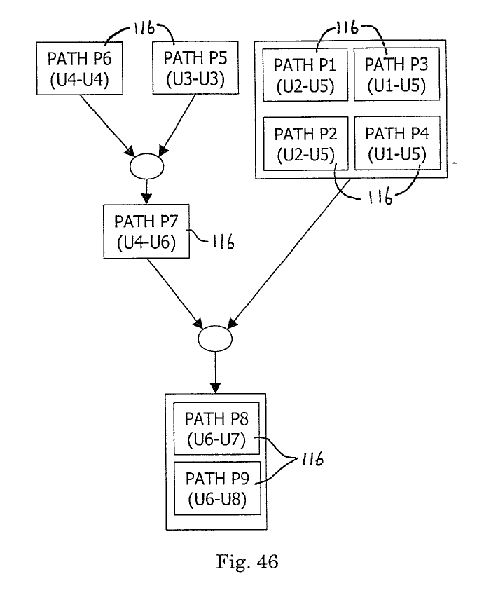

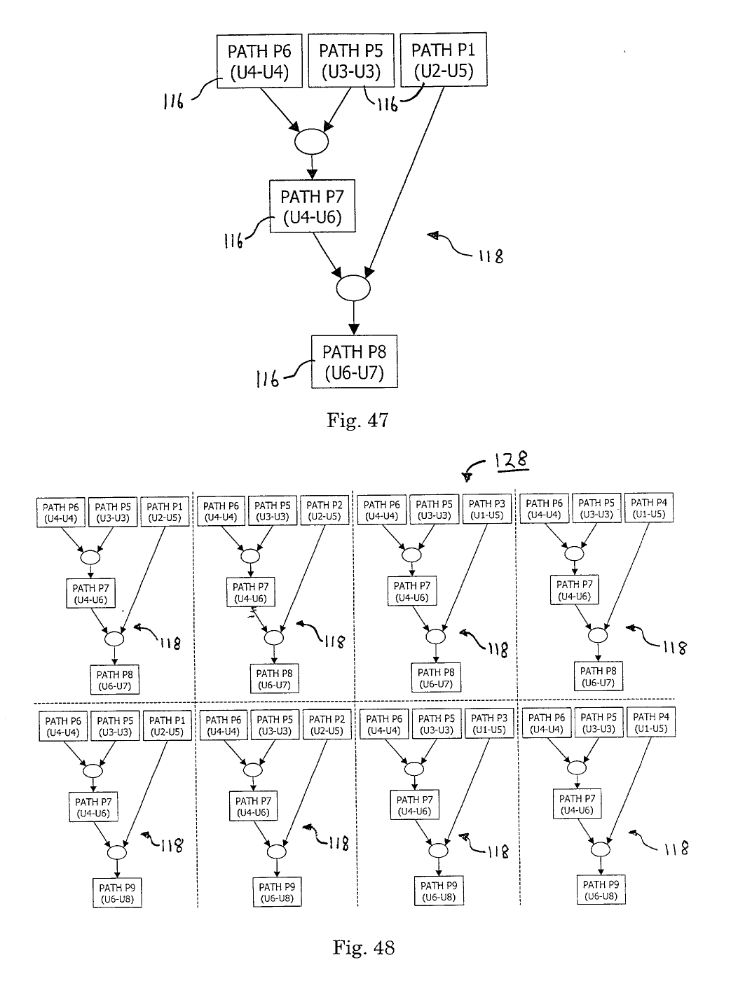

FIG. 46 depicts all of the possible segment paths 116 of the example organized into the general structure of the dependency path 102. FIG. 47 provides one of the possible production paths 118 for the example. FIG. 48 provides the resulting set of production paths 128 for the example after the performing the analysis outlined above.

Optionally, but preferably, the site information 40 comprises optimization information 132 and the method includes determining at least one optimum master recipe 134. The optimum master recipes 134 may be selected directly from the set of master recipes 42 after they are generated, or the optimization information 132 may be used during the general recipe 44 to master recipe 46 conversion process to eliminate non-optimum master recipes before they are created. The latter scenario is preferable because it eliminates possible master recipes before they are reconstructed from the general recipe. This can reduce processing time. The preferred optimization process is depicted in FIGS. 20 and 21. The optimization is performed on the set of production paths 128 and the segment paths 116 prior to reconstruction into the master recipe 46. Block 94f “Determine the Optimal Production Paths” as shown in FIGS. 20 and 21 corresponds to this step. In block 94f the set of production paths 128 created in step 94e are analyzed to determine the optimal production path or set of production paths based on optimization information 132.

The optimization information 132 may be user defined or it may be predefined, such as minimum number of material movements, minimum number of units used to perform the general recipe 44 in the process cell 14, minimum cost of running a recipe segment 64, etc. The optimization information 132 might be cycle time information which identifies the cycle time associated with each associated unit procedure 50 or unit operation 52 and the optimal master recipes are the master recipes 46 which produce the products 72 in the least time. The optimization information might be equipment path information and the optimal master recipes are the master recipes that will produce the products using the least number of units 88 in the process cell 14. The optimization information might be material transfer cost information and the optimal master recipes are the master recipes that will produce the products with the least material transfer costs. The optimization information 132 could be any type of information the user desires to utilize to optimize the master recipes 46 created by the invention.

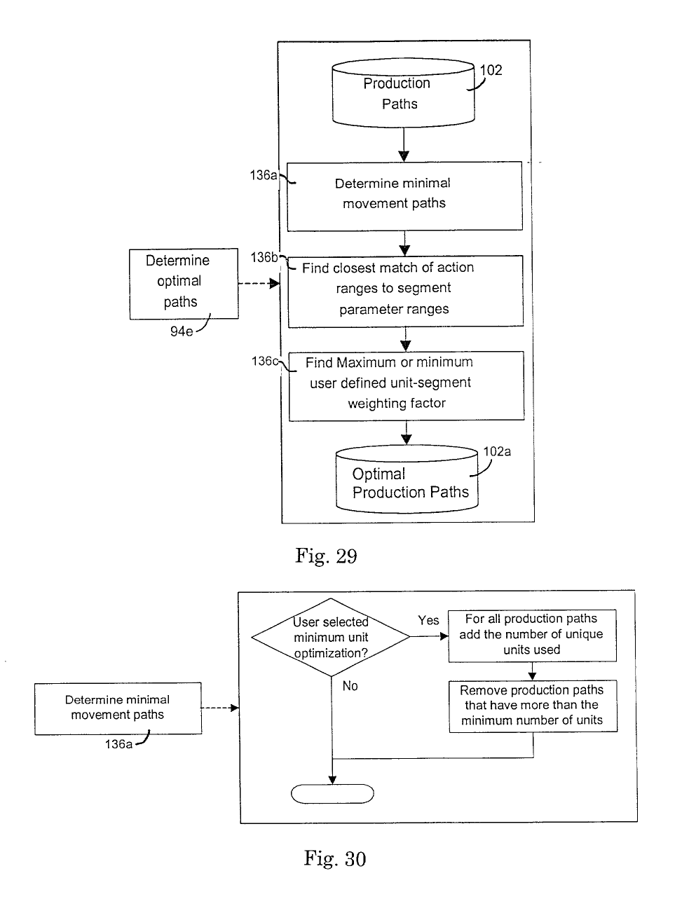

The preferred methods for selecting the optimal production paths are illustrated in FIGS. 29 though 32. FIG. 29 is a block diagram illustrating the basic procedure to optimize the production paths 118. The procedure is broken into three major process blocks, 136a through 136c. These blocks correspond to three separate varieties of optimization that may be performed. Each of these blocks preferably allows the user to select whether the optimization processing flows associated with the block are activated or not.

The first block 136a is the optimization procedure to minimize material movements and the number of units 88 required to perform the master recipe 46. Since the only information required to optimize this parameter is the material flow information 82, this optimization routine does not require any additional information above and beyond the material flow information included in the site information 40. FIG. 30 depicts the detailed processing flows associated with block 136a of FIG. 29. If the optimization procedure has been selected by the user, the algorithm counts the number of unique units utilized by each production path 118. The production paths with the minimum number of units are identified and all the paths with more than the minimum number of units are removed.

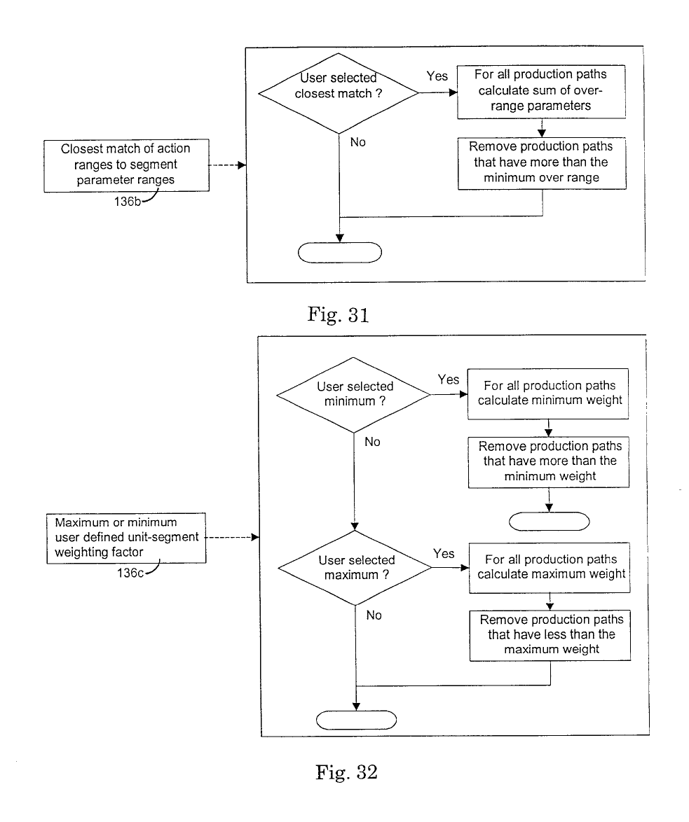

FIG. 31 depicts the detailed processing flows for the optimization procedure of block 136b, and the optimization procedure to select the production paths 118 with recipe segments 64 which provide the closest match between the parameter ranges for the process actions 62 that they perform. Again, the user is provided the option of selecting the optimization procedure. If the procedure has been selected, the algorithm or procedure calculates the sum of all of the parameters over range or parameters out of range associated with each recipe segment 64 of each production path 118. For example, if the range for a process action 62 is 100 to 150 gallons and the corresponding recipe segment 64 has a range of 50 to 400 gallons, the out of range or over range parameter for this recipe segment might be [100 gallons −50 gallons]+[400 gallons −150 gallons]=300 gallons. Each recipe segment 64 in the production path 118 has the over range parameter calculated in this manner.

The over range parameter for each recipe segment 64 is a measure of how closely the operating range for the recipe segment matches that required by its corresponding process action 62. The lower the over range parameter is, the better the recipe segment matches the process action it is intended to perform. The algorithm for this procedure calculates the sum of the over range parameters for all of the recipe segments in the production path. The production paths 118 with the minimum sum of the over range parameters are identified and the production paths that have a sum of the over range parameter greater than the minimum are removed from the set of production paths 128.

FIG. 32 depicts the detailed processing flows for the optimization procedure of block 136c of FIG. 29, the maximum or minimum user defined unit-segment weighting factor. As with the other optimization procedures, the user is provided the option of selecting either a user defined minimum or a user defined maximum weighting factor. If either one of these options is selected, the user must provide the weighting factor so that the weighting value can be calculated for each production path 118. Material transfer costs or unit efficiencies are examples of optimization information 132 that would require the user to provide such information. This information could be provided as part of the site information 40 associated with the process cell 14. If the user selected minimum is activated, the algorithm or process calculates the weighting value associated with each production path 118. The production paths with the minimum weighting factor are identified and all production paths with a weighting factor above the minimum value are removed. If the user selected maximum is activated, the algorithm calculates the weighting factor associated with each production path. The production paths with the maximum weighting factor are identified and all the production paths with weighting factors below the maximum value are removed.

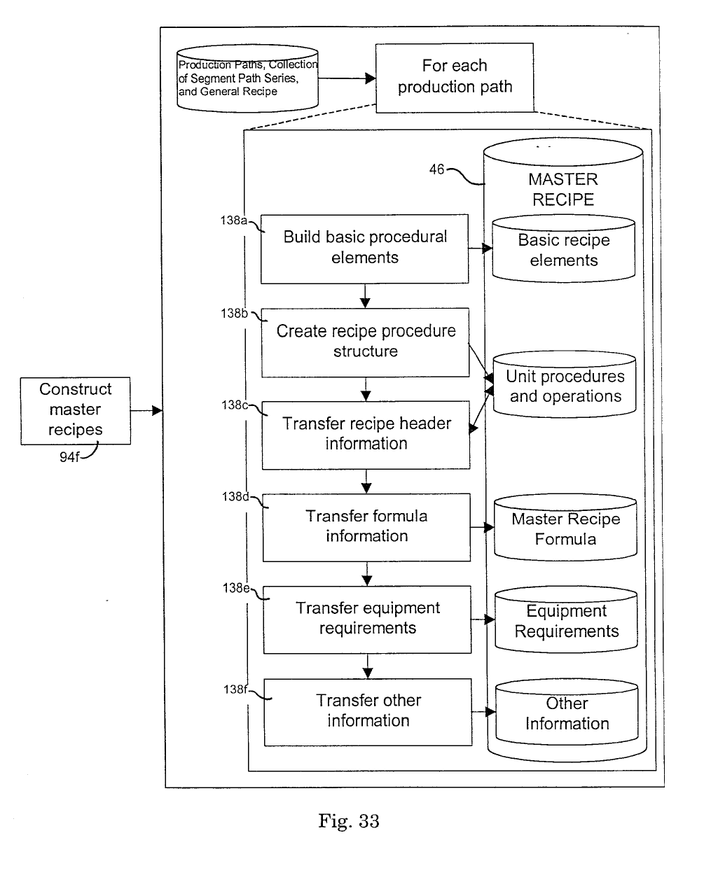

Further in accordance with the preferred implementation, the set of production paths 128, the collection of segments path series 126, and the site information 40 are used to create a set of master recipes 42, as shown in FIGS. 12, 20, and 21. Preferably, the optimization procedure, block 94e shown in FIGS. 20 and 21 described above, are performed on the production paths 118 to eliminate non-optimum production paths. This minimizes the number of master recipes 46 that require reconstruction, thus saving processing time. Block 94f or FIGS. 20 and 21 represent the reconstruction process. FIG. 33 provides a more detailed depiction of the reconstruction process associated with block 94f. The basic steps of the reconstruction procedure are to build the basic procedural elements as depicted by block 138a, create the recipe procedure structure as depicted by block 138b, transfer the recipe header information as depicted by block 138c, transfer the formula information as depicted by block 138d, transfer the equipment requirements as depicted by block 138e, and transfer the other information as depicted by block 138f. This procedure is performed for each production path 118 remaining in the set of production paths 128, one at a time, until all the master recipes 46 in the set of master recipes 42 have been constructed. The first step of the process, building the basic procedural elements, comprises inserting the recipe segments 64 for each segment path 116 of the production path 118 into the master recipe being constructed. This results in the basic building blocks of the master recipe. All of the recipe segments 64 that correspond to the process actions 62 of the general recipe 44 are in place in the master recipe under construction.

The next step in the process, creating the recipe procedure structure as depicted by block 138b, includes the main procedural elements of the reconstruction process. In the preferred implementation, this step performs the following functions:

1. Defines the starting and ending points of the master recipe,

2. Inserts all the material transfers between the different units used by the master recipe in the process cell,

3. Inserts all the unit start recipe segments and the unit end recipe segments for each unit requiring such segments,

4. Transfers all the process operation identifiers from the general recipe to the master recipe as unit operation identifiers, and

5. Identifies all the unit procedures in the master recipe.

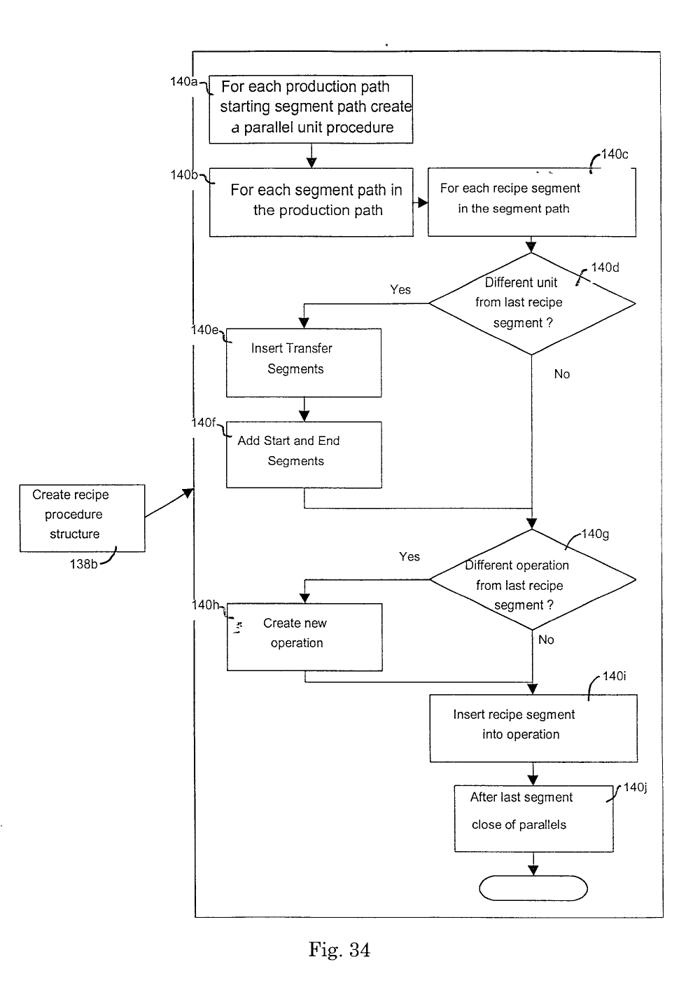

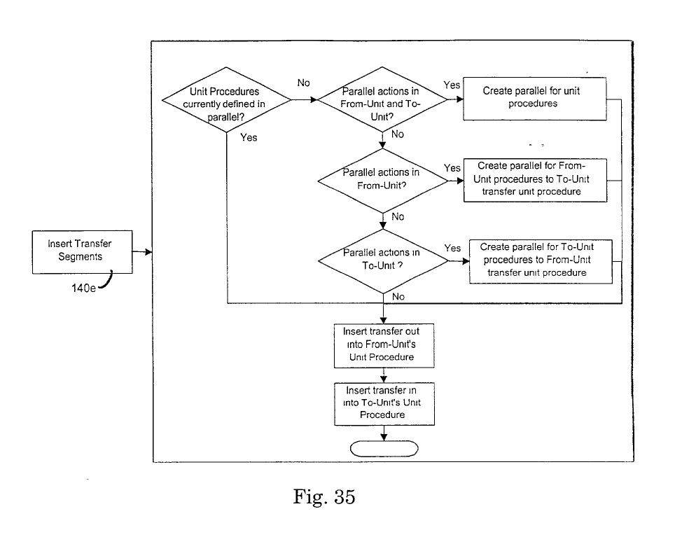

The processing flows associated with block 138b are depicted in FIGS. 34 and 35. The first step is to find each starting segment path and to open parallel unit procedures 50 for the starting unit of each of the starting segment paths. As described above, the unit procedures 50 and the unit operations 52 are simply sections of the master recipe 46 that are smaller master recipes unto themselves. Essentially, they can be thought of as subroutines, or subcomponents. They contain all of the necessary structure to operate alone. They correspond to convenient modules of the master recipe which allow the recipe to be divided in a modular structure which is sensible for both the users and for the structure of the process cell 14. For example, if one unit in a cell is not operational, the unit procedure for that unit may be replaced with an equivalent unit procedure for another unit which can perform that procedure, provided that the material flow paths in the cell allow its use in that master recipe. The unit procedures and the unit operations include the same categories of information as the master recipe, as was described above. They contain a header, a formula, a procedure, equipment requirements, and other information.

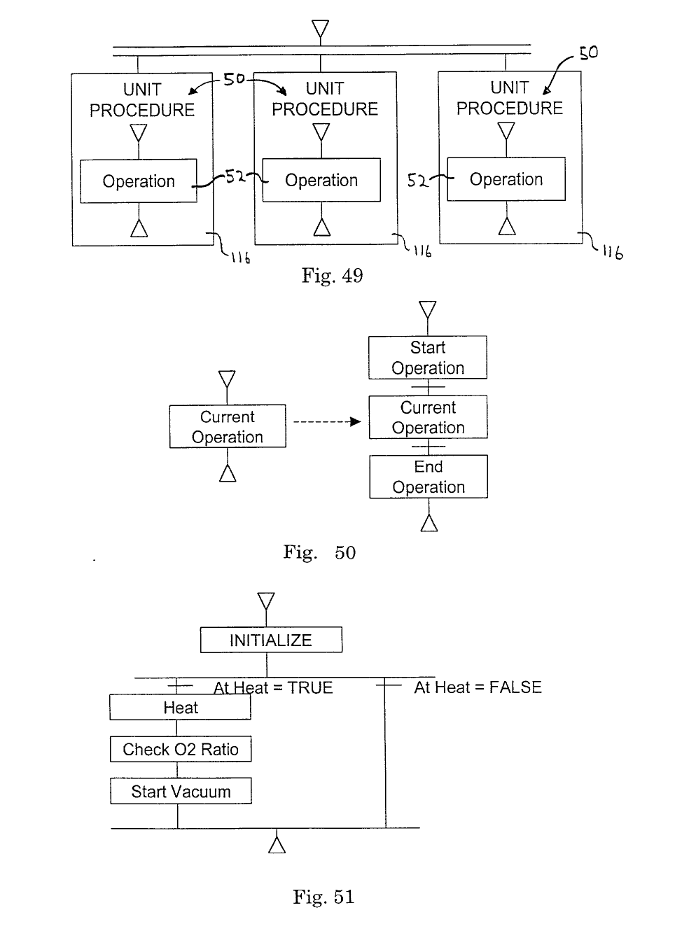

Blocks 140a through 140j illustrate the steps of the reconstruction process. The procedure begins at the starting segment paths. Parallel unit procedures are created for each starting unit in the starting segment paths as depicted by block 140a. FIG. 49 depicts the first step of the procedure applied to the production path 118 of FIG. 47 for the example. In this case, there are three starting segment paths, paths P4, P5, and P1 of FIG. 47. All three paths are opened in parallel, as shown in FIG. 49. As described above, the unit procedures 50 are divided into their corresponding unit operations 52 as shown in FIG. 49.

Each segment path 116 preferably is analyzed one at a time, starting with the segment path corresponding to the first starting process branch. Upon completion of the previous segment path, the next segment path is selected and analyzed, as depicted by block 140b. The segment paths 116 are analyzed one recipe segment 64 at a time, as depicted by block 140c. The first step of the analysis of a recipe segment is to determine if the recipe segment corresponds to a different unit than the previous recipe segment, as depicted by block 140d. The starting recipe segment of a starting segment path (corresponding to the beginning of the master recipe) is a new unit by virtue of the fact that it is the beginning of the recipe. This also starts a new unit procedure. When a new unit is encountered, the transfer recipe segments for the transfer between the previous unit and the new unit are inserted, as depicted by block 140e. A new unit procedure identifier is inserted at the start of the new unit procedure. Unit Start and End Segments are added if required, as depicted by block 140f. FIG. 50 provides the basic structure of a unit procedure 50 with a start recipe segment, an end recipe segment, and one unit operation 52. If the previous unit requires a unit end recipe segment, it is inserted. If the new unit requires a unit start recipe segment, it is inserted. FIG. 51 provides an example of a unit start recipe segment. In this example, if the unit is to operate at temperature (at heat=true), then the start recipe segment requires that the unit be heated, the O2 ratio be checked, and a vacuum be initiate. If the unit is not to operate at temperature (at heat=false), then no start recipe phases are performed. An example of the data structure defining the start and end recipe segment requirements for the units in the process cell of the example is provided in FIG. 18.

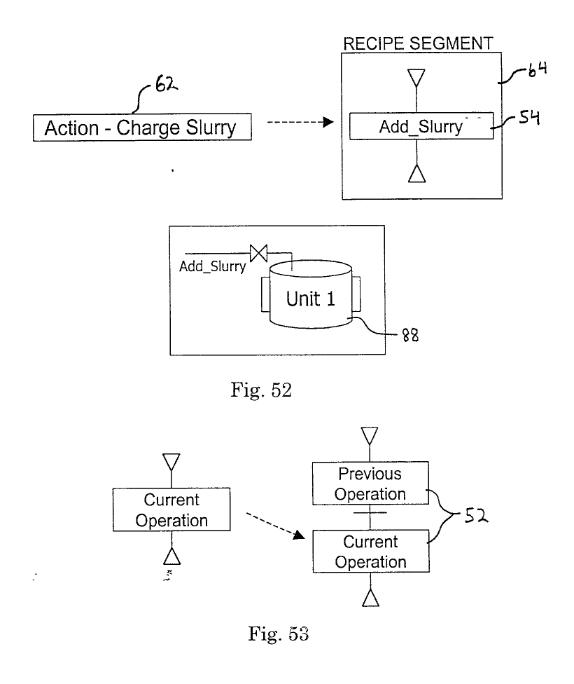

As described above, the segment paths 116 are divided into their corresponding operations, which are referred to as process operations 60 in the general recipe 44 and unit operations 52 in the master recipe 46. During the creation of the master recipe structure, the unit operations must be inserted in their correct location. Each recipe segment 64 is analyzed against its corresponding process action 62 in the general recipe to determine if it is part of a new operation, as depicted by block 140g. FIG. 52 provides an example of a recipe segment and its corresponding process action. In this example, the recipe segment 64 includes a single recipe phase 54, “Add-Slurry”. If its corresponding process action 62 is the start of a new process operation 60, a new unit operation 52 is created, as depicted by block 140h, and the recipe segment is inserted into the new operation as depicted by block 140i, as shown in the example of FIG. 53. If the segment 64 corresponds to the closing of parallel process operation, then the parallels are closed as depicted by block 140j. The required parallel operations are defined by the general recipe 44. Parallel process branches generally close when process branches 100 join at a material join 106 as described above.

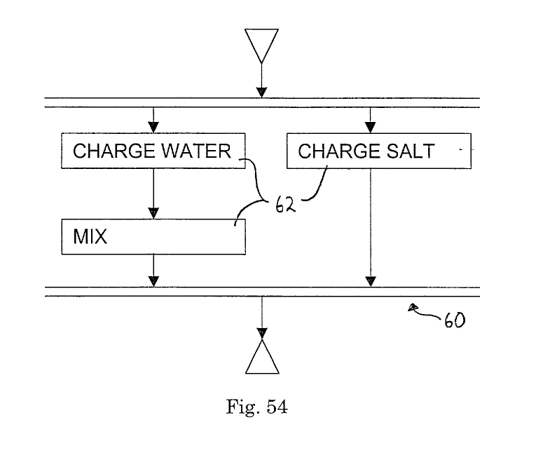

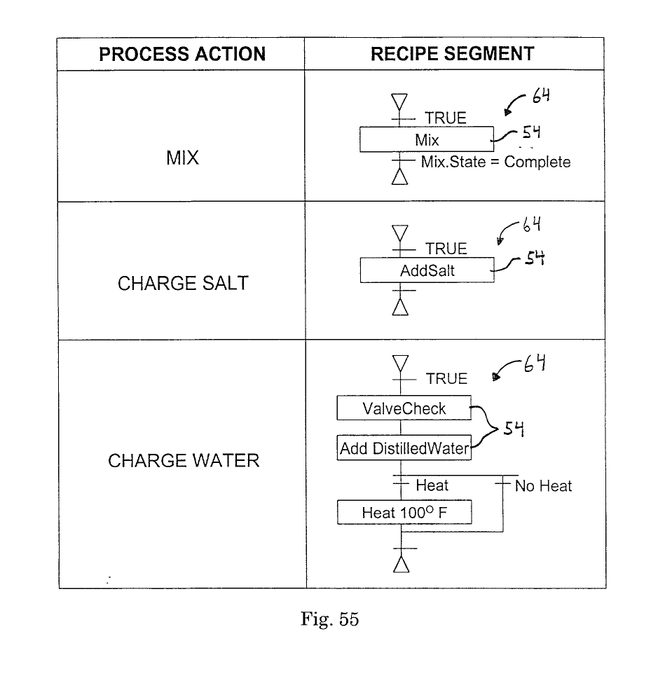

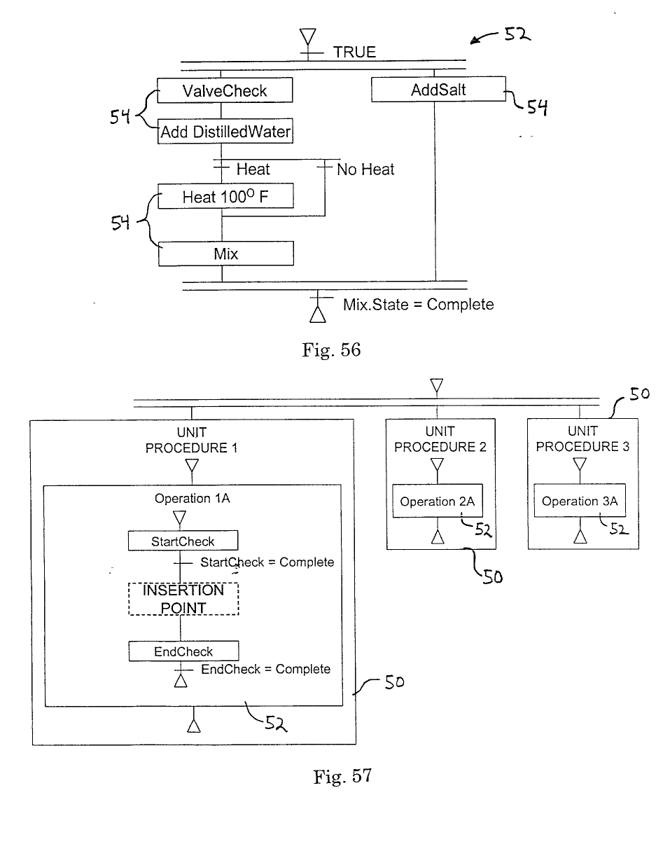

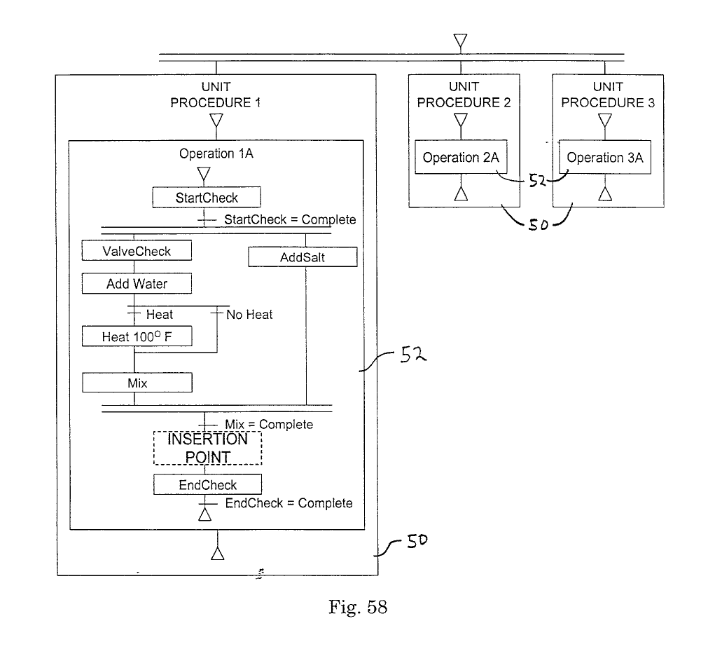

FIGS. 54 through 58 depict the resulting data structures from the steps associated with the creation of unit operations 52 and their insertion into the unit procedures 50 during the reconstruction of a master recipe 46. FIG. 54 provides an example of a process operation 60 from a general recipe 44 consisting of two parallel branches and three process actions 62. FIG. 55 provides the recipe segments 64 corresponding to the process actions 62 from FIG. 54 including the details of the recipe phases 54 associated with each of the recipe segments. FIG. 56 shows the resulting unit operation 52 constructed from the process operation 60 of FIG. 54. FIG. 57 depicts the three parallel starting unit procedures from FIG. 49 with UNIT PROCEDURE 1 having an insertion point for receiving the unit operation of FIG. 56. FIG. 58 shows the resulting UNIT PROCEDURE 1 with the unit operation of FIG. 56 inserted and identified as unit Operation 1A.

FIG. 34 is a detailed depiction of the process for inserting transfer recipe segments. There are three basic scenarios in which a unit transfer can be involved. Transfers in which there are no parallel processing operations occurring during the transfer in any of the units involved, transfers in which one or more of the “transfer from” units requires operations to continue to be performed in parallel during and/or after the transfer operation, and transfers in which the “transfer to” unit requires operations to continue to be performed in parallel during and/or before the transfer operation. There generally are separate recipe segments for each of the two units involved in a transfer, a “transfer from” recipe segment and a “transfer to” recipe segment, as shown for the example in FIG. 16.

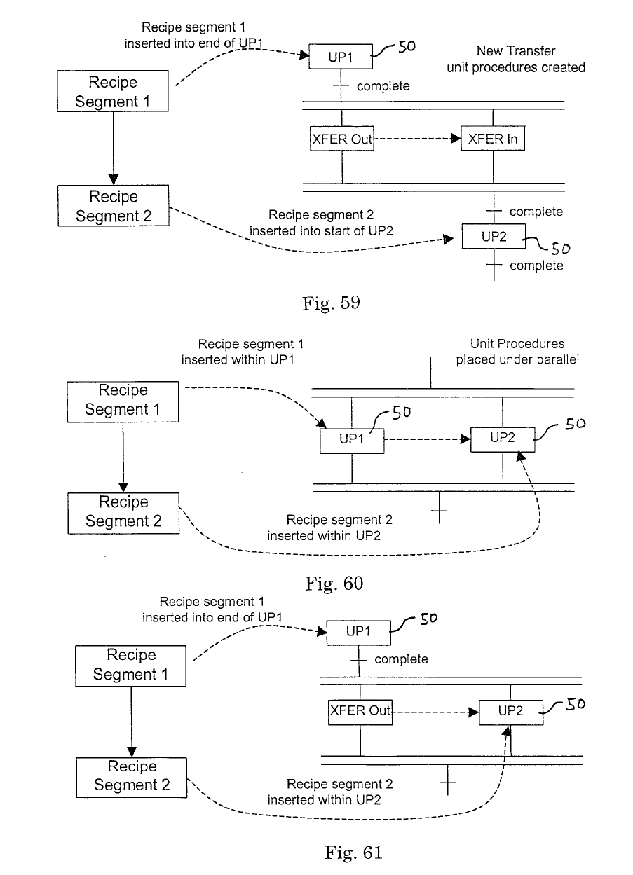

FIGS. 59 through 62 are examples of the transfer from one unit to another involving situations with and without parallel processing during the transfer operation. FIG. 59 depicts the situation where there is no parallel processing during the transfer operation. UP1 is the unit procedure for the “transfer from” unit and UP2 is the unit procedure for the “transfer to” unit. In this case, UP1 processes the materials until the procedure of UP1 is complete. UP2 processes the materials after the transfer process is complete. Neither UP1 nor UP2 operate in parallel with each other or with the transfer in this scenario. As shown in FIG. 59, in this case the transfer from recipe segment (depicted as “XFER Out”) is added to the end of unit procedure UP1. The transfer to recipe segment is added to the beginning of unit procedure UP2. A parallel is opened at the beginning of the transfer and the parallel is closed at the end of the transfer. Thus, the unit procedure UP1 is completed. The transfer recipe segments are then performed in parallel. The parallel is closed and the unit procedure UP2 starts.

FIG. 60 depicts the scenario where both the unit procedures are operated in parallel and the transfer occurs while the procedures operate in parallel. In this case a parallel is started at the beginning and both of the unit procedures are initiated in parallel. The transfer from and transfer to recipe segments are inserted within the unit procedures at the appropriate point in the respective unit procedures. The unit procedures start together, the material transfer occurs while both unit procedures are being performed, and the unit procedures continue to operate in parallel until they are both complete.

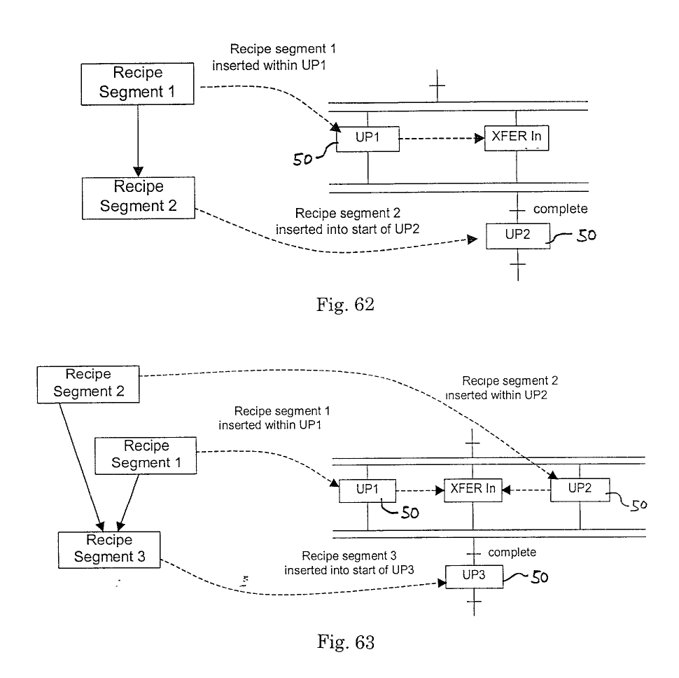

FIGS. 61 and 62 depict the remaining two possibilities for a material transfer between two units. FIG. 61 depicts the situation where unit procedure UP1 does not have any parallel operations being performed during the transfer, but unit procedure UP2 does have parallel operations being performed during the transfer. Such might be the case if unit procedure UP2 required activities such as mixing or heating to be performed during the transfer. The transfer might be a controlled transfer, where the material being transferred into unit 2 is being reacted, for example, with a material already in unit 2 prior to the transfer. Such a situation often requires a controlled transfer so that the temperatures can be maintained within a specified range during the transfer process. The transfer rate may actually be controlled to maintain the temperature in unit 2, as might be the case in a highly exothermic or endothermic reaction. In this case, the transfer from recipe segment is added to the end of unit procedure UP1 and the transfer to recipe segment is added within the recipe of unit procedure UP2. A parallel is opened after UP1 is complete and UP2 is started. The transfer is performed at the appropriate time during the operation of unit procedure UP2. FIG. 62 depicts the transfer occurring with operations being performed in unit procedure UP1 in parallel to the transfer. The transfer to unit does not have any parallel operations being performed during the transfer. In this case, unit procedure UP1 is started at the beginning of the parallel. The transfer from recipe segment is inserted within the procedure of UP1. The transfer is performed at the appropriate time during the performance of unit procedure UP1. The transfer to recipe segment is inserted at the beginning of unit procedure UP2. The transfer is performed in parallel with UP1, the parallel is closed, and then the unit procedure of UP2 begins, not in parallel to the transfer.

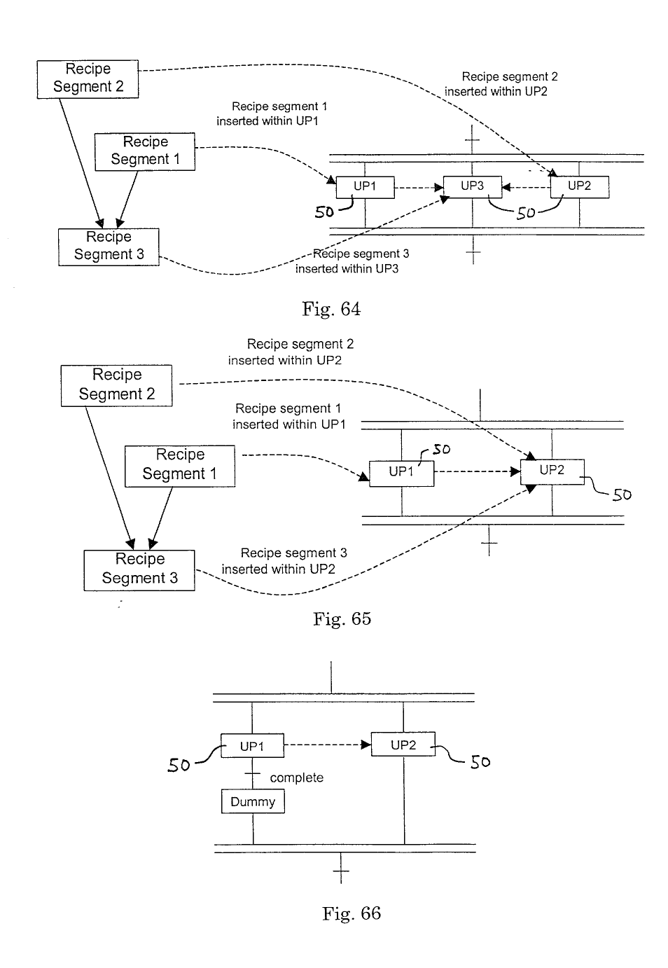

Material transfers such as a material join 106 involving three process branches 100 of the general recipe 44, corresponding to three segment paths 116 of the master recipe 46, are handled similarly to the two unit material transfers discussed above. The key difference is that two transfers may be involved instead of one. This does not have to be the case, however, if the end of one of the transfer from segment paths is in the same unit as the beginning of the transfer to segment path. This scenario is depicted in FIG. 65. FIGS. 63 and 64 correspond to examples where the transfers involve three units 88. FIG. 63 depicts a material join involving three units, unit 1 through 3, with three respective unit procedures, UP1 through UP3. In FIG. 63 the two transfer from unit procedures, UP1 and UP2, have parallel processing being performed during the transfer. The transfer to unit procedure UP3 does not have any processing being performed in parallel during the transfer. In this case, the transfer from recipe segments are added within the unit procedures of UP1 and UP2 and the transfer to recipe segment is added to the beginning of unit procedure UP3. UP1 and UP2 begin in parallel and the transfer is performed at the appropriate time during the operation of UP1 and UP2. The parallel operations are closed after the transfer and the procedure of UP3 is performed, not in parallel with the transfer operation. It should be noted that the transfers depicted in FIG. 63 from unit 1 and unit 2 into unit 3 are depicted to occur simultaneously. Each of the transfers to unit 3, from unit 1 and unit 2, respectively, could occur at different times during the procedures of UP1 and UP2. In this case, two transfer to recipe segments would be added at the start of UP3, one for the transfer from UP1 and one for the transfer from UP2. FIG. 64 depicts the same transfer process where there are parallel operations being performed in all three units procedures, UP1, UP2, and UP3. In this case the transfer from and transfer to recipe segments are inserted within each of the unit procedures. All three unit procedures are operated in parallel and the transfer is accomplished at the appropriate time during the performance of the three unit procedures.

It should be noted that during any of the transfers with parallel unit operations being performed in one or more units 88 involved in the transfer, the parallel operations may only be active during a portion of each of the unit procedures 50 involved. The actual start and end of the unit procedures may be at a different time from one another. In this case, only the portion of the unit procedures that are required to be in parallel should be represented in parallel. A dummy unit procedure may be added for the time periods when the unit procedures are not in parallel. This allows a unit which is not being used during a portion of the procedure to be de-allocated in a timely fashion. This situation is depicted in FIG. 66.

As discussed above, FIG. 35 depicts the processing flows for inserting the material transfer recipe segments associated with block 140e of FIG. 34. When an insertion point has been identified by the process of FIG. 34, first it is determined if the transfer from and transfer to unit procedures are currently operating in parallel. If not, then the algorithms determine if there are suppose to be any parallel operations in the from unit, the to unit, or both. If parallels are required they are created in the appropriate unit procedure for the from or the to unit or both. After the appropriate parallel operations have been created, the transfer from recipe segment is inserted into the unit procedure of the unit discharging the material and the transfer to recipe segment is inserted into the unit procedure for the unit receiving the material.

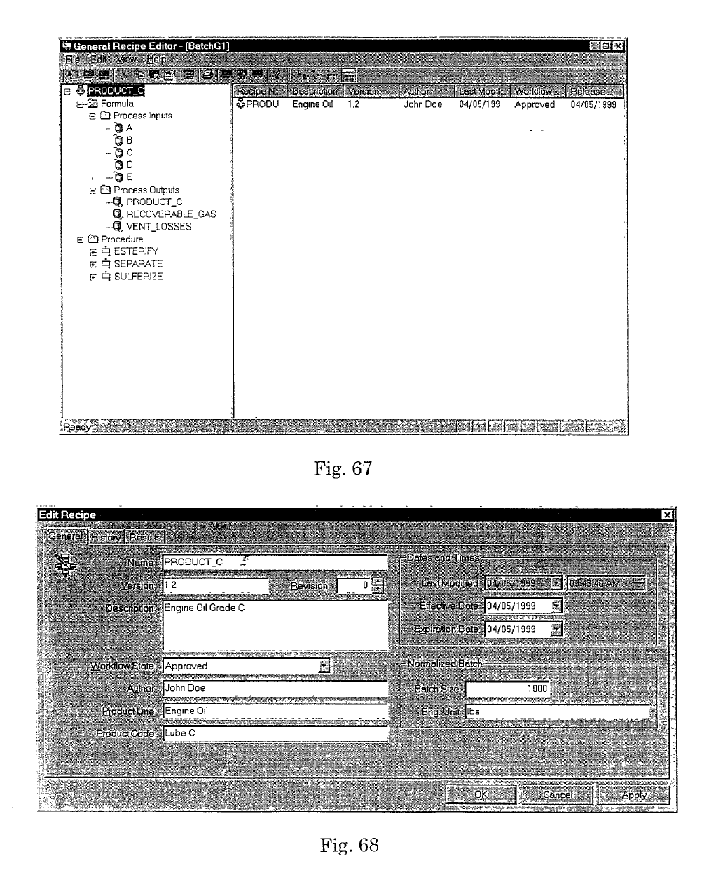

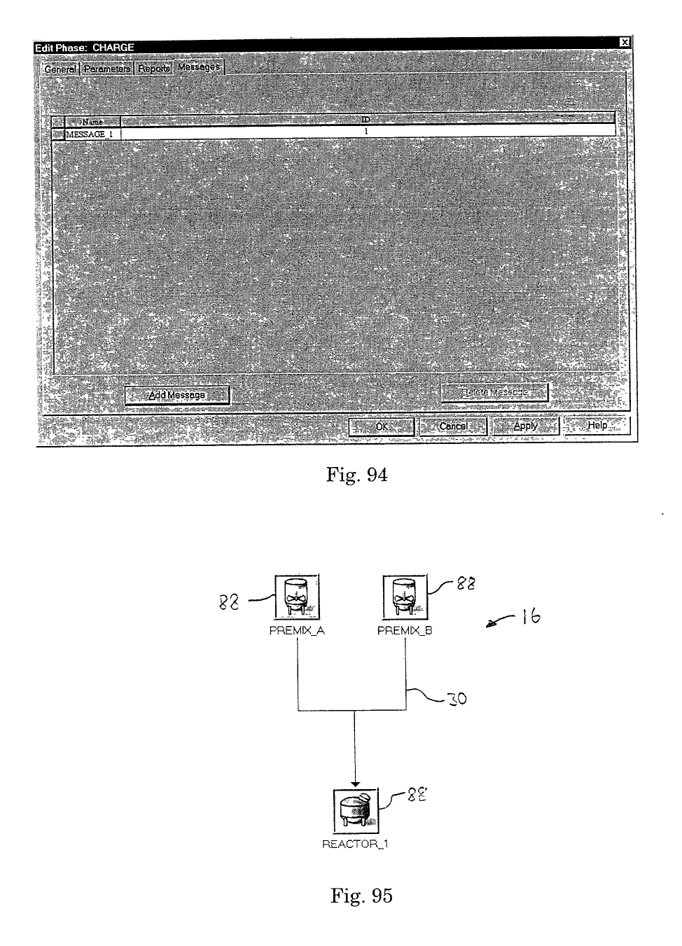

FIGS. 67 through 97 provide an example of a preferred data structure and methods of representing a general recipe 44, a master recipe 46, and site information 40 for use with the preferred implementation. Much like the example provided by FIGS. 13 through 19 and 36 through 45 described above, FIGS. 67 through 97 provide an example of a specific general recipe 44, a specific set of site information 40 defining a specific process cell 14, and a master recipe 46 created from the general recipe of the example and the specific set of site information. FIGS. 67 through 97 represent the general recipe, the master recipe, and the site information using the data structure and methods of representing the data for use in the preferred implementation. In the preferred implementation, the data associated with the general recipe, the master recipe, and the site information is stored in relational databases that support object embedding and linking (OLE). The methods of inputting, viewing, and editing the data associated with the general and master recipes and the site information are preferably as OLE objects. The OLE objects preferably have underlying tables and data entry screens which are used to create, edit, and display the information in the database by accessing these tables or data entry screens through the OLE objects. The objects used to link to the database preferably conform to the standards defined by the OPC Foundation of Boca Raton, Fla. The Object Linking and Embedding used to create, edit, and display the various recipes and elements (general recipe, master recipe, process stages, unit procedures, process operations, unit operations, process actions, recipe segments, recipe phases, site information, etc.) are preferably compatible with the WINDOWS® operating systems (WINDOWS® 3.x, WINDOWS® 95, WINDOWS® 98, WINDOWS® NT, etc.) by Microsoft Corporation of Redmond, Wash. As described earlier, the batch server 20 preferably has a WINDOWS® NT operating system and includes the WINDOWS® DDE software package, both by Microsoft Corporation, operating on the server. These software packages support the OLE object creation and editing. In addition, the batch server preferably has a relational database software package which supports OLE, such as SQL-Server by Microsoft Corporation, operating on the Server 20. Thus, the server configuration allows for the recipes and their elements to be created, edited, and viewed using OLE objects and OLE software tools.

FIGS. 67 through 82 depict the various screens associated with the preferred recipe authoring application, which preferably is loaded at transaction computer system 6. The recipe authoring application is for creating, editing, and viewing general 44 and master recipes 46 and converting general recipes to master recipes. As was described in detail above, the general recipe 44 preferably is composed of a variety of elements (the header, the formula, the process or procedure, the equipment requirements, and the other information), which are further divided into various subcomponents (process stages, process operations, and process actions). FIG. 67 shows the screen view for the header information of the example general recipe 44. The screen of FIG. 67 provides a brief summary of the name of the general recipe, in this case PRODUCT_C, the description of the recipe, the version or revision control number for the recipe, the author, the date the recipe was last modified, the workflow status of the recipe, and the release date for the recipe.

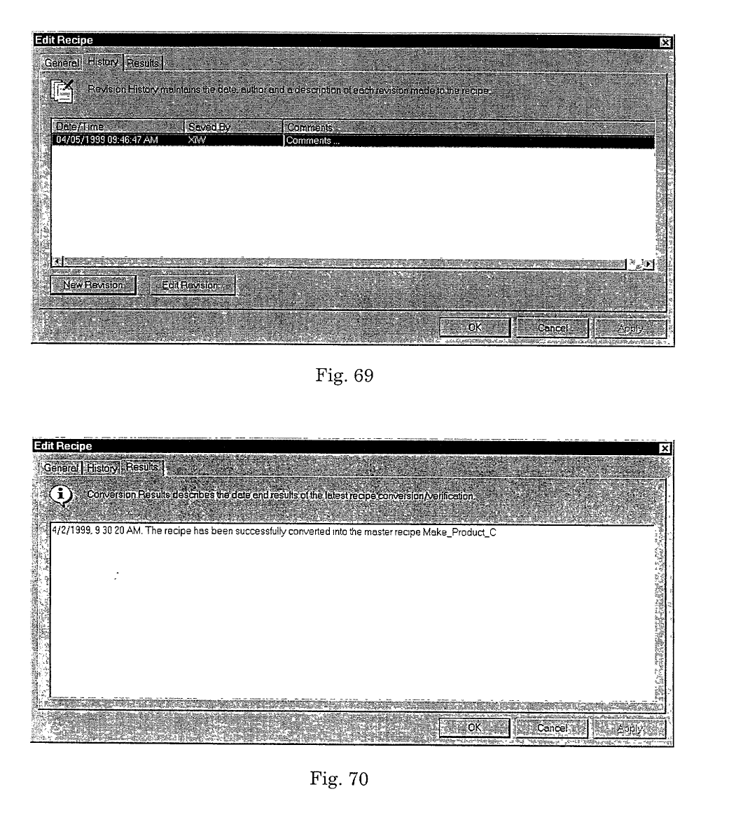

There are several underlying pages or sheets associated with the header information. These underlying sheets are identified as “General”, “History”, and “Results.” FIG. 68 shows the sheet underlying the general tab. A more detailed summary of the information provided in the view of FIG. 67 is provided in the view of FIG. 68. FIG. 69 shows the view associated with the “History” tab. This view provides a summary of all the revision history associated with the general recipe. FIG. 70 shows the view associated with the “Results” tab. This view provides a summary of the history of the recipe conversion process from general to master recipes, including date and time of conversion.

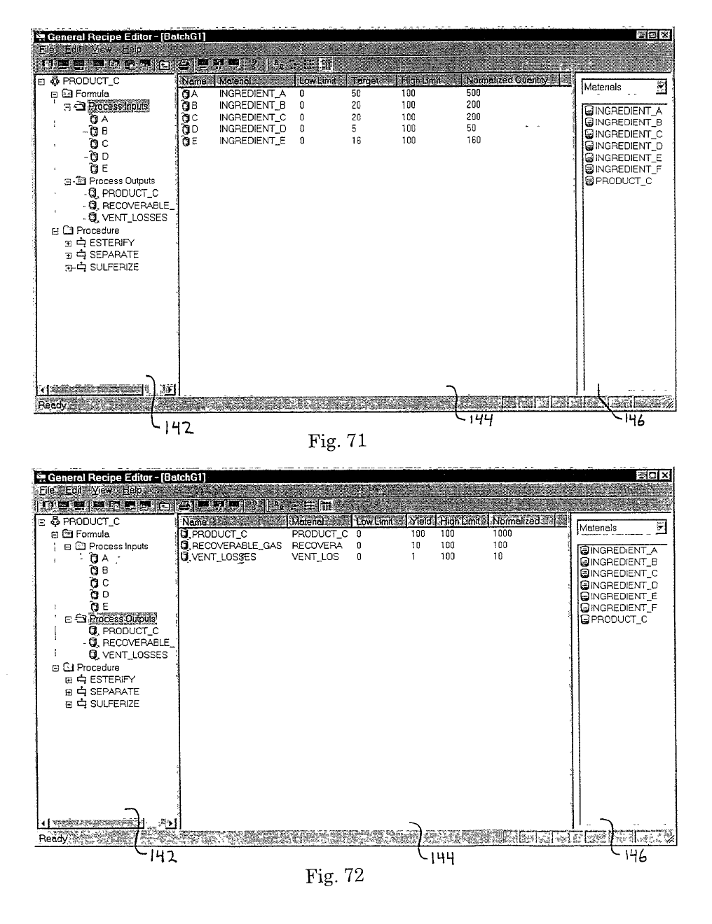

FIG. 71 shows the general recipe editor function of the preferred implementation. The view provided in FIG. 71 is divided into three sections. The left side, or the file folders pane 142, of the view depicts the structure of the recipe in an indented file format. The file folders pane allows the user to select the elements of the recipe he or she wishes to view. The middle pane, or the view pane 144, shows the recipe view elements that are selected in the file folders pane 142. In the case of FIG. 71, the “Process Inputs” file folder underlying the “Formula” file folder in the recipe is selected in the file folders pane. The view displayed in the view pane 144 of FIG. 71 is a summary of the process inputs for the formula. The process inputs include the input materials 74 for the general recipe. The summary includes a list of all the process inputs for the recipe and a summary of the properties associated with the process inputs. The right side of the view, or the tool pane 146, provides a user selectable list of tools associated with the selected view pane 144. The tools are used to create and edit the selected view pane. The list of tools preferably includes Flow Diagrams, Materials, Process Inputs, Process Outputs, and Equipment Properties. Any tool that is useful for creating and editing recipes in the view pane could be included in the list of tools. In the case of FIG. 71, the tools provided are a list of materials available to edit the process inputs for the formula.

FIG. 72 shows the recipe editor with the “Process Outputs” file of the formula selected in the file folders pane 142 of the editor. The view pane 144 shows a summary of the products 72 created by the recipe. The tools provided in the tool pane 146 are a list of the materials available to edit the process outputs file of the formula.

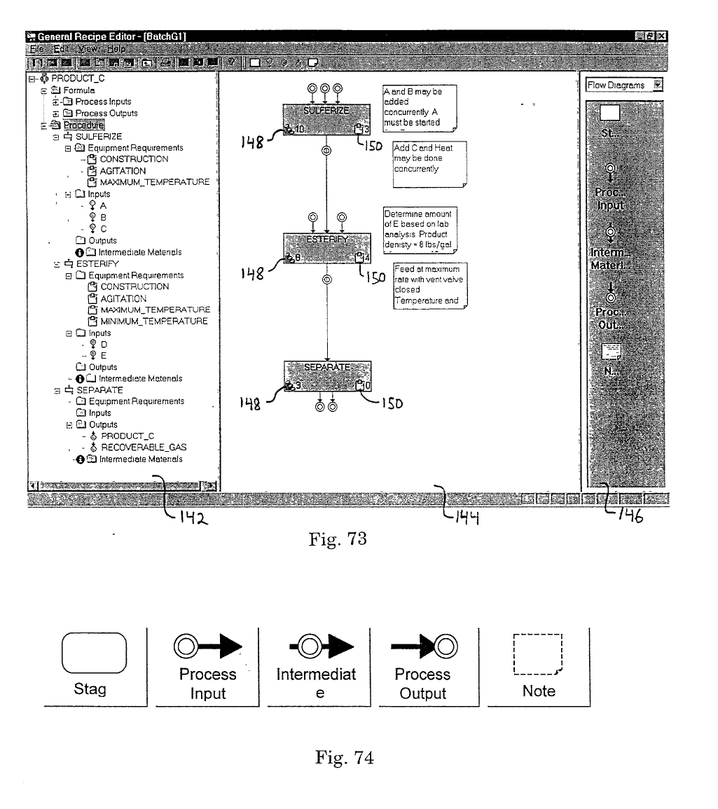

FIG. 73 shows the recipe editor with the “Procedure” file folder of the general recipe selected in the file folders pane 142 of the editor. The view pane 144 depicts the general recipe 44 depicted as a process dependency chart at the highest level, the process stage level. Again, refer to Appendix 2 for a detailed description of how to read a process dependency chart. In this case, the process stages 58 are depicted as blocks in the chart. The tools provided in the tool pane 146 are the symbols for the various types of elements of the process dependency chart, namely the process stages 58, the process input materials 74, the process intermediate materials, the process outputs or products 72, and user defined text notes for documenting additional information associated with the general recipe 44. FIG. 74 provides a clear view of the tools from the tool pane 146 of FIG. 73. These tools are provided to assist the user in creating and editing the general recipe 44 in the view pane 144. The user may select these tools to add their corresponding features to the recipe in the view pane 144.

In the case of this example, the general recipe 44 depicted in FIG. 73 includes three process stages 58, “Sulfurize,” “Esterify,” and “Separate.” The block depictions of the process stages include a step icon 148 located in the lower left hand corner of each process stage block. The step icon identifies the number of steps, including the process actions 62, that are in the process stage underlying the process stage block. As can be seen in FIG. 73, the Sulfurize stage includes 10 steps, the Esterify stage includes 8 steps, and the Separate stage includes 3 steps. The icon in the lower right hand corner of each process stage is the equipment requirements icon 150. This icon displays the number of equipment requirements that are associated with the process stage underlying the process stage block.

FIG. 75 shows the view with the “Sulfurize” file folder under the “Procedure” file selected in the file folders pane 142. The view pane 144 depicts the process for the Sulfurize stage. The view in the view pane 144 for the stage shows the procedure or process of the stage in a tabular format, called a Process Sequence Table, in accordance with Appendix 2. The table is broken up into a group of columns. The left most column is the index number associated 152 with steps and elements of the procedure. Not all of the index numbers are actual steps. They can be position holders for process tags such as the name of a process operation 60 beginning at that tag, or the identification of an intermediate material. Index numbers 1, 6, and 10 in FIG. 75 are index numbers that do not correspond with actual process steps or process actions for the Sulfurize stage. The balance of the index numbers are associated with actual steps for the stage. The order symbols 154 provided in the column labeled “Order” identify what steps or index numbers are to be performed in parallel, when to start parallels, and when to finish parallels. The path number 156 identifies which path of a parallel a particular index number 152 is associated with. These columns taken together define the structure of parallels. They follow the process dependency chart guidelines provided in Appendix 2. The action name 158 is provided in the column labeled “Action.” The action name may be the name of the process action 62 associated with an index number, or it may be another identifier such as the name of a process operation 60 beginning at that index number if the index number is not associated with an actual recipe step performing a process action.

The material type 160 of any materials associated with an index number 152 is provided. The type is represented by one of the symbols proved in FIG. 74 for input material 74, intermediate material, or output material (product) 72. The formula identifier 162 for materials associated with an index number is provided in the column labeled “Formula.” This identifier is typically a general or common identifier. The actual material identification 164 is provided in the column labeled “Material.” This column is generally used to identify the input 74 and product 72 materials with the site specific identification for the material. This identifier is typically the material identifier used by the recipe conversion system. If the material is an intermediate, without a site specific identifier, then this column may be used to provide a description of the material that is useful to a person reviewing or using the recipe. An example of this situation is provided in index 10 of FIG. 75, where the intermediate material is identified as “Sulfurized.” Additional columns are provided to summarize index number information 166 associated with an index number, such as engineering units, set points, and the like.

The tool pane 146 of the view of FIG. 75 provides the process actions 62 available for editing the procedure of the process stage 58. It should be noted that the tool pane of the recipe editor includes a drop down list of tool panes that may be changed by the user for convenience in creating and editing the recipes.

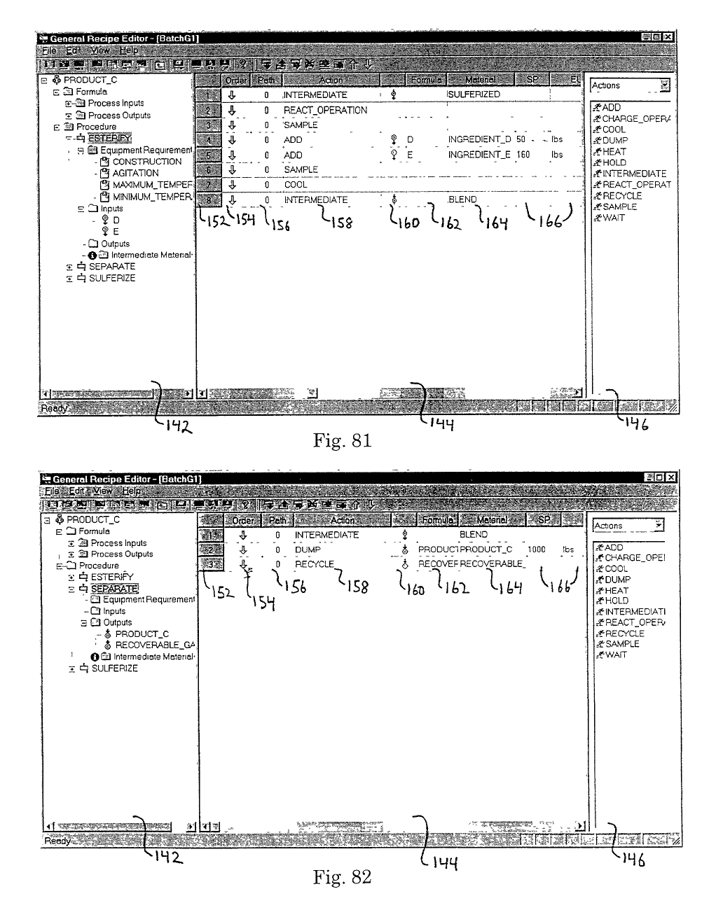

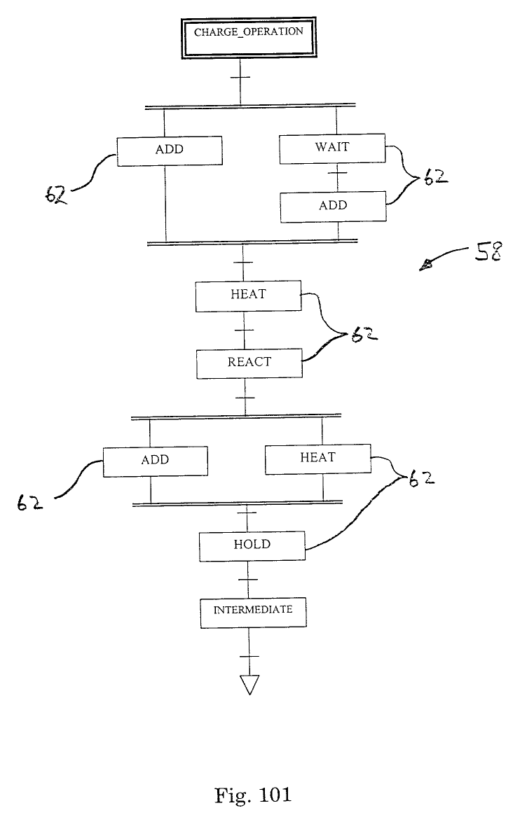

An alternate preferred method of representing the details of the process stages 58 of the general recipe 44 is the use of a graphical format such as a Sequence Function Chart (SFC). The interpretation of an SFC is essentially the same as the interpretation of a PFC. See Appendix 1 for the interpretation of an SFC. When SFC format is used to depict the elements of a general recipe 44, the blocks or steps of the SFC represent the process actions 62 of the recipe. The lines indicate the flow (direction and order) or sequence of operations in the recipe. Users may also optionally configure transition or logic conditions for process actions. In this manner, the start or completion of a process action may be made conditional. The conditions must be met before a process action 62 is executed or before a process action is completed. Such transition conditions are similar in use and format to those depicted for the unit start recipe segment of FIG. 51, as described above. An example of the SFC representation for a process stage 58 is shown in FIG. 101. The process stage represented in FIG. 101 is the “Esterify” process stage from the general recipe for this example as depicted in FIG. 73. The tabular representation, or process sequence table representation, for the “Esterify” process stage for this example is shown in FIG. 81.

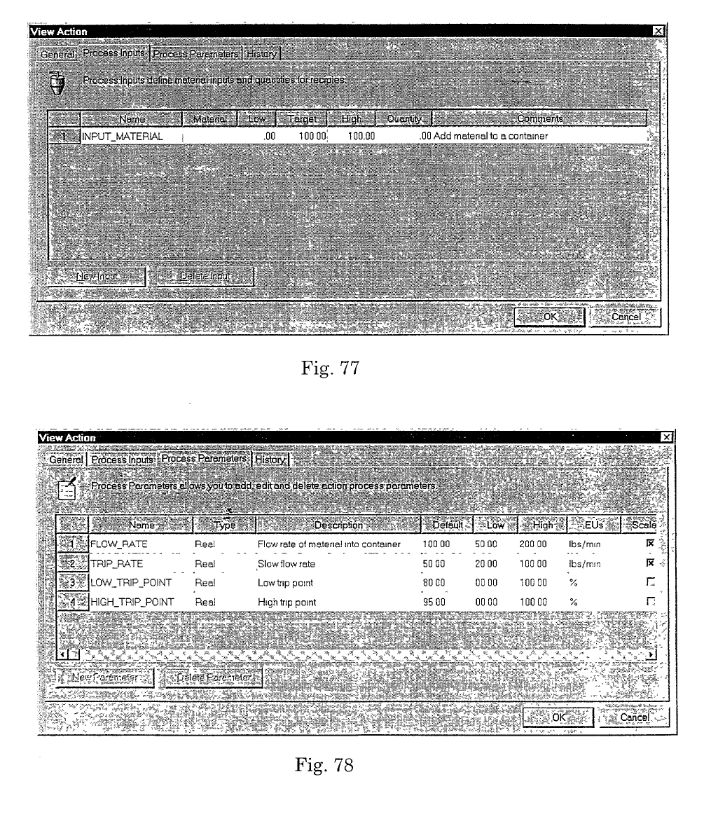

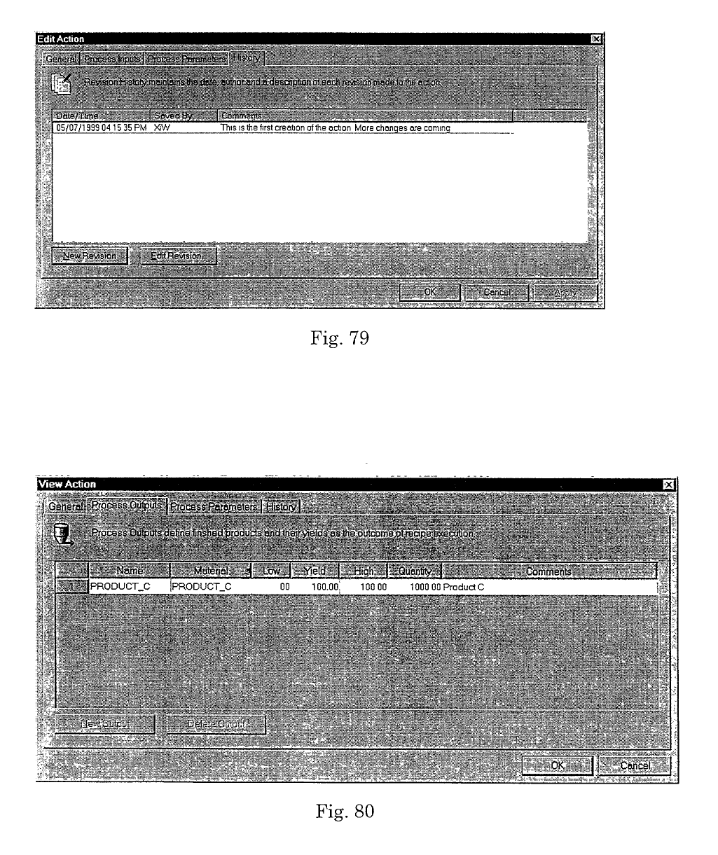

FIGS. 76 through 79 provide the underlying properties pages or sheets associated with the process action “ADD” from the process action list in the tool pane 146 of FIG. 75. The properties associated with the process action include a general sheet which has the name of the process action, its version, its description, and other general information associated with the process action. The sheet underlying the general tab is shown in FIG. 76. FIG. 77 shows the sheet underlying the process inputs tab for the same process action. This tab defines specific details associated with the input material. In the case it defines the material, the amount of material (high, low, and target), and scaling factors. FIG. 78 shows the sheet underlying the Process Parameters tab for the process action. This sheet defines the detailed parameters associated with the action. In this case, flow rates and alarm trip points. FIG. 79 shows the screen underlying the History tab for the process action. This screen provides the revision history for the process action. FIG. 79 shows the same process action properties sheets associated with a material discharge process action. In this case, the process inputs tab becomes a process outputs tab because the action is discharging one of the products from the process. The process outputs sheet underlying the process outputs tab for the discharge process action is shown in FIG. 80. The sheet is similar to the process inputs sheet shown in FIG. 77, except the information provided includes the product yield information for the process. The sheets underlying the other tabs for this process action are similar to those provided in FIGS. 76, 78, and 79.

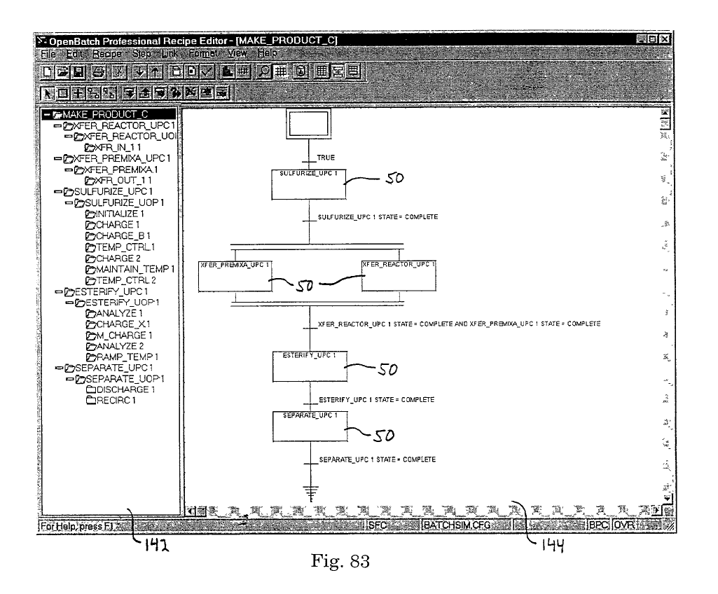

FIGS. 81 and 82 show the procedure associated with the “Esterify” and the “Separate” process stages, respectively. These tabular procedures are displayed in the viewed pane of the recipe editor when the “Esterify” or the “Separate” files folders are selected in the file folders pane. These views have the same structure as the view of FIG. 76.

FIGS. 83 through 88 illustrate the master recipe 46 that was created from the general recipe 44 provided in FIGS. 67 through 82. The master recipe is shown in the preferred PFC format conforming to ISA S88.02 and Appendix 1. The views shown in these figures utilize the presently preferred process control application RSBATCH™ by Rockwell Automation to display the master recipe.

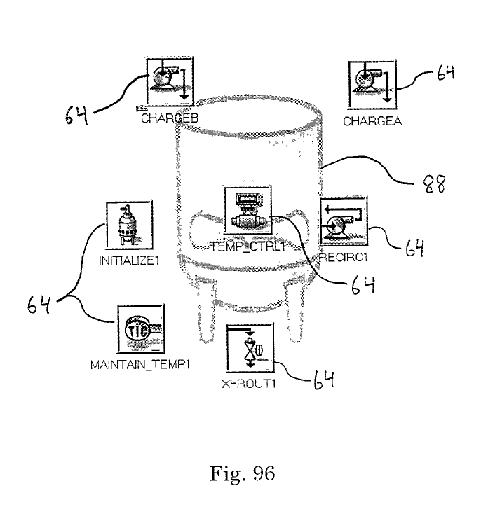

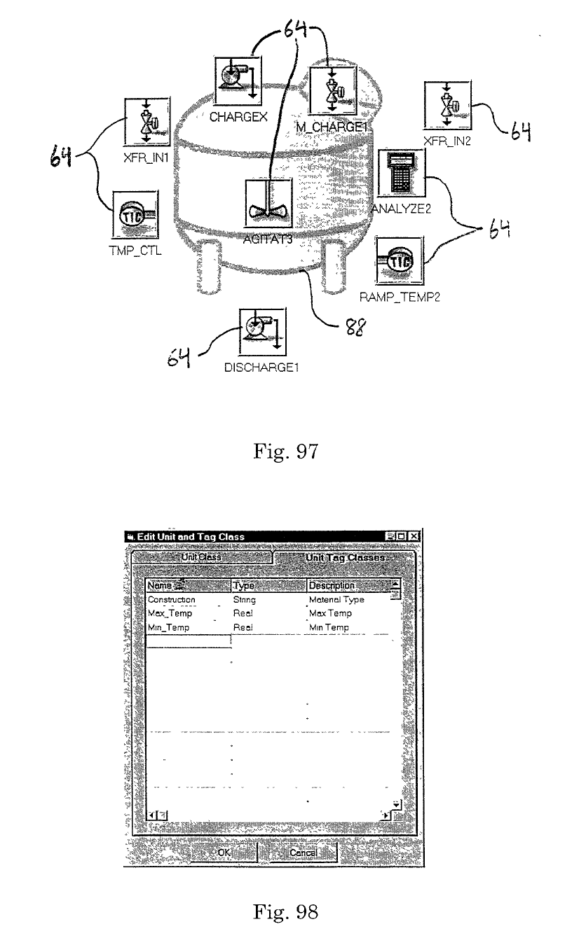

FIG. 83 depicts the master recipe 46 at its highest level displaying only the unit procedures 50 and the manufacturing sequence required to create the master recipe from the unit procedures. Similar to the view screens for the General Recipe Editor, the Professional Recipe Editor for RSBATCH™ includes a file folders pane 142 for selecting the file folder to view and edit and a view pane 144 for viewing the selected file folder. In FIG. 83, the procedure file folder for the master recipe, “Make_Product_C” is selected in the file folders pane. The master recipe associated with Make_Product_C is displayed in the view pane. The master recipe shown in FIG. 83 includes unit procedures 50 corresponding to the process stages 58 of the general recipe as shown in FIG. 73. The unit procedure “Sulfurize_UPC:1” corresponds to the process stage “Sulfurize.” The unit procedure “Esterify_UPC:1” corresponds to the process stage “Esterify” and the unit procedure “Separate_UPC:1” corresponds to the process stage “Separate.” The process cell configuration for this example is provided in FIG. 95. The cell 14 includes three units, “Premix_A,” Premix_B,” and “Reactor_{—}1.” The master recipe of FIG. 83 uses the units Premix_A and Reactor_{—}1 to perform the recipe. The recipe segments 64 available in the unit “Premix_A” are shown in FIG. 96 and the recipe segments available in the unit “Reactor_{—}1” are shown in FIG. 97. The master recipe 46 depicted in FIG. 83 includes two material transfer procedures, one corresponding to the “transfer from” recipe segment for unit “Premix A” and the other corresponding to the “transfer to” recipe segment for unit “Reactor_{—}1.” As discussed above, these recipe segments correspond to equipment specific recipe segments that do not have corresponding process actions 62 in the general recipe 44. In the case shown in FIG. 83, the transfer recipe segments occur in parallel with one another, but these recipe segments do not have corresponding unit procedures 50 occurring in parallel.

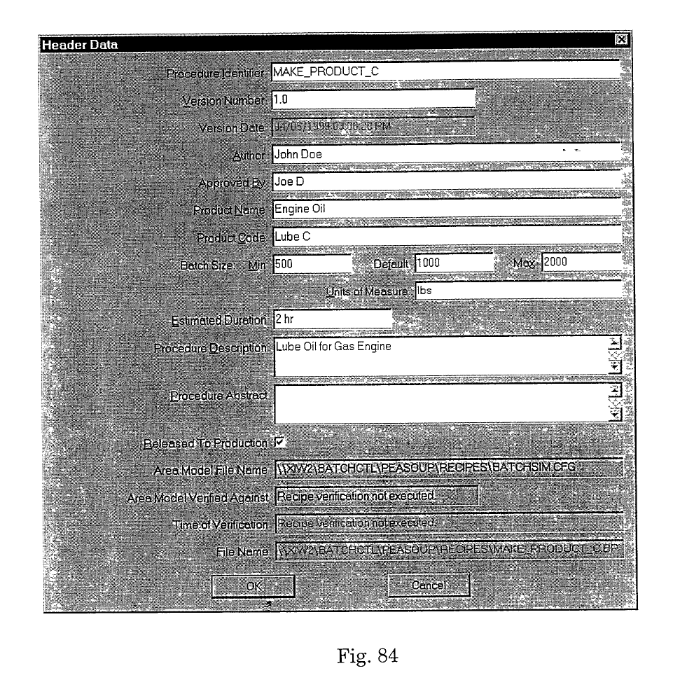

Similar to the general recipe of FIGS. 67 through 82, the master recipe has header information as shown in the view of FIG. 84. The header information includes the procedure name or identifier, the version and version date, the author, approval information, product name and code, batch size, and other general information pertinent to the master recipe 46.

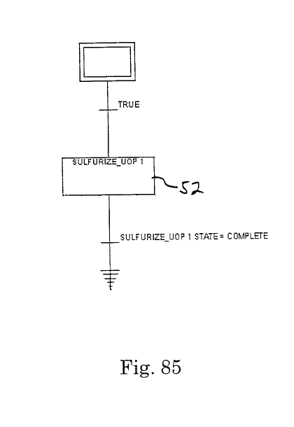

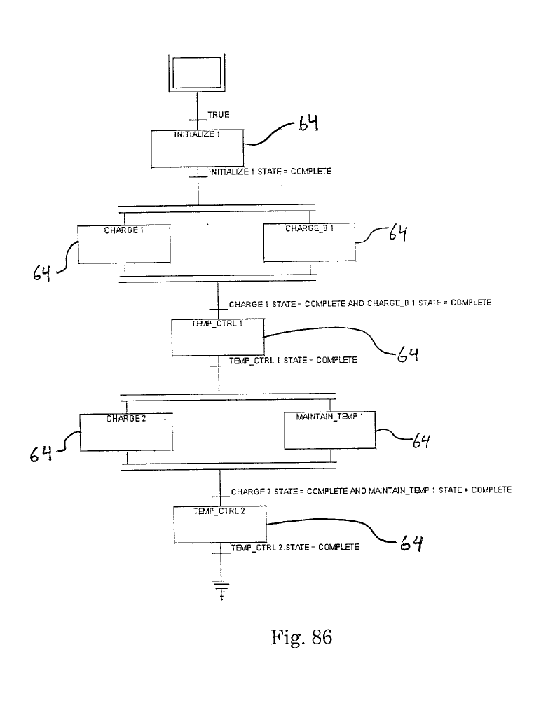

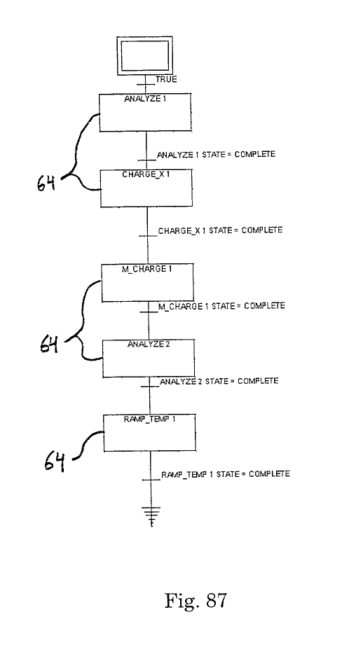

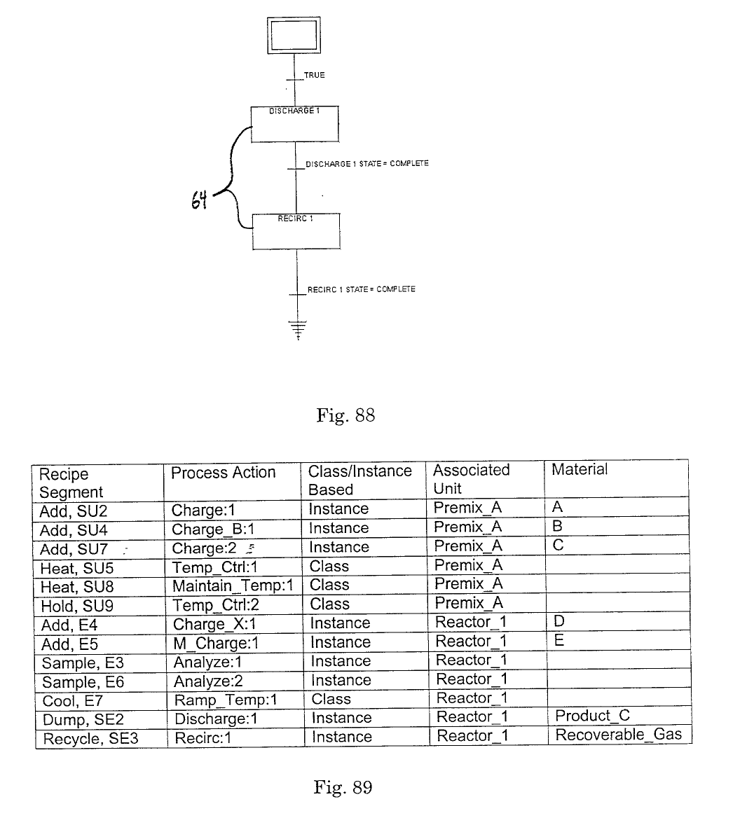

FIG. 85 depicts the “Sulfurize_UOP:1” unit operation, which is the only unit operation 52 underlying the “Sulfurize_UPC:1” unit procedure 50, and FIG. 86 depicts the detailed procedure for the sulfurize unit procedure in PFC format. FIG. 87 depicts the detailed procedure for the esterify unit procedure in PFC format and FIG. 88 depicts the detailed procedure for the separate unit procedure in PFC format. FIG. 89 provides a list of the process actions 62 from the general recipe 44 defined by FIGS. 73, 75, 79, and 82 and the recipe segment 64 for the master recipe 46 that correspond to the process actions of the general recipe. The recipe segments or the master recipe are illustrated in FIGS. 83 and 86-88. FIG. 89 provides each recipe segment for the master recipe of FIG. 83 in the column labeled “Recipe Segment.” The process action from the general recipe of FIG. 73 that is performed by each corresponding recipe segment is given in the row for that recipe segment under the column labeled “Process Action.” The process action 62 is identified by the name or identifier for the process action followed by an abbreviated process stage and index number identifier. The abbreviated process stage and index number identifier comprise one or two character alpha prefix which indicates for the process stage the process action is used in followed by the index number of the process action in the procedure for that stage. The alpha prefix is either “SU” which stands for the “Sulfurize” process stage, “E” which stands for the “Esterify” process stage, or “SE” which stands for the “Separate” process stage. The Prefix “SU2” means that the process action listed in the “Process Action” column of the table in FIG. 89 is used in the general recipe at index number 2 of the process stage “Sulfurize” (for which the procedure is provided in FIG. 75). For example, the process action Add, SU2 listed in the FIG. 89 is used in the general recipe in the “Sulfurize” process stage at index number 2. The corresponding recipe segment which performs that process action in the general recipe is “Charge:1.” This recipe segment is used in the detailed procedure for the unit procedure “Sulfurize_UPC:1” shown in FIG. 86.

It should be noted that each of the recipe segments 64 used in the master recipe 46 includes a recipe segment name, such as “Charge” or “Charge_B”, followed by a colon and a number, for example “Charge:1,” “Charge-B:1.” The numeric suffix following the colon is added to make the recipe segment identifier in the master recipe unique. This is because each recipe segment may be used more than once in the master recipe. For example, the recipe segment “Charge” is used twice in the unit procedure “Sulfurize_UPC:1” depicted in FIG. 86. The first time it is used the recipe segment is identified as “Charge:1” and the second time it is used the recipe segment is identified as “Charge:2,” thus keeping both recipe segment identifications unique.

FIG. 89 also identifies the unit 88 associated with the recipe segments 64 for the master recipe 46. The unit in which a specific recipe segment is performed is listed in the row for that recipe segment under the column labeled “Associated Unit.” If a material is associated with a recipe segment, it is listed in the row for that recipe segment under the column labeled “Material.” The column labeled “Class/Instance Based” identifies whether a particular recipe segment is class based or instance based.

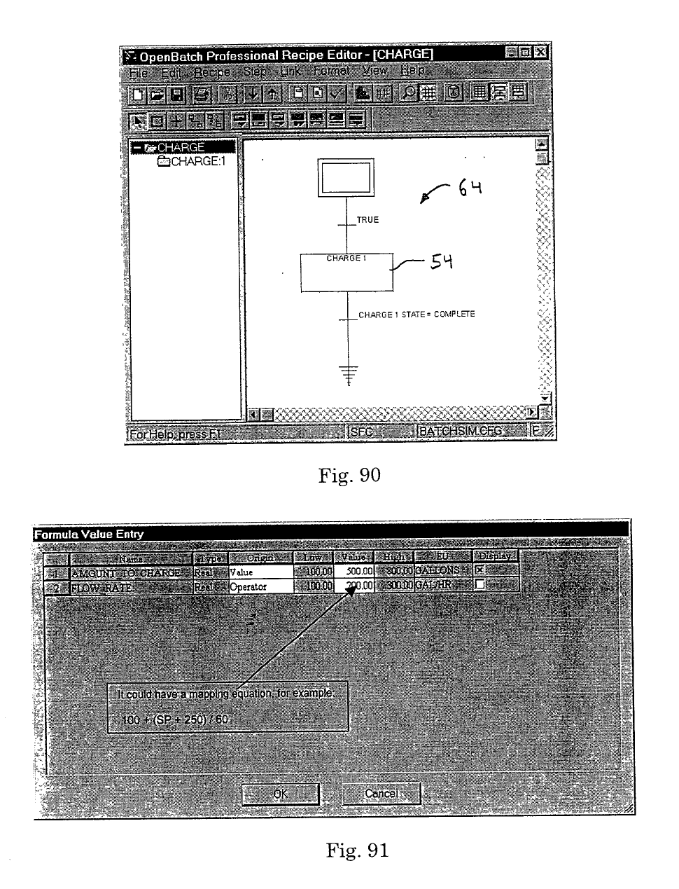

FIG. 90 depicts the RSBATCH™ professional Recipe Editor screen for the recipe segment “Charge” which performs the process action “Add” from the general recipe. In this case, the recipe segment 64 comprises a single recipe phase 54, the recipe phase “Charge:1.” FIG. 91 shows a screen for mapping recipe segments 64 to process actions 62 so that the recipe conversion algorithms know what the process action corresponding to a recipe segment is. The mapping equations include defining how the recipe segment parameters map to the corresponding process action parameters. In the case depicted in FIG. 90 the mapping between a “Charge” recipe segment and an “Add” process action is shown. This screen allows process action parameters to be mapped to the “Amount_to_Charge” and “Flow_Rate” recipe segment parameters. The mapping can be a numerical mapping, such a 100 gallons to 100 gallons or 100 gallons to 378.54 liters or the mapping could be in the form or an equation, such as Amount_to_Charge=Material Volume×Material Density.

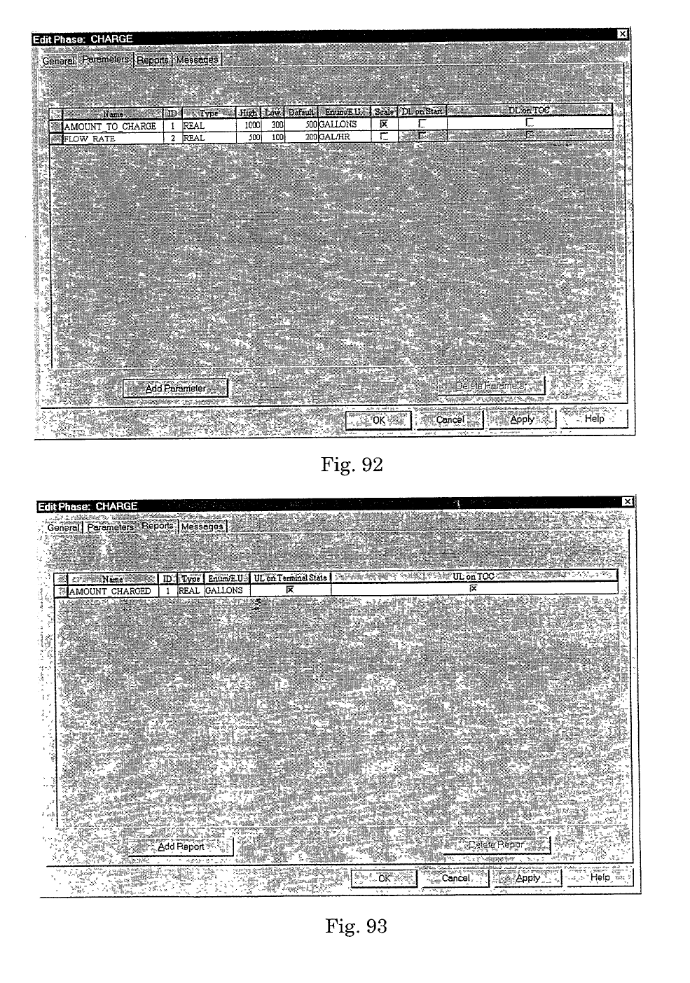

FIGS. 92 through 94 show the various properties pages underlying the recipe phase “Charge:1.” The underlying properties pages include the general sheet, which provides header information, the parameters sheet which provides the parameters associated with the recipe phase 54, and the reports and messages sheets.

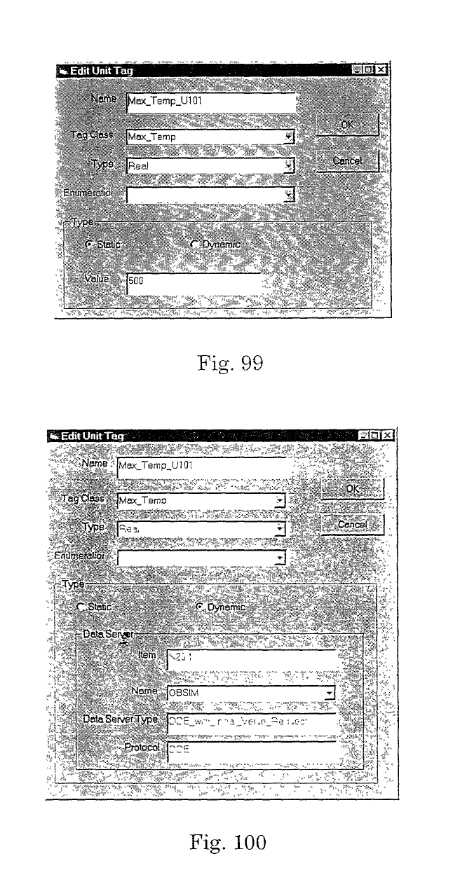

FIGS. 98 through 100 show the various screens for defining and editing the equipment information 86 associated with the units 88 in the process cell 14.

Preferably the method includes the step of analyzing the general recipe for each product brand belonging to each listed product brand owner to create the product brand information. As described above, the general recipe preferably is in the form of a data file. The form of the general recipe for use with the preferred embodiments of the invention is a data file is linked with one or more OLE objects. As described above, the general recipe includes a process, formula, and equipment requirements.

Again, as described above, the preferred form of the general recipe comprises a process dependency chart, a process sequence table, or both. The elements of the process dependency chart for a specific general recipe preferably are OLE objects linked to their corresponding elements of a process sequence table for the same specific general recipe. For example, FIG. 73 depicts the process dependence chart for a general recipe describing the manufacturing process requirements for producing PRODUCT_C. The general recipe includes three process stages, “Sulfurize”, “Esterfy”, and “Separate”. The process dependency chart shown in FIG. 73 displays these three elements. These elements are liked to their corresponding process sequence table elements, which are the process sequence table representations of the three process stages. The process sequence tables for each of these process stages are shown in FIGS. 75, 81, and 82. FIG. 75 is the process sequence table for the process stage “Sulfurize”, FIG. 81 is the process sequence table for the process stage “Esterfy,” and FIG. 82 is the process sequence table for the process stage “Separate”.

The general recipe preferably comprises the same functional elements as described above—process stages, process operations, and process actions, the process actions corresponding to the lowest fundamental element of the general recipe. Again, as described above, each process action has one or more corresponding recipe segments for performing that process action in a process cell.

The process stages and process operations are higher level elements of the general recipe. Generally, the process stages are general recipe elements often unique to a specific general. For example, the process stages “Sulfurize”, “Esterfy”, and “Separate”, included in the general recipe shown in FIG. 73 are somewhat unique to the general recipe for manufacturing PRODUCT_C. They include a very specific set of instructions. Another general recipe may have process stages with the same name, but the details of their procedure or process may be significantly different. The title, or name of the process stages does provide some information on the manufacturing process requirements for a specific general recipe and product brand. The name “Esterfy” for the second process stage of the general recipe depicted in FIG. 73 indicates that the manufacturing process requirements for the product brand PRODUCT_C will require reactors capable of performing esterfication reactions. Considering these reactions usually involve strong acids and acid anhydrides, this has very specific implication for the manufacturing equipment. It also can have strong implications relative to the hazard classification of the materials a manufacturing organization must be capable of handling.

This same argument can be made for the process operations. The details of each process operation in each general recipe generally dictate that one specific process operation contained in one specific general recipe is not necessarily the same as another process operation contained in another general recipe, even if both process operations have the same tile or name. Again, the process operation title can provide some insight into the manufacturing process requirements for a specific general recipe or product brand. For example, a process operation titled “Distill” implies that the manufacturing process requirements for a general recipe including this process operation include the capability to distill a material. The distillation parameters, such as temperatures, and pressures, however, may vary substantially from one distillation operation to another. Generally, though, any manufacturing organization intending to produce this product brand will need to have distillation equipment such as distillation towers.

In the preferred implementation, the manufacturing organization information comprises the process stages each manufacturing organization is capable of performing. The process stages required by the general recipe for a specific product brand are compared to the manufacturing organization information to determine which manufacturing organizations can perform the process stages required by the general recipe. The manufacturing organizations that are capable of performing the process stages of the general recipe, i.e., candidate manufacturing organizations, are then included in the selected members of the manufacturing community.

It has been noted herein that the manufacturing information preferably comprises the process operations each manufacturing organization is capable of performing. The preferred implementation compares the process operations required by the general recipe for a specific product brand to the manufacturing organization information to determine which manufacturing organizations can perform the process operations required by the general recipe. The manufacturing organizations that are capable of performing the process operations of the general recipe are then included in the candidate or selected members of the manufacturing community.

In accordance with the system and method aspects of the invention, the transactional computer system generates selection information regarding the at least one candidate manufacturing organizations, and communicates the selection information to the product brand manager where the selection is being made for the benefit of the product brand manager, or to the manufacturing organization where the selection is made for the benefit of a manufacturing organization. The selection information communicated to the selecting party can be and preferably is only a part of the information actually used in the selection. It would not be unusual for a substantial amount of information to be used in the selection process, for example, as in the examples above regarding general recipes and master recipes, but for only a small portion of that information to be forwarded to the selecting party when the selection processing is completed.

The selection information as the term is used herein is used broadly to comprise any information that may be used to select one or more manufacturing organizations or one or more product brand managers according to selection criteria, and/or any information that reveals or reflects such selection.

The selection criteria will depend on the particular application and circumstances. As an example, when a product brand manager seeks to identify and enlist a manufacturing organization to manufacture a product brand, the selection criteria may comprise any of the product brand information outlined above, for example, such as the product brand, the required manufacturing processes, the delivery time and location, cost, etc., which comprises or relates to the needs, requirements or criteria of the product brand manager in determining which manufacturing organizations may be qualified candidates for the project. The selection information also preferably comprises the manufacturing organization information used in the selection process, e.g., in comparing the needs or requirements of the product brand manager with the capabilities of the manufacturing organization or organizations.

Similarly, where a manufacturing organization seeks the business of a product brand manager, the selection criteria may comprise manufacturing organization information such as that outlined above. This typically would comprise the location of the plant, site, process cell, etc., sought to be utilized, the associated equipment models, the types of products and/or processing the manufacturing organization is qualified to manufacture, scheduling information for the manufacturing organization, prices or pricing information, raw materials availability, etc. These factors generally relate to the needs or requirements of the manufacturing organization in making its selection of candidate product brand managers. The selection information also preferably would comprise the product brand information useful for comparing the needs, requirements, capabilities, etc. of the manufacturing organization with the needs, requirements, interests, etc. of the product brand managers.

The selection information also may comprise information generated in or obtained from the selection process, for example, which identifies the candidate party or parties and information regarding the candidate party or parties that can be forwarded to the selecting party or parties to describe the candidate party or parties.

In the preferred implementation, the selection process may take a number of forms, even after the candidate manufacturing organizations or candidate product brand managers have been screened or limited to a select set. The selection of the at least one candidate manufacturing organization, for example, selection may comprise assessing the extent to which each of the manufacturing organizations matches the product brand information and assigning to each of the manufacturing organizations a score. The selection information thus also may comprise a threshold value or score. Selection then may be made of each of the at least one candidate manufacturing organizations for which the score is above the threshold value. The selection also may be made by including within the at least one candidate manufacturing organizations a predetermined number of the manufacturing organizations having the highest of the scores.

The at least one candidate manufacturing organization selection similarly may comprise assessing the extent to which each of the manufacturing organizations matches the product brand information and assigning to each of the manufacturing organizations a rank, and including within the selection information each of the at least one candidate manufacturing organizations in order of the rank.

In similar manner, the at least one candidate manufacturing organization selection may comprise assessing the extent to which each of the manufacturing organizations matches the product brand information using a weighted set of selection criteria. The weighted criteria may comprise, for example, selected ones or even all of the selection criteria, and for each such criteria a weighting factor, such as a multiplier, reflecting the importance or significance of that factor to the overall selection process.

The rankings as applied, for example, to the selection of manufacturing organizations, could be in the form of a single numerical ranking, for example, a ranking on a scale of 0 to 100. A manufacturing organization with a 0 ranking, for example, would correspond to a manufacturing organization that is incapable of producing the product brand, whereas a manufacturing organization with a 100 ranking would correspond to a manufacturing organization with the best capability to manufacture the product brand. In this case, the higher the ranking between 0 and 100,the better the capability of the manufacturing organization to manufacture the product brand according to the product brand manager's criteria or requirements.

Alternately, the manufacturing organization rankings could be in the form of a group of values, each value representing a different criterion for evaluating the manufacturing organization's capability to produce the product brand. For example, the first value could represent the manufacturing organization's equipment related capabilities, the second value may represent the manufacturing organization's cost factor, the third value may represent the manufacturing organization's capacity capabilities, the fourth factor may represent the manufacturing organization's lead time and schedule performance, etc. A manufacturing organization ranking scheme of this variety allows a product brand owner to evaluate a manufacturing organization's suitability to manufacture a product brand from a number of perspectives. A manufacturing organization that has the right equipment to manufacture the product brand may not have the capacity to manufacture the required quantities or it may not meet the pricing requirements for the product brand representing, etc. Other methods of ranking the manufacturing organization's capability to manufacture the product brands can be used.

Once the selection processing is completed, or as it is completed, the transactional computer system is used to communicate the selection information to the selecting party. As noted above, the selection information thus communicated preferably comprises only a portion of the selection information used in the selection processing.

The selection information thus communicated may be any form of information identifying one or more of the candidate and possibly preferred manufacturing organizations for the selected product brand, preferably in addition to selection information such as scoring, ranking, etc.

Where the selecting party is a product brand manager, for example, the selection information may comprise the names and contact information for the candidate manufacturing organizations selected in the selection process. It also may comprise information about each of the candidate manufacturing organizations, such as their plant location, pricing information, availability, prior experience in the related field or with products of the type involved, etc. The selection criteria, for example, also may comprise information sufficient to confirm that the at least one candidate manufacturing organization can manufacture the product brand according to the product brand information, but the selection information may exclude information sufficient to identify the at least one candidate manufacturing organization. In a general sense, where a product brand manager seeks a manufacturing organization, the selection information generally may comprise any information useful to the product brand manager in making this selection or evaluating the candidates. It may comprise, for example, price information.

Where the selecting party is a manufacturing organization, the selection information may comprise the names and contact information for the candidate product brand managers, the product brands or product types involved, typical volumes or quantities, scheduling information, pricing information, etc.

The selection information communicated to the selecting party may be quite limited, it may be quite detailed, or anything in between. Initially, for example, it may consist only of the number of candidate parties, e.g., the number of manufacturing organizations that meet the product brand manager's requirements. The information also may comprise the general geographic region in which the candidate manufacturers are found, or other information that may be helpful to the selecting party but not reveal the identities of the specific candidate parties.

The selection information may comprise public selection information and/or private selection information. Public selection information comprises selection information that is publicly available, or at least not confidential or private. Private selection information comprises selection information that is confidential or otherwise not generally available. The communication of the selection information according to the preferred implementation comprises communicating the public selection information to the product brand manager and withholding the private selection information from the product brand manager. Where it is a manufacturing organization that is seeking a product brand manufacturer, the public selection information may be communicated to the manufacturing organization, whereas the private selection information preferably is not. The preferred implementation also may incorporate a feature in which one of the criteria for disclosure of certain selection information is whether the intended recipient, e.g., the selecting party, has executed and returned an appropriate contract document ensuring the confidentiality and non-use or limited use of the candidate party's private information.

In the preferred implementation, the public selection information or a portion thereof is communicated to the product brand manager by communicating this selection information, preferably comprising the candidate manufacturing organization or organizations, to the product brand manager computer accessible by the product brand manager. In the event the selection is made for a manufacturing organization, the selection information or the appropriate portion or portions of it are communicated to the manufacturing organization via its manufacturing organization computer. This preferably is done with little or no human intervention.

The communication may be an e-mail to the selected product brand owner or one or more of the preferred manufacturing organizations, it may be a response to a query initiated by the selected product brand owner, or any other electronic communication. It may identify the selected product brand owner or the preferred manufacturing organizations, or it may simply identify that a match has been found. For example, contract manufacturing organizations may prefer to remain anonymous until they have reviewed the situation. A communication information the preferred manufacturing organizations that they were identified as a match for manufacturing a product brand may be sent first. This would allow the preferred manufacturing organizations to determine if they have an interest in manufacturing the product brand before their identity is disclosed to the product brand owner. The preferred manufacturing organizations preferably are provided the opportunity to confirm their interest to the computer system anonymously. Preferably, the preferred manufacturing organizations are also provided the opportunity to request additional information regarding the product brand owner and the product brand while still remaining anonymous. This allows the preferred manufacturing organizations to evaluate the opportunity in detail while remaining in anonymity. Once a preferred manufacturing organization determines it is interested in contacting the product brand owner, one or both of the parties will be informed of the identity of the other party.

In the preferred implementation, the selection information to be communicated to the product brand manager and/or the manufacturing organization is communicated via network 4 or otherwise remotely, e.g., electronically, optically, etc. as a data signal or like means. The communication of the selection information may comprise any form of information transfer that uses the computer system to transfer the information from one party to another. For example, the information may be transferred over the a public network such as the World Wide Web, or via e-mail. The information may be transferred by modem, network, by radio wave communication such as satellite, etc. The actual method of transferring the information between parties may be any method capable of transferring information between computers, for example wire or fiber optical connections such as telephone lines or cable lines, wireless connections such as radio waves, etc. In the preferred implementation, the selection information is communicated via network 4.

The specific nature of the transaction, and the specific relationship between the parties, such as the product brand manager or managers and the manufacturing organization or organizations, is not necessarily limiting. The product brand manager and a particular manufacturing organization may have other relationships or roles. The manufacturing organization, for example, may be enlisted not only to manufacture or process the product brand, but to market or distribute it as well. The invention accordingly is not necessarily limited to the contract manufacturing role specifically identified in connection with the preferred implementation.

It has been noted that the selecting party may comprise a product brand manager, or it may comprise a manufacturing organization. Although many of the principles, features and illustrative examples have been in the context of a product brand manager seeking to select one or more manufacturing organizations, it will be understood from the description herein that these principles, features and examples are equally applicable to a context in which a manufacturing organization seeks to select one or more product brands and/or product brand managers.

It has been noted herein that the system and method according to the various aspects of the invention preferably are carried out with little or no human intervention at the transactional computer system level. Human intervention preferably is only used to confirm an action, such as to confirm that a message should be sent to a candidate party alerting that party that a proposal is being or has been forwarded for consideration regarding the transaction, or to a selecting party informing it of the selection information. Even this extent of human intervention can be eliminated and the process fully automated, for example, if the selecting party sets an option specifying automatic delivery of such messages. Human intervention may, and preferably is, limited to monitoring traffic on the transactional system computer and administering it from a maintenance standpoint, and possibly to monitor and occasionally become involved in data conversion options, setting selection criteria, and the like.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

[image]

[image]

[image]

[image]

[image]

[image]

[image]

[image]

[image]

[image]

[image]

[image]

[image]

What is claimed is:

1. A method for facilitating transactions between a product brand manager and manufacturing organizations using a transactional computer system, the product brand manager having a product brand and product brand information comprising information for manufacturing the product brand, and there being manufacturing organization information for each of the manufacturing organizations comprising the manufacturing process capabilities of the respective manufacturing organization, the method comprising:
communicating the product brand information from the product brand manager to the transactional computer system;
communicating the manufacturing organization information for the manufacturing organizations from the manufacturing organizations to the transactional computer system;
using the transactional computer system to process the product brand information and the manufacturing organization information to select at least one candidate manufacturing organization from the manufacturing organizations and to generate selection information regarding the at least one candidate manufacturing organization, the selection comprising using the transactional computer system to compare the product brand information to the manufacturing organization information; and
using the transactional computer system to communicate the selection information to the product brand manager.

2. A method as recited in claim 1, wherein the communicating of the product brand information from the product brand manager to the transactional computer system is performed without human intervention at the transactional computer system.

3. A method as recited in claim 1, wherein the communicating of the manufacturing organization information for the manufacturing organizations from the manufacturing organizations to the transactional computer system is performed without human intervention at the transactional computer system.

4. A method as recited in claim 1, wherein the using of the transactional computer system to process the product brand information and the manufacturing organization information to select at least one candidate manufacturing organization from the manufacturing organizations and to generate selection information regarding the at least one candidate manufacturing organization is performed without human intervention at the transactional computer system.

5. A method as recited in claim 1, wherein the use of the transactional computer system to compare the product brand information to the manufacturing organization information is performed without human intervention at the transactional computer system.

6. A method as recited in claim 1, wherein the use of the transactional computer system to communicate the selection information to the product brand manager is performed without human intervention at the transactional computer system.

7. A method as recited in claim 1, wherein:
the product brand manager comprises a product brand manager computer; and
the transactional computer system is operatively coupled to the product brand computer to communicate the product brand information from the product brand computer and to communicate the selection information to the product brand computer.

8. A method as recited in claim 1, wherein:
each of the manufacturing organizations comprises a manufacturing organization computer; and
the transactional computer system is operatively coupled to each of the manufacturing organization computers to receive the manufacturing organization information from the manufacturing organization computers.

9. A method as recited in claim 1, wherein:
the product brand manager comprises a product brand manager computer;
each of the manufacturing organizations comprises a manufacturing organization computer;
the transactional computer system is operatively coupled to the product brand computer to communicate the product brand information from the product brand computer and to communicate the selection information to the product brand computer; and
the transactional computer system is operatively coupled to each of the manufacturing organization computers to receive the manufacturing organization information from the manufacturing organization computers.

10. A method as recited in claim 9, wherein the transactional computer system receives the product brand information and the manufacturing organization information from the product brand manager computer and the manufacturing organization computer respectively without human intervention at the transactional computer system and automatically selects the at least one candidate manufacturing organization without human intervention at the transactional computer system.

11. A method as recited in claim 10, wherein the transactional computer system generates the selection information without human intervention.

12. A method as recited in claim 10, wherein the transactional computer system communicates the selection information to the product brand manager without human intervention.

13. A method as recited in claim 1, wherein the transactional computer system comprises at least one computer operatively coupled to a network.

14. A method as recited in claim 13, wherein the transactional computer system comprises a plurality of computers and a distributed database.

15. A method as recited in claim 1, wherein the transactional computer system comprises a local area network.

16. A method as recited in claim 1, wherein the transactional computer system comprises a wide area network.

17. A method as recited in claim 1, wherein the product brand manager comprises an owner of the product brand.

18. A method as recited in claim 1, wherein the product brand manager comprises a product development organization.

19. A method as recited in claim 1, wherein the product brand comprises a material manufactured by a batch chemical process.

20. A method as recited in claim 1, wherein the product brand information communication comprises communicating the product brand information to comprise a general recipe.

21. A method as recited in claim 1, wherein the product brand information communication comprises communicating the product brand information to comprise pricing information.

22. A method as recited in claim 1, wherein the product brand information communication comprises communicating the product brand information to comprise schedule information.

23. A method as recited in claim 1, wherein the product brand information communication comprises communicating the product brand information to comprise delivery information.

24. A method as recited in claim 1, wherein the product brand information communication comprises communicating the product brand information to comprise quality information.

25. A method as recited in claim 1, wherein the product brand information communicating comprises communicating the product brand information in a general recipe format.

26. A method as recited in claim 1, wherein the product brand information communicating comprises communicating the product brand information in a normalized format.

27. A method as recited in claim 1, wherein the manufacturing organizations comprise contract manufacturing organizations.

28. A method as recited in claim 1, wherein each of the manufacturing organizations comprises a site.

29. A method as recited in claim 1, wherein each of the manufacturing organizations comprises an area.

30. A method as recited in claim 1, wherein each of the manufacturing organizations comprises a process cell.

31. A method as recited in claim 1, wherein the manufacturing organization information comprises site information.

32. A method as recited in claim 1, wherein the manufacturing organization information comprises area information.

33. A method as recited in claim 1, wherein the manufacturing organization information comprises process cell information.

34. A method as recited in claim 1, wherein the manufacturing organization information comprises equipment information.

35. A method as recited in claim 1, wherein the manufacturing organization information comprises flow information.

36. A method as recited in claim 1, wherein the manufacturing organization information comprises scheduling information.

37. A method as recited in claim 1, wherein the manufacturing organization information comprises price information.

38. A method as recited in claim 1, wherein the manufacturing organization information comprises delivery information.

39. A method as recited in claim 1, wherein the manufacturing organization information comprises capacity information.

40. A method as recited in claim 1, wherein the manufacturing organization information comprises plant location information.

41. A method as recited in claim 1, wherein:
each of the manufacturing organizations is capable of manufacturing a product; and
the manufacturing organization information for each of the manufacturing organizations comprises the product for the manufacturing organization.

42. A method as recited in claim 1, wherein:
each of the manufacturing organizations is capable of manufacturing a product within at least one product classification; and
the manufacturing organization information for each of the manufacturing organizations comprises the at least one product classification for the manufacturing organization.

43. A method as recited in claim 1, wherein the manufacturing organization information communicating comprises communicating the manufacturing organization information in a normalized format.

44. A method as recited in claim 1, further comprising excluding the product brand information from the manufacturing organizations.

45. A method as recited in claim 1, further comprising excluding the manufacturing information from the product brand manager.

46. A method as recited in claim 1, wherein the product brand information communicating comprises communicating the product brand information to comprise a general recipe.

47. A method as recited in claim 46, wherein the processing comprises converting the general recipe to a plurality of master recipes, and comparing the plurality of master recipes to the manufacturing organization information.

48. A method as recited in claim 1, wherein the product brand information processing comprises formatting the product brand information to comprise a general recipe.

49. A method as recited in claim 46, wherein the processing comprises converting the general recipe to a plurality of master recipes, and comparing the plurality of master recipes to the manufacturing organization information.

50. A method as recited in claim 1, wherein the processing comprises providing a normalized set of process parameters, and converting the product brand information to the normalized set of process parameters.

51. A method as recited in claim 1, wherein the manufacturing organization information communication comprises providing a normalized set of process parameters, and providing the manufacturing organization information for each of the manufacturing organizations as the normalized set of process parameters.

52. A method as recited in claim 1, wherein the processing comprises providing a normalized set of process parameters, and converting the manufacturing organization information for each of the manufacturing organizations to the normalized set of process parameters.

53. A method as recited in claim 1, wherein the processing comprises:
providing a normalized set of process parameters;
converting the product brand information to the normalized set of process parameters; and
converting the manufacturing organization information to the normalized set of process parameters.

54. A method as recited in claim 1, wherein the product brand information is stored in a database.

55. A method as recited in claim 1, wherein the product brand information is stored in a distributed database.

56. A method as recited in claim 1, wherein the product brand information is stored in a secure database.

57. A method as recited in claim 1, wherein the manufacturing organization information is stored in a database.

58. A method as recited in claim 1, wherein the manufacturing organization information is stored in a distributed database.

59. A method as recited in claim 1, wherein the manufacturing organization information is stored in a secure database.

60. A method as recited in claim 1, wherein:
the product brand information comprises a general recipe; and
the processing comprises converting the general recipe into at least one master recipe.

61. A method as recited in claim 60, wherein the processing comprises converting the general recipe into a plurality of the master recipes.

62. A method as recited in claim 61, wherein the processing comprises comparing the plurality of the master recipes with the manufacturing organization information.

63. A method as recited in claim 1, wherein:
the product brand information comprises steps required to make the product brand;
the manufacturing organization information comprises steps capable of being carried out by the manufacturing organization; and
the processing comprises comparing the product brand information steps with the manufacturing organization steps to identify a match.

64. A method as recited in claim 1, wherein the at least one candidate manufacturing organization selection comprises selecting as the at least one candidate manufacturing organization each of the manufacturing organizations that has at least one master recipe for the general recipe for the product brand.

65. A method as recited in claim 1, wherein the at least one candidate manufacturing organization selection comprises assessing the extent to which each of the manufacturing organizations matches the product brand information and assigning to each of the manufacturing organizations a score, and including within the selection information each of the at least one candidate manufacturing organizations for which the score is above a threshold value.

66. A method as recited in claim 1, wherein the at least one candidate manufacturing organization selection comprises assessing the extent to which each of the manufacturing organizations matches the product brand information and assigning to each of the manufacturing organizations a score, and including within the at least one candidate manufacturing organizations a predetermined number of the manufacturing organizations having the highest of the scores.

67. A method as recited in claim 1, wherein the at least one candidate manufacturing organization selection comprises assessing the extent to which each of the manufacturing organizations matches the product brand information and assigning to each of the manufacturing organizations a rank, and including within the selection information each of the at least one candidate manufacturing organizations in order of the rank.

68. A method as recited in claim 1, wherein the at least one candidate manufacturing organization selection comprises assessing the extent to which each of the manufacturing organizations matches the product brand information satisfies a weighted set of selection criteria.

69. A method as recited in claim 1, wherein the selection information comprises the number of manufacturing organizations comprising the at least one candidate manufacturing organizations.

70. A method as recited in claim 1, wherein the selection information comprises information sufficient to confirm that the at least one candidate manufacturing organization can manufacture the product brand according to the product brand information, but the selection information excludes information sufficient to identify the at least one candidate manufacturing organization.

71. A method as recited in claim 1, wherein the selection information comprises information useful to the product brand manager.

72. A method as recited in claim 1, wherein the selection information comprises price information.

73. A method as recited in claim 1, wherein the selection information comprises public selection information and private selection information; and
the selection information communicating comprises communicating the authorized selection information to the product brand manager and withholding the unauthorized selection information from the product brand manager.

74. A method as recited in claim 1, wherein the communication of the selection information to the product brand manager comprises communicating the selection information to a product brand manager computer accessible by the product brand manager.

75. A method as recited in claim 74, wherein the communication of the selection information to the product brand manager comprises communicating the selection information automatically upon the selection of the at least one candidate manufacturing organization, without human intervention.

76. A method as recited in claim 1, further comprising communicating the selection information to the at least one candidate manufacturing organization.

77. A method for facilitating transactions between a product brand manager and manufacturing organizations using a transactional computer system, the product brand manager having a product brand and product brand information comprising information for manufacturing the product brand, and there being manufacturing organization information for each of the manufacturing organizations comprising the manufacturing process capabilities of the respective manufacturing organization, the method comprising:
communicating the product brand information from the product brand manager to the transactional computer system;
communicating the manufacturing organization information for the manufacturing organizations from the manufacturing organizations to the transactional computer system;
using the transactional computer system to process the product brand information and the manufacturing organization information to select at least one candidate manufacturing organization from the manufacturing organizations and to generate selection information regarding the at least one candidate manufacturing organization, the selection being carried out by the transactional computer system and comprising
confirming that the product brand information comprises a general recipe and to the extent the confirmation is not made, converting the product brand information into the general recipe,
converting the general recipe into a plurality of master recipes, and
comparing the product brand information to the manufacturing organization information; and
using the transactional computer system to communicate the selection information to the product brand manager.

78. A method as recited in claim 77, wherein the communicating of the product brand information from the product brand manager to the transactional computer system is performed without human intervention at the transactional computer system.

79. A method as recited in claim 77, wherein the communicating of the manufacturing organization information for the manufacturing organizations from the manufacturing organizations to the transactional computer system is performed without human intervention at the transactional computer system.

80. A method as recited in claim 77, wherein the using of the transactional computer system to process the product brand information and the manufacturing organization information to select at least one candidate manufacturing organization from the manufacturing organizations and to generate selection information regarding the at least one candidate manufacturing organization is performed without human intervention at the transactional computer system.

81. A method as recited in claim 77, wherein the use of the transactional computer system to compare the product brand information to the manufacturing organization information is performed without human intervention at the transactional computer system.

82. A method as recited in claim 77, wherein the use of the transactional computer system to communicate the selection information to the product brand manager is performed without human intervention at the transactional computer system.

83. A method for facilitating transactions between a manufacturing organization and product brand managers using a transactional computer system, each of the product brand managers having a product brand and product brand information comprising information for manufacturing the product brand, and there being manufacturing organization information for the manufacturing organization comprising the manufacturing process capabilities of the manufacturing organization, the method comprising:
communicating the product brand information from the product brand managers to the transactional computer system;
communicating the manufacturing organization information for the manufacturing organization from the manufacturing organization to the transactional computer system;
using the transactional computer system to process the product brand information and the manufacturing organization information to select at least one candidate product brand manager from the product brand managers and to generate selection information regarding the at least one candidate product brand managers, the selection comprising using the transactional computer system to compare the product brand information to the manufacturing organization information; and
using the transactional computer system to communicate the selection information to the manufacturing information.

84. A system for facilitating transactions between a product brand manager and manufacturing organizations, the product brand manager having a product brand and product brand information comprising information for manufacturing the product brand, and there being manufacturing organization information for each of the manufacturing organizations comprising the manufacturing process capabilities of the respective manufacturing organization, the system comprising:
a network comprising a transactional computer system, at least one product brand manager computer and a plurality of manufacturing organization computers, each of the manufacturing organizations having one of the plurality of the manufacturing organization computers;
the product brand manager computer comprising a storage device for storing the product brand information and communication means for communicating the product brand information to the transactional computer system;
each of the manufacturing organization computers comprising a storage device for storing the manufacturing organization information for the manufacturing, and communication means for communicating the manufacturing organization information to the transactional computer system;
the transactional computer system comprising a processor for processing the product brand information and the manufacturing organization information to select at least one candidate manufacturing organization from the manufacturing organizations and to generate selection information regarding the at least one candidate manufacturing organization; and
communications means for communicating the selection information to the product brand manager computer without human intervention at the transactional computer system.

85. A system for facilitating transactions between a manufacturing organization and product brand managers, each of the product brand managers having a product brand and product brand information comprising information for manufacturing the product brand, and there being manufacturing organization information for the manufacturing organization comprising the manufacturing process capabilities of the manufacturing organization, the system comprising:
a network comprising a transactional computer system, at least one manufacturing organization computer and a plurality of product brand manager computers, each of the product brand computers having one of the plurality of the product brand manager computers;
each of the product brand manager computers comprising a storage device for storing the product brand information and communication means for communicating the product brand information to the transactional computer system;
the manufacturing organization computer comprising a storage device for storing the manufacturing organization information for the manufacturing, and communication means for communicating the manufacturing organization information to the transactional computer system;
the transactional computer system comprising a processor for processing the product brand information and the manufacturing organization information to select at least one candidate product brand manager from the product brand managers and to generate selection information regarding the at least one candidate product brand managers; and
communications means for communicating the selection information to the manufacturing organization computer without human intervention at the transactional computer system.
